(19) United States
(12) Patent Application Publication
(10) Pub. No.: US 2025/0109059 A1
(43) Pub. Date: Apr. 3, 2025

(54) PRECURSOR GLASSES AND GLASS-CERAMICS FORMED THEREFROM WITH IMPROVED MECHANICAL PROPERTIES

(71) Applicant: CORNING INCORPORATED, CORNING, NY (US)

(72) Inventors: Carol Ann Click, Corning, NY (US); Qiang Fu, Painted Post, NY (US); Kayla Nicole Horton, Campbell, NY (US); Charlene Marie Smith, Corning, NY (US); Ljerka Ukrainczyk, Ithaca, NY (US); Alana Marie Whittier, Painted Post, NY (US); Shelby Kerin Wilson, Corning, NY (US)

(21) Appl. No.: 18/899,279

(22) Filed: Sep. 27, 2024

Related U.S. Application Data
(60) Provisional application No. 63/541,577, filed on Sep. 29, 2023.

(51) Int. Cl. C03C 10/00; C03C 21/00

(52) U.S. Cl. CPC C03C 10/00; C03C 21/002; C03C 2204/00

(57) ABSTRACT

A glass-ceramic includes greater than or equal to 55 wt % to less than or equal to 75 wt % SiO₂; greater than or equal to 2 wt % to less than or equal to 10 wt % Al₂O₃; greater than or equal to 8 wt % to less than or equal to 15 wt % Li₂O; greater than or equal to 2 wt % to less than or equal to 4 wt % P₂O₅; greater than or equal to 0.05 wt % and less than or equal to 4.0 wt % CaO; greater than or equal to 5 wt % to less than or equal to 15 wt % ZrO₂; and a phase assemblage comprising a crystalline phase and a glass phase, wherein: a ratio of Li₂O to Al₂O₃ is greater than 2 and less than or equal to 4; and a ratio of Li₂O to ZrO₂ is greater than or equal to 1.2 and less than or equal to 1.7.

This application claims the benefit of priority under 35 U.S.C. § 119 of U.S. Provisional Application Ser. No. 63/541,577 filed on Sep. 29, 2023, the content of which is relied upon and incorporated herein by reference in its entirety.

### FIELD

The present specification generally relates to precursor glasses and glass-ceramics formed therefrom, more particularly to glass-ceramics with improved mechanical properties.

### TECHNICAL BACKGROUND

There is a demand for high strength glass-based articles that may be used in conjunction with, for example, portable electronic devices. Several materials are currently utilized on the market such as glass, zirconia, plastic, metal, and glass-ceramics.

Glass-ceramics have certain advantages over other materials. However, it can be difficult to form glass-ceramics having the properties required for high strength portable devices.

Accordingly, a need exists for glass-ceramics having improved properties and methods for making the glass-ceramics.

### SUMMARY

According to a first aspect A1, a glass-ceramic includes: greater than or equal to 55 wt % to less than or equal to 75 wt % SiO₂; greater than or equal to 2 wt % to less than or equal to 10 wt % Al₂O₃; greater than or equal to 8 wt % to less than or equal to 15 wt % Li₂O; greater than or equal to 2 wt % to less than or equal to 4 wt % P₂O₅; greater than or equal to 0.05 wt % and less than or equal to 4.0 wt % CaO; greater than or equal to 5 wt % to less than or equal to 15 wt % ZrO₂; and a phase assemblage comprising at least one crystalline phase and a residual amorphous glass phase, wherein: a ratio of Li₂O (wt %) to Al₂O₃ (wt %) is greater than 2 and less than or equal to 4; and a ratio of Li₂O (wt %) to ZrO₂ (wt %) is greater than or equal to 1.2 and less than or equal to 1.7.

A second aspect A2 comprises the glass-ceramic of aspect A1, wherein the ratio of Li₂O (wt %) to Al₂O₃ (wt %) is greater than 2 and less than or equal to 3.5.

A third aspect A3 comprises the glass-ceramic of any preceding aspect, wherein the ratio of Li₂O (wt %) to ZrO₂ (wt %) is greater than or equal to 1.35 and less than or equal to 1.7.

A fourth aspect A4 comprises the glass-ceramic of any preceding aspect, wherein a ratio of Al₂O₃ (wt %) to ZrO₂ (wt %) is greater than 0 and less than or equal to 1.

A fifth aspect A5 comprises the glass-ceramic of any preceding aspect, wherein a ratio of Al₂O₃ (wt %) to ZrO₂ (wt %) is greater than 0.35 and less than or equal to 0.65.

A sixth aspect A6 comprises the glass-ceramic of any preceding aspect, further comprising greater than 0 wt % and less than or equal to 2 wt % Na₂O.

A seventh aspect A7 comprises the glass-ceramic of any preceding aspect, further comprising greater than 0.1 wt % and less than or equal to 1 wt % K₂O.

An eighth aspect A8 comprises the glass-ceramic of any preceding aspect, further comprising greater than or equal to 0.1 wt % to less than or equal to 1.0 wt % HfO₂.

A ninth aspect A9 comprises the glass-ceramic of any preceding aspect, comprising greater than or equal to 10 wt % to less than or equal to 14 wt % Li₂O.

A tenth aspect A10 comprises the glass-ceramic of any preceding aspect, comprising greater than or equal to 6 wt % to less than or equal to 10 wt % ZrO₂.

An eleventh aspect A11 comprises the glass-ceramic of any preceding aspect, comprising greater than or equal to 3 wt % to less than or equal to 8 wt % Al₂O₃.

A twelfth aspect A12 comprises the glass-ceramic of any preceding aspect, comprising greater than or equal to 0.10 wt % to less than or equal to 1.00 wt % CaO.

A thirteenth aspect A13 comprises the glass-ceramic of any preceding aspect, wherein the phase assemblage comprises: a lithium disilicate crystalline phase; a petalite crystalline phase; and the residual amorphous glass phase.

A fourteenth aspect A14 comprises the glass-ceramic of any preceding aspect, comprising, greater than or equal to 15 wt % to less than or equal to 35 wt % of the residual amorphous glass phase.

A fifteenth aspect A15 comprises the glass-ceramic of any preceding aspect, comprising, greater than or equal to 20 wt % to less than or equal to 45 wt % of the petalite crystalline phase.

A sixteenth aspect A16 comprises the glass-ceramic of any preceding aspect, comprising, greater than or equal to 35 wt % to less than or equal to 50 wt % of the lithium disilicate crystalline phase.

A seventeenth aspect A17 comprises the glass-ceramic of any preceding aspect, further comprising: a compressive stress layer extending from a surface of the glass-ceramic to a depth of compression; and a central tension, wherein the central tension is greater than 170 MPa.

An eighteenth aspect A18 comprises the glass-ceramic of any preceding aspect, wherein the compressive stress layer comprises a surface compressive stress greater than or equal to 200 MPa and less than or equal to 550 MPa.

A nineteenth aspect A19 comprises the glass-ceramic of any preceding aspect, wherein the glass-ceramic is ion-exchange strengthened.

A twentieth aspect A20 comprises the glass-ceramic of any preceding aspect, wherein the glass-ceramic has a thickness t and the depth of compression is greater than or equal to 0.09*t to less than or equal to 0.30*t.

A twenty-first aspect A21 comprises the glass-ceramic of any preceding aspect, wherein the glass-ceramic has a transmittance of greater than 90% for wavelengths of light within a range from greater than or equal to 400 nm to less than or equal to 800 nm at an article thickness of 0.5 mm.

A twenty-second aspect A22 comprises the glass-ceramic of any preceding aspect, wherein the glass-ceramic has a fracture toughness greater than or equal to 1.0 MPa·m^{1/2} and less than or equal to 2.0 MPa·m^{1/2} prior to strengthening by ion exchange.

A twenty-third aspect A23 comprises the glass-ceramic of any preceding aspect, wherein the glass-ceramic has an elastic modulus greater than or equal to 90 GPa and less than or equal to 130 GPa.

A twenty-fourth aspect A24 comprises an electronic device comprising a cover substrate, the cover substrate comprising the glass-ceramic of any preceding aspect.

A twenty-fifth aspect A25 includes a glass-ceramic comprising: a lithium disilicate crystalline phase; a petalite crystalline phase; and a residual amorphous glass phase, wherein: a ratio of Li₂O (wt %) to Al₂O₃ (wt %) in the glass-ceramic is greater than 2 and less than or equal to 4; and a ratio of Li₂O (wt %) to ZrO₂ (wt %) in the glass-ceramic is greater than or equal to 1.2 and less than or equal to 1.7.

A twenty-sixth aspect A26 comprises the glass-ceramic of aspect A25 comprising, greater than or equal to 15 wt % to less than or equal to 35 wt % of the residual amorphous glass phase.

A twenty-seventh aspect A27 includes the glass-ceramic of any of aspects A25-A26 comprising, greater than or equal to 20 wt % to less than or equal to 45 wt % of the petalite crystalline phase.

A twenty-eighth aspect A28 includes the glass-ceramic of any of aspects A25-A27 comprising, greater than or equal to 35 wt % to less than or equal to 50 wt % of the lithium disilicate crystalline phase.

A twenty-ninth aspect A29 includes the glass-ceramic of any of aspects A25-A28, further comprising: a compressive stress layer extending from a surface of the glass-ceramic to a depth of compression; and a central tension, wherein the central tension is greater than 170 MPa.

A thirtieth aspect A30 includes the glass-ceramic of any of aspects A25-A29, wherein the compressive stress layer comprises a surface compressive stress greater than or equal to 200 MPa and less than or equal to 550 MPa.

A thirty-first aspect A31 includes the glass-ceramic of any of aspects A25-A30, wherein the glass-ceramic is ion-exchange strengthened.

A thirty-second aspect A32 includes the glass-ceramic of any of aspects A25-A31, wherein the glass-ceramic has a thickness t and the depth of compression is greater than or equal to 0.09*t to less than or equal to 0.30*t.

A thirty-third aspect A33 includes the glass-ceramic of any of aspects A25-A32, wherein the glass-ceramic has a transmittance of greater than 90% for wavelengths of light within a range from greater than or equal to 400 nm to less than or equal to 800 nm at an article thickness of 0.5 mm.

A thirty-fourth aspect A34 includes an electronic device comprising a cover substrate, the cover substrate comprising the glass-ceramic any of aspects A25-A33.

A thirty-fifth aspect A35 includes the glass-ceramic of any of aspects A25-A34, wherein the glass-ceramic has a fracture toughness greater than or equal to 1.0 MPa·m^{1/2} and less than or equal to 2.0 MPa·m^{1/2} prior to strengthening by ion exchange.

A thirty-sixth aspect A36 includes the glass-ceramic of any of aspects A25-A35, wherein the glass-ceramic has an elastic modulus greater than or equal to 90 GPa and less than or equal to 130 GPa.

A thirty-seventh aspect A37 includes a precursor glass comprising: greater than or equal to 55 wt % to less than or equal to 75 wt % SiO₂; greater than or equal to 2 wt % to less than or equal to 10 wt % Al₂O₃; greater than or equal to 8 wt % to less than or equal to 15 wt % Li₂O; greater than or equal to 2 wt % to less than or equal to 4 wt % P₂O₅; greater than or equal to 0.05 wt % and less than or equal to 4.0 wt % CaO; and greater than or equal to 5 wt % to less than or equal to 15 wt % ZrO₂; a ratio of Li₂O (wt %) to Al₂O₃ (wt %) is greater than 2 and less than or equal to 4; and a ratio of Li₂O (wt %) to ZrO₂ (wt %) is greater than or equal to 1.2 and less than or equal to 1.7.

A thirty-eighth aspect A38 includes the precursor glass of aspect A37, wherein the ratio of Li₂O (wt %) to Al₂O₃ (wt %) is greater than 2 and less than or equal to 3.5.

A thirty-ninth aspect A39 includes the precursor glass of any of aspects A37-A38, wherein the ratio of Li₂O (wt %) to ZrO₂ (wt %) is greater than or equal to 1.35 and less than or equal to 1.7.

A fortieth aspect A40 includes the precursor glass of any of aspects A37-A39, wherein a ratio of Al₂O₃ (wt %) to ZrO₂ (wt %) is greater than 0 and less than or equal to 1.

A forty-first aspect A41 includes the precursor glass of any of aspects A37-A40, wherein a ratio of Al₂O₃ (wt %) to ZrO₂ (wt %) is greater than 0.35 and less than or equal to 0.65.

A forty-second aspect A42 includes the precursor glass of any of aspects A37-A41, further comprising greater than 0 wt % and less than or equal to 2 wt % Na₂O.

A forty-third aspect A43 includes the precursor glass of any of aspects A37-A42, further comprising greater than 0.1 wt % and less than or equal to 1 wt % K₂O.

A forty-fourth aspect A44 includes the precursor glass of any of aspects A37-A43, further comprising greater than or equal to 0.1 wt % to less than or equal to 1.0 wt % HfO₂.

A forty-fifth aspect A45 includes the precursor glass of any of aspects A37-A44, comprising greater than or equal to 10 wt % to less than or equal to 14 wt % Li₂O.

A forty-sixth aspect A46 includes the precursor glass of any of aspects A37-A45, comprising greater than or equal to 6 wt % to less than or equal to 10 wt % ZrO₂.

A forty-seventh aspect A47 includes the precursor glass of any of aspects A37-A46, comprising greater than or equal to 3 wt % to less than or equal to 8 wt % Al₂O₃.

A forty-eighth aspect A48 includes the precursor glass of any of aspects A37-A47, comprising greater than or equal to 0.10 wt % to less than or equal to 1.00 wt % CaO.

A forty-ninth aspect A49 includes the precursor glass of any of aspects A37-A48, wherein the precursor glass has a liquidus viscosity greater than or equal to 0.5 kP and less than or equal to 3.5 kP.

Additional features and advantages of the glass-ceramics and precursor glasses for forming the same will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 is a flow chart that depicts methods according to embodiments disclosed and described herein;

FIG. 2 schematically depicts a cross section of a glass-ceramic article that has been chemically strengthened by ion exchange treatment;

FIG. 3 schematically depicts a drop test apparatus;

FIG. 4 schematically depicts the drop test apparatus of FIG. 3 in use;

FIG. 5 schematically depicts the drop test apparatus of FIG. 3 is use;

FIG. 6A schematically depicts a top view of an electronic device including a glass-ceramic article according to embodiments disclosed and described herein;

FIG. 6B schematically depicts a perspective view of an electronic device including a glass-ceramic article according to embodiments disclosed and described herein;

FIG. 7 graphically depicts the maximum central tension (y-axis) as a function of ion exchange time (x-axis) for glass-ceramics according to embodiments disclosed and described herein and comparative glass-ceramics;

FIG. 8 graphically depicts the maximum central tension (y-axis) as a function of ZrO₂ concentration (x-axis) for glass-ceramics according to embodiments disclosed and described herein and comparative glass-ceramics;

FIG. 9 graphically depicts the applied fracture stress (y-axis) following a four point bend test for glass-ceramics according to embodiments disclosed and described herein and comparative glass-ceramics;

FIG. 10 graphically depicts the applied fracture stress (y-axis) following a four point bend test for glass-ceramics according to embodiments disclosed and described herein and comparative glass-ceramics;

FIG. 11 graphically depicts the maximum drop height (y-axis) from a drop test apparatus for glass-ceramics according to embodiments disclosed and described herein and comparative glass-ceramics;

FIG. 12 graphically depicts the maximum drop height (y-axis) from a drop test apparatus for glass-ceramics according to embodiments disclosed and described herein and comparative glass-ceramics; and

FIG. 13 graphically depicts the transmittance (y-axis) as a function of wavelength (x-axis) for glass-ceramics according to embodiments disclosed and described herein.

### DETAILED DESCRIPTION

Reference will now be made in detail to embodiments of precursor glasses and glass-ceramics formed therefrom, examples of which are illustrated in the accompanying drawings. Whenever possible, the same reference numerals will be used throughout the drawings to refer to the same or like parts. According to embodiments, a glass-ceramic generally includes greater than or equal to 55 wt % to less than or equal to 75 wt % SiO₂; greater than or equal to 2 wt % to less than or equal to 10 wt % Al₂O₃; greater than or equal to 8 wt % to less than or equal to 15 wt % Li₂O; greater than or equal to 2 wt % to less than or equal to 4 wt % P₂O₅; greater than or equal to 0.05 wt % and less than or equal to 4.0 wt % CaO; greater than or equal to 5 wt % to less than or equal to 15 wt % ZrO₂; and a phase assemblage comprising at least one crystalline phase and a residual amorphous glass phase, wherein: a ratio of Li₂O (wt %) to Al₂O₃ (wt %) is greater than 2 and less than or equal to 4; and a ratio of Li₂O (wt %) to ZrO₂ (wt %) is greater than or equal to 1.2 and less than or equal to 1.7. Various embodiments of precursor glasses and glass-ceramics formed therefrom will be described herein with specific reference to the appended figures.

As used herein, the term “glass-ceramic” refers to solids prepared by controlled crystallization of a precursor glass and have one or more crystalline phases and a residual amorphous glass phase.

The liquidus temperature of a precusor glass is the temperature (in ° C.) above which no crystalline phases can coexist in equilibrium with the precusor glass. The liquidus temperature is measured according to ASTM C829-81 (2022).

The liquidus viscosity (in poise) of a precusor glass is the viscosity of the precusor glass at the liquidus temperature. The liquidus viscosity is measured according to ASTM C965-23 (2023).

As used herein, “depth of compression” or “DOC” refers to the depth of a compressive stress (CS) layer and is the depth at which the stress within a glass-ceramic article changes from compressive stress to tensile stress and has a stress value of zero. According to the convention normally used in the art, compressive stress is expressed as a negative (<0) stress and tensile stress is expressed as a positive (>0) stress. Throughout this description, however, and unless otherwise noted, CS is expressed as a positive or absolute value—that is, as recited herein, CS=|CS|.

The CS, DOC, and maximum central tension (CT) values are measured using a hybrid method that combines measurements made using evanescent prism coupling spectroscopy (EPCS) and light scattering polarimetry (LSP) as disclosed in U.S. Patent Application Publication No. 2020/0300615, which is incorporated herein by reference in its entirety.

Fracture toughness (K_{1C}) represents the ability of a precusor glass or glass-ceramic to resist fracture. Fracture toughness is measured on a non-chemically strengthened precursor glass article or glass-ceramic article, such as measuring the K_{1C} value prior to ion exchange (IOX) treatment of the precursor glass article or glass-ceramic article, thereby representing a feature of the article prior to IOX. The fracture toughness test methods described herein are not suitable for glasses that have been exposed to IOX treatment. However, fracture toughness measurements performed as described herein on the same article prior to IOX treatment (e.g., precursor glass or glass-ceramic substrates) correlate to fracture toughness after IOX treatment, and are accordingly used as such. The chevron notched short bar (CNSB) method utilized to measure the K_{1C} value is disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*m is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992). The double torsion method and fixture utilized to measure the K_{1C} value is described in Shyam, A. and Lara-Curzio, E., “The double-torsion testing technique for determination of fracture toughness and slow crack growth of materials: A review,” J. Mater. Sci., 41, pp. 4093-4104, (2006). The double torsion measurement method generally produces K_{1C} values that are slightly higher than the chevron notched short bar method. Unless otherwise specified, all fracture toughness values were measured by chevron notched short bar (CNSB) method.

Young's modulus, shear modulus, and Poisson's ratio are measured by a resonant ultrasonic spectroscopy technique of the general type set forth in ASTM E2001-13 (2018).

Haze of a glass-ceramic article is measured using a haze meter, such as the BYK Gardner Haze-Gard I, following ASTM D1003-21 (2021) or ASTM D1044-19 (2019) on a glass-ceramic plate having a thickness of 0.6 mm, unless otherwise stated.

Optical transmission (also referred to herein as “transmittance”) is measured in the 250-1000 nm range on optically polished samples with plane parallel faces using a Perkin Elmer Lambda 950 spectrophotometer, with data interval of 2 nm. The transmission is measured on the glass-ceramic article itself without any coatings or other applications.

X-ray diffraction (XRD) is conducted on powdered samples using a Bruker D4 Endeavor equipped with Cu radiation and a LynxEye detector. The phase assemblage is determined using Rietveld method and using Bruker's Topas software package.

The stored strain energy of the glass-ceramic article is calculated as described in Gulati, Suresh T., “Frangibility of Tempered Soda-Lime Glass Sheet,” Glass Processing Days, Sep. 13-15, 1997, pp. 72-76 (ISBN 952-90-8959-7), specifically equation (4) of the publication.

Density is measured according to as measured in accordance with ASTM C693-93 (2019).

Hardness is measured using a MITUTOYO HM 114 Hardness testing machine with a Knoop indenter with a 200 gram indentation load (Dwell time is 15 seconds). Measurement of indentation diagonals is performed using calibrated optical microscopy. Values are average of measurements from 5 indentations per sample. Tests are performed on optically polished samples with plane parallel faces.

The term “softening point,” as used herein, refers to the temperature at which the viscosity of the glass composition is 1×10^{7.6} poise. The softening point is determined using the parallel plate viscosity method of ASTM C1351M-96 (2012).

The term “annealing point” as used herein, refers to the temperature at which the viscosity of the precursor glass or glass-ceramic is 1×10¹³ poise. The annealing point is determined using the beam bending viscosity method of ASTM C598-93 (2013).

The term “strain point” and “Tₛₜᵣₐᵢₙ” as used herein, refer to the temperature at which the viscosity of the precursor glass or glass-ceramic is 3×10¹⁴ poise. The strain point is determined using the beam bending viscosity method of ASTM C598-93 (2013).

The linear coefficient of thermal expansion (CTE) of the glass-ceramics over the temperature range 0° C. to 300° C. is expressed as the average CTE over the range in terms of ppm/° C. (×10−6/° C.) and was determined using a push-rod dilatometer in accordance with ASTM E228-11 (2016).

Thermal diffusivity of the glass-ceramics was determined in accordance with ASTM E1461-13 (2022).

Thermal conductivity of the glass-ceramics was determined in accordance with ASTM E1461-13 (2022).

The heat capacity of the glass-ceramics in J/g*K was determined in accordance with ASTM E1269-11 (2018).

The terms “free” and “substantially free,” when used to describe the concentration and/or absence of a particular constituent component in a precursor glass or glass-ceramic, means that the constituent component is not intentionally added to the precursor glass or glass-ceramic. However, the precursor glass or glass-ceramic may contain traces of the constituent component as a contaminant or tramp in amounts of less than 0.01 wt %.

Ranges can be expressed herein as from “less than or equal to” one particular value, and/or to “less than or equal to” another particular value. When such a range is expressed, another embodiment includes from the one particular value and/or to the other particular value. Similarly, when values are expressed as approximations, by use of the antecedent “less than or equal to,” it will be understood that the particular value forms another embodiment. It will be further understood that the endpoints of each of the ranges are significant both in relation to the other endpoint, and independently of the other endpoint. Any ranges used herein include all ranges and subranges and any values there between unless explicitly stated otherwise.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Glass-ceramics have attributes making them amenable for use as cover substrates and/or housings for mobile electronic devices. For example, without being bound by theory, glass-ceramics with high fracture toughness and/or Young's modulus can provide resistance to crack penetration and exhibit good drop performance. When such glass-ceramics are chemically strengthened, for example through ion exchange, the resistance to crack penetration and drop performance can be further enhanced. The high fracture toughness and/or Young's modulus may also increase the amount of stored tensile energy and maximum central tension that can be imparted to the glass-ceramics through chemical tempering (e.g., through ion exchange strengthening). In addition, the optical characteristics of the glass-ceramics, such as transparency and haze, can be tailored by adjusting the heating/ceramming schedule used to transform the precursor glass into glass-ceramic.

As thinner glass and glass-ceramics are required to meet the needs of evolving electronic devices (such as electronic devices that are becoming smaller and thinner), it is desired to increase the strength of the thin precursor glasses and glass-ceramics formed therefrom by increasing the levels of stress (both compressive and tensile) installed in the glass-ceramics, such as through chemical tempering.

However, known glass-ceramic compositions have reached a plateau in the magnitude of stress that can be installed in the glass-ceramics. This includes both the magnitude of compressive stress (CS) attainable at the surface of the glass-ceramics, as well as the magnitude of the central tension (CT) in the thickness of the glass-ceramics, the latter contributing primarily to the fragmentation behavior (also referred to as frangibility) of the glass-ceramics. Said differently, existing glass-ceramics may be unable to achieve the desired fragmentation behavior because the material may be unable to attain the necessary amount of central tension through, for example, chemical tempering.

The composition of the precursor glasses and glass-ceramics disclosed herein allow for glass-ceramics which have a sufficiently high central tension (e.g., such as greater than or equal to 150 MPa to less than 230 MPa in a substrate having a thickness of 0.6 mm) following chemical tempering without exhibiting a highly fragmented breakage pattern. Without wishing to be bound by theory, it is believed that the relatively high central tension in the glass-ceramics described herein allows for higher compressive stresses at deeper depths from the surface of the glass-ceramic, thereby improving the mechanical performance of the glass-ceramic including, without limitation, drop height and fracture strength.

One compositional aspect that contributes to improved stress levels in glass-ceramics according to embodiments disclosed and described herein is an increased amount of Li₂O in the precursor glass. Lithium is the smallest of the alkali metal ions and when lithium is replaced in the glass network with sodium or potassium ions during ion exchange strengthening, relatively high compressive stress and central tension values may be achieved. However, including too much lithium in the precursor glass can make the glass difficult to form, which can make it difficult to achieve the thin glass-ceramic articles desirable for handheld electronic devices, such as mobile phones and tablets. Accordingly, one cannot simply increase the amount of lithium in a precursor glass to improve the compressive stress and central tension in a resulting glass-ceramic. Doing so will result in precursor glasses that cannot be easily and economically formed into thin sheets.

However, it has been found that including relatively high amounts of zirconia (ZrO₂) in the precursor glass, in combination with a slightly higher amount of lithium in the precursor glass, can result in higher compressive stress and central tension in the glass-ceramics following chemical tempering without unduly effecting the melting behavior of the precursor glass. Without being bound by any particular theory, it is believed that when forming glass-ceramics via heat treatments-which will be described in further detail herein-zirconia helps to partition lithium in the residual amorphous glass phase of the glass-ceramics. Thus, more lithium is present in the residual amorphous glass phase and is readily available to be exchanged with sodium and potassium during chemical tempering processes. Accordingly, while zirconia is traditionally included in precursor glass and glass-ceramic compositions to prevent devitrification in the precursor glass prior to ceramming, the relatively high amounts of zirconia included in embodiments disclosed and described herein goes beyond what is traditionally thought to improve the devitrification of the precursor glass and has been found to improve the ion exchange performance of the glass-ceramics.

It has now been further determined that the central tension installed in a glass-ceramic can be maximized by balancing the amount of Li₂O and ZrO₂ in the precursor glasses and resulting glass-ceramics. In particular, it has been found that when the ratio of Li₂O (wt %) to ZrO₂ (wt %) (i.e., Li₂O:ZrO₂) in the precursor glasses and resulting glass-ceramics is in the range from greater than or equal to 1.2 to less than or equal to 1.7, the central tension in the glass-ceramics as a result of strengthening by ion exchange can be maximized. In that regard, without wishing to be bound by any particular theory, it is believed that compositions which include ratios of Li₂O to ZrO₂ within this range maximize the amount Li₂O in the residual amorphous glass phase of the glass-ceramics which, in turn, allows for more ion exchange to occur between smaller lithium ions in the residual amorphous glass phase and larger sodium and/or potassium ions from an ion exchange bath resulting in greater central tension in the glass-ceramics.

Further, it has now been determined that the amount of the residual amorphous glass phase in the resulting glass-ceramics can be increased by balancing the amount of Li₂O and Al₂O₃ in the precursor glasses and resulting glass-ceramics. In particular, it has been found that when the ratio of Li₂O (wt %) to Al₂O₃ (wt %) (i.e., Li₂O:Al₂O₃) in the precursor glasses and resulting glass-ceramics is in the range from greater than or equal to 2 to less than or equal to 4, the amount of the residual amorphous glass phase in the glass-ceramics is increased, allowing for a further increase in the central tension installed in the glass-ceramics following chemical tempering. In that regard, without wishing to be bound by any particular theory, it is believed that increasing the amount of the residual amorphous glass phase in the glass-ceramics, while also maximizing the amount of lithium in the residual amorphous glass phase (such as by balancing the amount of Li₂O and ZrO₂ in the precursor glasses and resulting glass-ceramics), further increases the amount of ion exchange that occurs between smaller lithium ions in the residual amorphous glass phase and larger sodium and/or potassium ions from an ion exchange bath, further increasing the central tension in the glass-ceramics. Said differently, increasing the amount of the residual amorphous glass phase in the glass-ceramics, and the amount of lithium in the residual amorphous glass phase, increases the amount of ion exchange between lithium ions and sodium ions and/or potassium ions, thereby increasing the amount central tension that can be installed in the glass-ceramics.

In addition, precursor glasses and glass-ceramics according to embodiments disclosed and described herein also include relatively high amounts of calcium oxide (CaO). Without being bound by any particular theory, it is believed that the additional calcium oxide increases the density of the glass-ceramics and, therefore, slows the diffusion of ions into the glass-ceramics during chemical strengthening. This slowing of diffusion slows the ion exchange process, but results in glass-ceramics with more compressive stress and central tension than less dense precursor glasses and glass-ceramics. It is also believed that zirconia helps to increase the density of the glass-ceramic.

In various embodiments, the composition of the precursor glass is selected such that the resultant glass-ceramic has a phase assemblage comprising a petalite crystalline phase and a lithium silicate crystalline phase, specifically a lithium disilicate crystalline phase, wherein the petalite crystalline phase and the lithium disilicate crystalline phase have higher weight percentages than other crystalline phases present in the glass-ceramic article. The phase assemblage further includes a residual amorphous glass phase.

The petalite (LiAlSi₄O₁₀) of the petalite crystalline phase is a monoclinic crystal possessing a three-dimensional framework structure with a layered structure having folded Si₂O₅ layers linked by Li and A1 tetrahedra. The Li is in tetrahedral coordination with oxygen. The mineral petalite is a lithium source and is used as a low thermal expansion phase to improve the thermal downshock resistance of glass-ceramics or ceramic parts.

In embodiments of the glass-ceramics described herein, the weight percentage of the petalite crystalline phase in the glass-ceramics can be in a range from greater than or equal to 20 to less than or equal to 70 wt %, greater than or equal to 20 to less than or equal to 65 wt %, greater than or equal to 20 to less than or equal to 60 wt %, greater than or equal to 20 to less than or equal to 55 wt %, greater than or equal to 20 to less than or equal to 50 wt %, greater than or equal to 20 to less than or equal to 45 wt %, greater than or equal to 20 to less than or equal to 40 wt %, greater than or equal to 20 to less than or equal to 35 wt %, greater than or equal to 20 to less than or equal to 30 wt %, greater than or equal to 20 to less than or equal to 25 wt %, greater than or equal to 25 to less than or equal to 70 wt %, greater than or equal to 25 to less than or equal to 65 wt %, greater than or equal to 25 to less than or equal to 60 wt %, greater than or equal to 25 to less than or equal to 55 wt %, greater than or equal to 25 to less than or equal to 50 wt %, greater than or equal to 25 to less than or equal to 45 wt %, greater than or equal to 25 to less than or equal to 40 wt %, greater than or equal to 25 to less than or equal to 35 wt %, greater than or equal to 25 to less than or equal to 30 wt %, greater than or equal to 30 to less than or equal to 70 wt %, greater than or equal to 30 to less than or equal to 65 wt %, greater than or equal to 30 to less than or equal to 60 wt %, greater than or equal to 30 to less than or equal to 55 wt %, greater than or equal to 30 to less than or equal to 50 wt %, greater than or equal to 30 to less than or equal to 45 wt %, greater than or equal to 30 to less than or equal to 40 wt %, greater than or equal to 30 to less than or equal to 35 wt %, greater than or equal to 35 to less than or equal to 70 wt %, greater than or equal to 35 to less than or equal to 65 wt %, greater than or equal to 35 to less than or equal to 60 wt %, greater than or equal to 35 to less than or equal to 55 wt %, greater than or equal to 35 to less than or equal to 50 wt %, greater than or equal to 35 to less than or equal to 45 wt %, greater than or equal to 35 to less than or equal to 40 wt %, greater than or equal to 40 to less than or equal to 70 wt %, greater than or equal to 40 to less than or equal to 65 wt %, greater than or equal to 40 to less than or equal to 60 wt %, greater than or equal to 40 to less than or equal to 55 wt %, greater than or equal to 40 to less than or equal to 50 wt %, greater than or equal to 40 to less than or equal to 45 wt %, greater than or equal to 45 to less than or equal to 70 wt %, greater than or equal to 45 to less than or equal to 65 wt %, greater than or equal to 45 to less than or equal to 60 wt %, greater than or equal to 45 to less than or equal to 55 wt %, greater than or equal to 45 to less than or equal to 50 wt %, greater than or equal to 50 to less than or equal to 70 wt %, greater than or equal to 50 to less than or equal to 65 wt %, greater than or equal to 50 to less than or equal to 60 wt %, greater than or equal to 50 to less than or equal to 55 wt %, greater than or equal to 55 to less than or equal to 70 wt %, greater than or equal to 55 to less than or equal to 65 wt %, greater than or equal to 55 to less than or equal to 60 wt %, greater than or equal to 60 to less than or equal to 70 wt %, greater than or equal to 60 to less than or equal to 65 wt %, or even greater than or equal to 65 to less than or equal to 70 wt %. It should be understood that the above ranges include all subranges within the explicitly disclosed ranges. In embodiments, the glass-ceramics may comprise about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70 wt % of the petatlite crystalline phase.

The lithium disilicate (Li₂Si₂O₅) of the lithium disilicate crystalline phase is an orthorhombic crystal based on corrugated sheets of {Si₂O₅} tetrahedral arrays. The crystals are typically tabular or lath-like in shape, with pronounced cleavage planes. Glass-ceramics based on lithium disilicate offer highly desirable mechanical properties, including high body strength and fracture toughness, due to their microstructure of randomly oriented interlocked crystals—a crystal structure that forces cracks to propagate through the material via tortuous paths around these crystals.

In embodiments, the weight percentage of the lithium disilicate crystalline phase (also referred to herein as “L2S”) in the glass-ceramics can be in a range from greater than or equal to 20 to less than or equal to 60 wt %, greater than or equal to 20 to less than or equal to 55 wt %, greater than or equal to 20 to less than or equal to 50 wt %, greater than or equal to 20 to less than or equal to 45 wt %, greater than or equal to 20 to less than or equal to 40 wt %, greater than or equal to 20 to less than or equal to 35 wt %, greater than or equal to 20 to less than or equal to 30 wt %, greater than or equal to 20 to less than or equal to 25 wt %, greater than or equal to 25 to less than or equal to 60 wt %, greater than or equal to 25 to less than or equal to 55 wt %, greater than or equal to 25 to less than or equal to 50 wt %, greater than or equal to 25 to less than or equal to 45 wt %, greater than or equal to 25 to less than or equal to 40 wt %, greater than or equal to 25 to less than or equal to 35 wt %, greater than or equal to 25 to less than or equal to 30 wt %, greater than or equal to 30 to less than or equal to 60 wt %, greater than or equal to 30 to less than or equal to 55 wt %, greater than or equal to 30 to less than or equal to 50 wt %, greater than or equal to 30 to less than or equal to 45 wt %, greater than or equal to 30 to less than or equal to 40 wt %, greater than or equal to 30 to less than or equal to 35 wt %, greater than or equal to 35 to less than or equal to 60 wt %, greater than or equal to 35 to less than or equal to 55 wt %, greater than or equal to 35 to less than or equal to 50 wt %, greater than or equal to 35 to less than or equal to 45 wt %, greater than or equal to 35 to less than or equal to 40 wt %, greater than or equal to 40 to less than or equal to 60 wt %, greater than or equal to 40 to less than or equal to 55 wt %, greater than or equal to 40 to less than or equal to 50 wt %, greater than or equal to 40 to less than or equal to 45 wt %, greater than or equal to 45 to less than or equal to 60 wt %, greater than or equal to 45 to less than or equal to 55 wt %, greater than or equal to 45 to less than or equal to 50 wt %, greater than or equal to 50 to less than or equal to 60 wt %, greater than or equal to 50 to less than or equal to 55 wt %, or even greater than or equal to 55 to less than or equal to 60 wt %. It should be understood that the above ranges include all subranges within the explicitly disclosed ranges. In embodiments, the glass-ceramic may comprise about 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, or 60 wt % of the lithium disilicate crystalline phase.

In embodiments, the content of the residual amorphous glass phase in the glass-ceramics is greater than or equal to 13 wt % and less than or equal to 35 wt %, greater than or equal to 14 wt % and less than or equal to 35 wt %, greater than or equal to 15 wt % and less than or equal to 35 wt %, greater than or equal to 16 wt % and less than or equal to 35 wt %, greater than or equal to 17 wt % and less than or equal to 35 wt %, greater than or equal to 18 wt % and less than or equal to 35 wt %, greater than or equal to 19 wt % and less than or equal to 35 wt %, greater than or equal to 20 wt % and less than or equal to 35 wt %, greater than or equal to 21 wt % and less than or equal to 35 wt %, greater than or equal to 22 wt % and less than or equal to 35 wt %, greater than or equal to 23 wt % and less than or equal to 35 wt %, greater than or equal to 24 wt % and less than or equal to 35 wt %, greater than or equal to 25 wt % and less than or equal to 35 wt %, greater than or equal to 26 wt % and less than or equal to 35 wt %, greater than or equal to 27 wt % and less than or equal to 35 wt %, greater than or equal to 28 wt % and less than or equal to 35 wt %, greater than or equal to 29 wt % and less than or equal to 35 wt %, greater than or equal to 30 wt % and less than or equal to 35 wt %, greater than or equal to 31 wt % and less than or equal to 35 wt %, greater than or equal to 20 wt % and less than or equal to 35 wt %, greater than or equal to 20 wt % and less than or equal to 34 wt %, greater than or equal to 20 wt % and less than or equal to 33 wt %, greater than or equal to 20 wt % and less than or equal to 32 wt %, greater than or equal to 21 wt % and less than or equal to 35 wt %, greater than or equal to 21 wt % and less than or equal to 34 wt %, greater than or equal to 21 wt % and less than or equal to 33 wt %, greater than or equal to 21 wt % and less than or equal to 32 wt %, greater than or equal to 22 wt % and less than or equal to 35 wt %, greater than or equal to 22 wt % and less than or equal to 34 wt %, greater than or equal to 22 wt % and less than or equal to 33 wt %, greater than or equal to 22 wt % and less than or equal to 32 wt %, greater than or equal to 23 wt % and less than or equal to 35 wt %, greater than or equal to 23 wt % and less than or equal to 34 wt %, greater than or equal to 23 wt % and less than or equal to 33 wt %, greater than or equal to 23 wt % and less than or equal to 32 wt %, greater than or equal to 24 wt % and less than or equal to 35 wt %, greater than or equal to 24 wt % and less than or equal to 34 wt %, greater than or equal to 24 wt % and less than or equal to 33 wt %, greater than or equal to 24 wt % and less than or equal to 32 wt %, greater than or equal to 25 wt % and less than or equal to 35 wt %, greater than or equal to 25 wt % and less than or equal to 34 wt %, greater than or equal to 25 wt % and less than or equal to 33 wt %, or even greater than or equal to 25 wt % and less than or equal to 32 wt %. It should be understood that the above ranges include all subranges within the explicitly disclosed ranges. In embodiments, the residual amorphous glass content can be 35, 34, 33, 32, 31, 30, 29, 28, 27, 26, 25, 24, 23, 22, 21, 20, 19, 18, 17, 16, 15, 14, or 13 wt %.

The precursor glasses and glass-ceramics described herein may be generally described as lithium-containing aluminosilicate precursor glasses and glass-ceramics and comprise SiO₂, Al₂O₃, P₂O₅, ZrO₂, CaO, and Li₂O. In addition to SiO₂, Al₂O₃, and Li₂O, the precursor glasses and glass-ceramics embodied herein may further contain alkali oxides, such as Na₂O, K₂O, Rb₂O, or Cs₂O, as well as one or more other components as described herein. As noted herein, the major crystallite phases of the phase assemblage of the glass-ceramics described herein include petalite and lithium disilicate. In embodiments, the glass-ceramics may comprise less than 7 wt %, such as less than 6 wt %, less than 5 wt %, less than 4 wt %, or even less than 3 wt %, of the sum of other crystalline phases (such as, but not limited to lithium metasilicate (Li₂SiO₃), virgilite (LiₓAlₓSi₃₋ₓO₆), cristabolite (SiO₂), Quartz (SiO₂), zirconia (ZrO₂), baddeleyite (ZrO₂), spodumene (LiAlSi₂O₆), and lithium phosphate (Li₃PO₄)). This phase assemblage provides a glass-ceramic that has low haze (high clarity) and improved mechanical properties.

SiO₂, an oxide involved in the formation of glass, can function to stabilize the network structure of precursor glasses and glass-ceramics. The concentration of SiO₂ should be sufficiently high to form the petalite crystalline phase when the precusor glass is heat treated to convert the precusor glass to a glass-ceramic. The amount of SiO₂ may be limited to control the melting temperature of the glass, as the melting temperature of pure SiO₂ or high-SiO₂ glasses is undesirably high. In embodiments, the precursor glasses and glass-ceramics comprise greater than or equal to 55 wt % and less than or equal to 80 wt % SiO₂, greater than or equal to 55 wt % and less than or equal to 75 wt % SiO₂, greater than or equal to 55 wt % and less than or equal to 73 wt % SiO₂, greater than or equal to 55 wt % and less than or equal to 72 wt % SiO₂, greater than or equal to 60 wt % and less than or equal to 80 wt % SiO₂, greater than or equal to 60 wt % and less than or equal to 75 wt % SiO₂, greater than or equal to 60 wt % and less than or equal to 73 wt % SiO₂, greater than or equal to 60 wt % and less than or equal to 72 wt % SiO₂, greater than or equal to 65 wt % and less than or equal to 80 wt % SiO₂, greater than or equal to 65 wt % and less than or equal to 75 wt % SiO₂, greater than or equal to 65 wt % and less than or equal to 73 wt % SiO₂, greater than or equal to 65 wt % and less than or equal to 72 wt % SiO₂, greater than or equal to 68 wt % and less than or equal to 80 wt % SiO₂, greater than or equal to 68 wt % and less than or equal to 75 wt % SiO₂, greater than or equal to 68 wt % and less than or equal to 73 wt % SiO₂, or even greater than or equal to 68 wt % and less than or equal to 72 wt % SiO₂. It should be understood that the above ranges include all subranges within the explicitly disclosed ranges.

Al₂O₃ may also provide stabilization to the network and provides improved mechanical properties and chemical durability. If the amount of Al₂O₃ is too high, however, the fraction of lithium disilicate crystals may be decreased, possibly to the extent that an interlocking structure cannot be formed. The amount of Al₂O₃ can be tailored to control the viscosity of the precusor glass during melting and forming. Further, if the amount of Al₂O₃ is too high, the viscosity of the melt is also generally increased. In embodiments, the precursor glasses and glass-ceramics comprise greater than or equal to 2 wt % and less than or equal to 15 wt % Al₂O₃, greater than or equal to 3 wt % and less than or equal to 15 wt % Al₂O₃, greater than or equal to 4 wt % and less than or equal to 15 wt % Al₂O₃, greater than or equal to 5 wt % and less than or equal to 15 wt % Al₂O₃, 2 wt % and less than or equal to 12 wt % Al₂O₃, greater than or equal to 3 wt % and less than or equal to 12 wt % Al₂O₃, greater than or equal to 4 wt % and less than or equal to 12 wt % Al₂O₃, greater than or equal to 5 wt % and less than or equal to 12 wt % Al₂O₃, 2 wt % and less than or equal to 10 wt % Al₂O₃, greater than or equal to 3 wt % and less than or equal to 10 wt % Al₂O₃, greater than or equal to 4 wt % and less than or equal to 10 wt % Al₂O₃, greater than or equal to 5 wt % and less than or equal to 10 wt % Al₂O₃, 2 wt % and less than or equal to 8 wt % Al₂O₃, greater than or equal to 3 wt % and less than or equal to 8 wt % Al₂O₃, greater than or equal to 4 wt % and less than or equal to 8 wt % Al₂O₃, greater than or equal to 5 wt % and less than or equal to 8 wt % Al₂O₃, 2 wt % and less than or equal to 6 wt % Al₂O₃, greater than or equal to 3 wt % and less than or equal to 6 wt % Al₂O₃, or even greater than or equal to 4 wt % and less than or equal to 6 wt % Al₂O₃. It should be understood that the above ranges include all subranges within the explicitly disclosed ranges.

In the precursor glasses and glass-ceramics described herein, Li₂O aids in forming both petalite and lithium disilicate crystal phases. In fact, to obtain petalite and lithium disilicate as the predominant crystal phases, it is desirable to have at least about 7 wt % Li₂O in the composition. Additionally, it has been found that once Li₂O approaches about 17 wt %, the viscosity of the precursor glass may be reduced to an undesirable level. Accordingly, in embodiments, the precursor glasses and glass-ceramics can comprise greater than or equal to 7 wt % and less than or equal to 17 wt % Li₂O, 8 wt % and less than or equal to 17 wt % Li₂O, greater than or equal to 10 wt % and less than or equal to 17 wt % Li₂O, greater than or equal to 11 wt % and less than or equal to 17 wt % Li₂O, greater than or equal to 12 wt % and less than or equal to 17 wt % Li₂O, greater than or equal to 14 wt % and less than or equal to 17 wt % Li₂O, greater than or equal to 16 wt % and less than or equal to 17 wt % Li₂O, greater than or equal to 7 wt % and less than or equal to 16 wt % Li₂O, greater than or equal to 8 wt % and less than or equal to 16 wt % Li₂O, greater than or equal to 10 wt % and less than or equal to 16 wt % Li₂O, greater than or equal to 11 wt % and less than or equal to 16 wt % Li₂O, greater than or equal to 12 wt % and less than or equal to 16 wt % Li₂O, greater than or equal to 14 wt % and less than or equal to 16 wt % Li₂O, greater than or equal to 7 wt % and less than or equal to 15 wt % Li₂O, greater than or equal to 8 wt % and less than or equal to 15 wt % Li₂O, greater than or equal to 10 wt % and less than or equal to 15 wt % Li₂O, greater than or equal to 11 wt % and less than or equal to 15 wt % Li₂O, greater than or equal to 12 wt % and less than or equal to 15 wt % Li₂O, greater than or equal to 14 wt % and less than or equal to 15 wt % Li₂O, greater than or equal to 7 wt % and less than or equal to 14 wt % Li₂O, greater than or equal to 8 wt % and less than or equal to 14 wt % Li₂O, greater than or equal to 10 wt % and less than or equal to 14 wt % Li₂O, greater than or equal to 11 wt % and less than or equal to 14 wt % Li₂O, greater than or equal to 12 wt % and less than or equal to 14 wt % Li₂O, greater than or equal to 7 wt % and less than or equal to 13 wt % Li₂O, greater than or equal to 8 wt % and less than or equal to 13 wt % Li₂O, greater than or equal to 10 wt % and less than or equal to 13 wt % Li₂O, greater than or equal to 11 wt % and less than or equal to 13 wt % Li₂O, greater than or equal to 12 wt % and less than or equal to 13 wt % Li₂O, greater than or equal to 7 wt % and less than or equal to 12 wt % Li₂O, greater than or equal to 8 wt % and less than or equal to 12 wt % Li₂O, or even greater than or equal to 10 wt % and less than or equal to 12 wt % Li₂O. It should be understood that the above ranges include all subranges within the explicitly disclosed ranges.

As noted herein, it has been found that when the ratio of Li₂O (wt %) to Al₂O₃ (wt %) (i.e., Li₂O:Al₂O₃) in the precursor glasses and resulting glass-ceramics is in the range from greater than or equal to 2.0 to less than or equal to 4.0, the amount of the residual amorphous glass phase in the glass-ceramics is increased, allowing for a further increase in the central tension installed in the glass-ceramics following chemical tempering. In embodiments, the ratio of Li₂O to Al₂O₃ is greater than or equal to 2.0 and less than or equal to 3.8, greater than or equal to 2.0 and less than or equal to 3.6, greater than or equal to 2.0 and less than or equal to 3.4, greater than or equal to 2.0 and less than or equal to 3.2, greater than or equal to 2.0 and less than or equal to 3.0, greater than or equal to 2.0 and less than or equal to 2.8, greater than or equal to 2.0 and less than or equal to 2.6, greater than or equal to 2.0 and less than or equal to 2.5, greater than or equal to 2.0 and less than or equal to 2.4, greater than or equal to 2.0 and less than or equal to 2.3, greater than or equal to 2.1 and less than or equal to 4.0, greater than or equal to 2.1 and less than or equal to 3.8, greater than or equal to 2.1 and less than or equal to 3.6, greater than or equal to 2.1 and less than or equal to 3.4, greater than or equal to 2.1 and less than or equal to 3.2, greater than or equal to 2.1 and less than or equal to 3.0, greater than or equal to 2.1 and less than or equal to 2.8, greater than or equal to 2.1 and less than or equal to 2.6, greater than or equal to 2.1 and less than or equal to 2.5, greater than or equal to 2.1 and less than or equal to 2.4, greater than or equal to 2.1 and less than or equal to 2.3, greater than or equal to 2.2 and less than or equal to 4.0, greater than or equal to 2.2 and less than or equal to 3.8, greater than or equal to 2.2 and less than or equal to 3.6, greater than or equal to 2.2 and less than or equal to 3.4, greater than or equal to 2.2 and less than or equal to 3.2, greater than or equal to 2.2 and less than or equal to 3.0, greater than or equal to 2.2 and less than or equal to 2.8, greater than or equal to 2.2 and less than or equal to 2.6, greater than or equal to 2.2 and less than or equal to 2.5, or even greater than or equal to 2.2 and less than or equal to 2.4. It should be understood that the above ranges include all subranges within the explicitly disclosed ranges.

As noted herein, the alkali metal oxide Li₂O is generally useful for forming various glass-ceramics. However, other alkali metal oxides tend to decrease glass-ceramic formation and, instead, form an aluminosilicate residual amorphous glass in the glass-ceramics. It has been found that more than about 5 wt % Na₂O or K₂O, or combinations thereof, leads to excessive amorphous residual glass, which can lead to deformation during crystallization and undesirable microstructures from a mechanical property perspective. The composition of the amorphous residual glass may be tailored to control viscosity during crystallization, minimizing deformation or undesirable thermal expansion, or control microstructure properties. Therefore, in general, the precursor glass may comprise relatively low amounts of non-lithium alkali metal oxides. For example, in embodiments, the precursor glass or glass-ceramic can comprise greater than or equal to 0 wt % to less than or equal to 5.5 wt % R₂O, wherein R is one or more of the alkali cations Na and K. In embodiments, the precursor glass or glass-ceramic composition can comprise from greater than or equal to 1 wt % to less than or equal to 3 wt % R₂O, wherein R is one or more of the alkali cations Na and K. In embodiments, the precursor glass or glass-ceramic composition can comprise from greater than or equal to 0.1 wt % to less than or equal to 0.5 wt % R₂O, from greater than or equal to 0.1 wt % to less than or equal to 0.3 wt % R₂O, or even from greater than or equal to 0.1 wt % to less than or equal to 0.25 wt % R₂O, wherein R is one or more of the alkali cations Na and K. It should be understood that, in embodiments, the precursor glass and glass-ceramic does not comprise R₂O. In embodiments, the precusor glass and glass-ceramic are substantially free of R₂O.

In embodiments, the precursor glasses and glass-ceramics comprise greater than or equal to 0 wt % and less than or equal to 2.5 wt % Na₂O, greater than or equal to 0 wt % and less than or equal to 2 wt % Na₂O, greater than or equal to 0 wt % and less than or equal to 1 wt % Na₂O, or even greater than or equal to 0 wt % and less than or equal to 0.5 wt % Na₂O. It should be understood that the above ranges include all subranges within the explicitly disclosed ranges.

In embodiments, the precursor glasses and glass-ceramics comprise greater than or equal to 0 wt % and less than or equal to 3 wt % K₂O, greater than or equal to 0 wt % and less than or equal to 2 wt % K₂O, greater than or equal to 0 wt % and less than or equal to 1 wt % K₂O, greater than or equal to 0.05 wt % and less than or equal to 1 wt % K₂O or even greater than or equal to 0.1 wt % and less than or equal to 1 wt % K₂O. It should be understood that the above ranges include all subranges within the explicitly disclosed ranges.

The precursor glasses and glass-ceramics include P₂O₅. P₂O₅ can function as a nucleating agent to produce bulk nucleation. If the concentration of P₂O₅ is too low, the precursor glass does crystallize, but only at higher temperatures (due to a lower viscosity) and from the surface inward, yielding a weak and often deformed body. However, if the concentration of P₂O₅ is too high, the devitrification, upon cooling during the formation of glass sheets, can be difficult to control. Embodiments of the precursor glasses and glass-ceramics comprise greater than or equal to 0.1 wt % and less than or equal to 5.0 wt % P₂O₅, greater than or equal to 0.5 wt % and less than or equal to 5.0 wt % P₂O₅, greater than or equal to 1.0 wt % and less than or equal to 5.0 wt % P₂O₅, greater than or equal to 1.5 wt % and less than or equal to 5.0 wt % P₂O₅, greater than or equal to 2.0 wt % and less than or equal to 5.0 wt % P₂O₅, greater than or equal to 2.25 wt % and less than or equal to 5.0 wt % P₂O₅, greater than or equal to 2.5 wt % and less than or equal to 5.0 wt % P₂O₅, greater than or equal to 3.0 wt % and less than or equal to 5.0 wt % P₂O₅, greater than or equal to 0.1 wt % and less than or equal to 4.5 wt % P₂O₅, greater than or equal to 0.5 wt % and less than or equal to 4.5 wt % P₂O₅, greater than or equal to 1.0 wt % and less than or equal to 4.5 wt % P₂O₅, greater than or equal to 1.5 wt % and less than or equal to 4.5 wt % P₂O₅, greater than or equal to 2.0 wt % and less than or equal to 4.5 wt % P₂O₅, greater than or equal to 2.25 wt % and less than or equal to 4.5 wt % P₂O₅, greater than or equal to 2.5 wt % and less than or equal to 4.5 wt % P₂O₅, greater than or equal to 3.0 wt % and less than or equal to 4.5 wt % P₂O₅, greater than or equal to 0.1 wt % and less than or equal to 4.0 wt % P₂O₅, greater than or equal to 0.5 wt % and less than or equal to 4.0 wt % P₂O₅, greater than or equal to 1.0 wt % and less than or equal to 4.0 wt % P₂O₅, greater than or equal to 1.5 wt % and less than or equal to 4.0 wt % P₂O₅, greater than or equal to 2.0 wt % and less than or equal to 4.0 wt % P₂O₅, greater than or equal to 2.25 wt % and less than or equal to 4.0 wt % P₂O₅, greater than or equal to 2.5 wt % and less than or equal to 4.0 wt % P₂O₅, greater than or equal to 3.0 wt % and less than or equal to 4.0 wt % P₂O₅, greater than or equal to 0.1 wt % and less than or equal to 3.5 wt % P₂O₅, greater than or equal to 0.5 wt % and less than or equal to 3.5 wt % P₂O₅, greater than or equal to 1.0 wt % and less than or equal to 3.5 wt % P₂O₅, greater than or equal to 1.5 wt % and less than or equal to 3.5 wt % P₂O₅, greater than or equal to 2.0 wt % and less than or equal to 3.5 wt % P₂O₅, greater than or equal to 2.25 wt % and less than or equal to 3.5 wt % P₂O₅, greater than or equal to 2.5 wt % and less than or equal to 3.5 wt % P₂O₅, greater than or equal to 3.0 wt % and less than or equal to 3.5 wt % P₂O₅, greater than or equal to 0.1 wt % and less than or equal to 3.0 wt % P₂O₅, greater than or equal to 0.5 wt % and less than or equal to 3.0 wt % P₂O₅, greater than or equal to 1.0 wt % and less than or equal to 3.0 wt % P₂O₅, greater than or equal to 1.5 wt % and less than or equal to 3.0 wt % P₂O₅, greater than or equal to 2.0 wt % and less than or equal to 3.0 wt % P₂O₅, greater than or equal to 2.25 wt % and less than or equal to 3.0 wt % P₂O₅, greater than or equal to 2.5 wt % and less than or equal to 3.0 wt % P₂O₅, greater than or equal to 0.1 wt % and less than or equal to 2.5 wt % P₂O₅, greater than or equal to 0.5 wt % and less than or equal to 2.5 wt % P₂O₅, greater than or equal to 1.0 wt % and less than or equal to 2.5 wt % P₂O₅, greater than or equal to 1.5 wt % and less than or equal to 2.5 wt % P₂O₅, greater than or equal to 2.0 wt % and less than or equal to 2.5 wt % P₂O₅, greater than or equal to 0.1 wt % and less than or equal to 2.0 wt % P₂O₅, greater than or equal to 0.5 wt % and less than or equal to 2.0 wt % P₂O₅, greater than or equal to 1.0 wt % and less than or equal to 2.0 wt % P₂O₅, greater than or equal to 1.5 wt % and less than or equal to 2.0 wt % P₂O₅, greater than or equal to 0.1 wt % and less than or equal to 1.5 wt % P₂O₅, greater than or equal to 0.5 wt % and less than or equal to 1.5 wt % P₂O₅, greater than or equal to 1.0 wt % and less than or equal to 1.5 wt % P₂O₅, greater than or equal to 0.1 wt % and less than or equal to 1.0 wt % P₂O₅, greater than or equal to 0.5 wt % and less than or equal to 1.0 wt % P₂O₅, or greater than or equal to 0.1 wt % and less than or equal to 0.5 wt % P₂O₅. It should be understood that the above ranges include all subranges within the explicitly disclosed ranges.

In addition to the other effects of ZrO₂ described herein, it is generally found that ZrO₂ can improve the stability of Li₂O—Al₂O₃—SiO₂—P₂O₅ glass by significantly reducing glass devitrification during forming and lowering the liquidus temperature. At concentrations above 8 wt %, ZrSiO₄ can form a primary liquidus phase at a high temperature, which significantly lowers liquidus viscosity. Transparent precusor glasses can be formed when the glass contains over 2 wt % ZrO₂. The addition of ZrO₂ can also help decrease the petalite grain size, which aids in the formation of a transparent glass-ceramic. In embodiments, the precursor glasses and glass-ceramics comprise greater than or equal to 4 wt % and less than or equal to 15 wt % ZrO₂, greater than or equal to 5 wt % and less than or equal to 15 wt % ZrO₂, greater than or equal to 6 wt % and less than or equal to 15 wt % ZrO₂, greater than or equal to 7 wt % and less than or equal to 15 wt % ZrO₂, greater than or equal to 8 wt % and less than or equal to 15 wt % ZrO₂, greater than or equal to 10 wt % and less than or equal to 15 wt % ZrO₂, greater than or equal to 12 wt % and less than or equal to 15 wt % ZrO₂, greater than or equal to 14 wt % and less than or equal to 15 wt % ZrO₂, greater than or equal to 4 wt % and less than or equal to 14 wt % ZrO₂, greater than or equal to 5 wt % and less than or equal to 14 wt % ZrO₂, greater than or equal to 6 wt % and less than or equal to 14 wt % ZrO₂, greater than or equal to 7 wt % and less than or equal to 14 wt % ZrO₂, greater than or equal to 8 wt % and less than or equal to 14 wt % ZrO₂, greater than or equal to 10 wt % and less than or equal to 14 wt % ZrO₂, greater than or equal to 12 wt % and less than or equal to 14 wt % ZrO₂, greater than or equal to 4 wt % and less than or equal to 12 wt % ZrO₂, greater than or equal to 5 wt % and less than or equal to 12 wt % ZrO₂, greater than or equal to 6 wt % and less than or equal to 12 wt % ZrO₂, greater than or equal to 7 wt % and less than or equal to 12 wt % ZrO₂, greater than or equal to 8 wt % and less than or equal to 12 wt % ZrO₂, greater than or equal to 10 wt % and less than or equal to 12 wt % ZrO₂, greater than or equal to 4 wt % and less than or equal to 10 wt % ZrO₂, greater than or equal to 5 wt % and less than or equal to 10 wt % ZrO₂, greater than or equal to 6 wt % and less than or equal to 10 wt % ZrO₂, greater than or equal to 7 wt % and less than or equal to 10 wt % ZrO₂, greater than or equal to 8 wt % and less than or equal to 10 wt % ZrO₂, greater than or equal to 4 wt % and less than or equal to 9 wt % ZrO₂, greater than or equal to 6 wt % and less than or equal to 9 wt % ZrO₂, or greater than or equal to 7 wt % and less than or equal to 9 wt % ZrO₂. It should be understood that the above ranges include all subranges within the explicitly disclosed ranges.

As noted herein, it has been found that when the ratio of Li₂O (wt %) to ZrO₂ (wt %) (i.e., Li₂O:ZrO₂) in the precursor glasses and resulting glass-ceramics is in the range from greater than or equal to 1.20 to less than or equal to 1.70, the central tension in the glass-ceramics as a result of strengthening by ion exchange can be maximized. In embodiments, the ratio of Li₂O to ZrO₂ in the precursor glasses and glass-ceramics is greater than or equal to 1.30 to less than or equal to 1.70, greater than or equal to 1.35 to less than or equal to 1.70, greater than or equal to 1.40 to less than or equal to 1.70, greater than or equal to 1.45 to less than or equal to 1.70, greater than or equal to 1.50 to less than or equal to 1.70, greater than or equal to 1.55 to less than or equal to 1.70, greater than or equal to 1.60 to less than or equal to 1.70, greater than or equal to 1.20 to less than or equal to 1.65, greater than or equal to 1.20 to less than or equal to 1.60, greater than or equal to 1.20 to less than or equal to 1.55, greater than or equal to 1.20 to less than or equal to 1.50, greater than or equal to 1.20 to less than or equal to 1.45, greater than or equal to 1.20 to less than or equal to 1.40, greater than or equal to 1.25 to less than or equal to 1.65, greater than or equal to 1.30 to less than or equal to 1.60, greater than or equal to 1.35 to less than or equal to 1.55, or even greater than or equal to 1.40 to less than or equal to 1.50. It should be understood that the above ranges include all subranges within the explicitly disclosed ranges.

In embodiments, a ratio of Al₂O₃ (wt %) to ZrO₂ (wt %) (i.e., Al₂O₃:ZrO₂) may be greater than 0 and less than or equal to 1. Without wishing to be bound by theory, it is believed that ratios of Al₂O₃ to ZrO₂ within the range of greater than 0 to less than or equal to 1 may lower the liquidus viscosity of the precursor glasses. In embodiments, the ratio of Al₂O₃ to ZrO₂ may be greater than or equal to 0.1 and less than or equal to 0.9, greater than or equal to 0.15 and less than or equal to 0.85, greater than or equal to 0.20 and less than or equal to 0.80, greater than or equal to 0.25 and less than or equal to 0.75, greater than or equal to 0.30 and less than or equal to 0.70, greater than or equal to 0.35 and less than or equal to 0.65, or even greater than or equal to 0.40 and less than or equal to 0.65. It should be understood that the above ranges include all subranges within the explicitly disclosed ranges.

CaO can enter petalite crystals in a partial solid solution. In embodiments, the precursor glasses and glass-ceramics comprise greater than or equal to 0.05 wt % and less than or equal to 4.0 wt % CaO, greater than or equal to 0.1 wt % and less than or equal to 4.0 wt % CaO, greater than or equal to 0.5 wt % and less than or equal to 4.0 wt % CaO, greater than or equal to 1.0 wt % and less than or equal to 4.0 wt % CaO, greater than or equal to 1.5 wt % and less than or equal to 4.0 wt % CaO, greater than or equal to 2.0 wt % and less than or equal to 4.0 wt % CaO, greater than or equal to 2.5 wt % and less than or equal to 4.0 wt % CaO, greater than or equal to 3.0 wt % and less than or equal to 4.0 wt % CaO, greater than or equal to 3.5 wt % and less than or equal to 4.0 wt % CaO, greater than or equal to 0.05 wt % and less than or equal to 3.5 wt % CaO, greater than or equal to 0.1 wt % and less than or equal to 3.5 wt % CaO, greater than or equal to 0.5 wt % and less than or equal to 3.5 wt % CaO, greater than or equal to 1.0 wt % and less than or equal to 3.5 wt % CaO, greater than or equal to 1.5 wt % and less than or equal to 3.5 wt % CaO, greater than or equal to 2.0 wt % and less than or equal to 3.5 wt % CaO, greater than or equal to 2.5 wt % and less than or equal to 3.5 wt % CaO, greater than or equal to 3.0 wt % and less than or equal to 3.5 wt % CaO, greater than or equal to 0.05 wt % and less than or equal to 3.0 wt % CaO, greater than or equal to 0.1 wt % and less than or equal to 3.0 wt % CaO, greater than or equal to 0.5 wt % and less than or equal to 3.0 wt % CaO, greater than or equal to 1.0 wt % and less than or equal to 3.0 wt % CaO, greater than or equal to 1.5 wt % and less than or equal to 3.0 wt % CaO, greater than or equal to 2.0 wt % and less than or equal to 3.0 wt % CaO, greater than or equal to 2.5 wt % and less than or equal to 3.0 wt % CaO, greater than or equal to 0.05 wt % and less than or equal to 2.5 wt % CaO, greater than or equal to 0.1 wt % and less than or equal to 2.5 wt % CaO, greater than or equal to 0.5 wt % and less than or equal to 2.5 wt % CaO, greater than or equal to 1.0 wt % and less than or equal to 2.5 wt % CaO, greater than or equal to 1.5 wt % and less than or equal to 2.5 wt % CaO, greater than or equal to 2.0 wt % and less than or equal to 2.5 wt % CaO, greater than or equal to 0.05 wt % and less than or equal to 2.0 wt % CaO, greater than or equal to 0.1 wt % and less than or equal to 2.0 wt % CaO, greater than or equal to 0.5 wt % and less than or equal to 2.0 wt % CaO, greater than or equal to 1.0 wt % and less than or equal to 2.0 wt % CaO, greater than or equal to 1.5 wt % and less than or equal to 2.0 wt % CaO, greater than or equal to 0.05 wt % and less than or equal to 1.5 wt % CaO, greater than or equal to 0.1 wt % and less than or equal to 1.5 wt % CaO, greater than or equal to 0.5 wt % and less than or equal to 1.5 wt % CaO, greater than or equal to 1.0 wt % and less than or equal to 1.5 wt % CaO, greater than or equal to 0.05 wt % and less than or equal to 1.0 wt % CaO, greater than or equal to 0.1 wt % and less than or equal to 1.0 wt % CaO, greater than or equal to 0.5 wt % and less than or equal to 1.0 wt % CaO, greater than or equal to 0.05 wt % and less than or equal to 0.5 wt % CaO, greater than or equal to 0.1 wt % and less than or equal to 0.5 wt % CaO, or greater than or equal to 0.05 wt % and less than or equal to 0.1 wt % CaO. It should be understood that the above ranges include all subranges within the explicitly disclosed ranges.

In embodiments, the precursor glasses or glass-ceramics may further include MgO. Without wishing to be bound by theory, it is believed that additions of MgO may enter the residual amorphous glass phase or the petalite crystalline phase. It is believed that additions of MgO that enter the residual amorphous glass phase may decrease the diffusivity of alkali ions in the glass, such as during ion exchange. As such, the content of MgO in the embodiments described herein is limited to 2.0 wt % to avoid any deleterious effects on ion exchange performance. In embodiments, the precursor glasses and glass-ceramics comprise greater than or equal to 0 wt % and less than or equal to 2.0 wt % MgO, greater than or equal to 0 wt % and less than or equal to 1.5 wt % MgO, greater than or equal to 0 wt % and less than or equal to 1.0 wt % MgO, greater than or equal to 0 wt % and less than or equal to 0.5 wt % MgO, greater than or equal to 0.1 wt % and less than or equal to 2.0 wt % MgO, greater than or equal to 0.1 wt % and less than or equal to 1.5 wt % MgO, greater than or equal to 0.1 wt % and less than or equal to 1.0 wt % MgO, or even greater than or equal to 0.1 wt % and less than or equal to 0.5 wt % MgO. In embodiments, the precursor glasses and glass-ceramics do not include MgO. In embodiments, the precursor glasses and glass-ceramics are substantially free of MgO. It should be understood that the above ranges include all subranges within the explicitly disclosed ranges.

In embodiments, the precursor glasses or glass-ceramics may further include SrO. Without wishing to be bound by theory, it is believed that SrO, when present, may increase the amount of residual glass in the resultant glass-ceramics. In embodiments, the precursor glasses and glass-ceramics comprise greater than or equal to 0 wt % and less than or equal to 2.0 wt % SrO, greater than or equal to 0 wt % and less than or equal to 1.5 wt % SrO, greater than or equal to 0 wt % and less than or equal to 1.0 wt % SrO, greater than or equal to 0 wt % and less than or equal to 0.5 wt % SrO, greater than or equal to 0.1 wt % and less than or equal to 2.0 wt % SrO, greater than or equal to 0.1 wt % and less than or equal to 1.5 wt % SrO, greater than or equal to 0.1 wt % and less than or equal to 1.0 wt % SrO, or even greater than or equal to 0.1 wt % and less than or equal to 0.5 wt % SrO. In embodiments, the precursor glasses and glass-ceramics do not include SrO. In embodiments, the precursor glasses and glass-ceramics are substantially free of SrO. It should be understood that the above ranges include all subranges within the explicitly disclosed ranges.

In embodiments, the precursor glasses or glass-ceramics may further include BaO. Without wishing to be bound by theory, it is believed that BaO, when present, may increase the amount of residual glass in the resultant glass-ceramics. In embodiments, the precursor glasses and glass-ceramics comprise greater than or equal to 0 wt % and less than or equal to 2.0 wt % BaO, greater than or equal to 0 wt % and less than or equal to 1.5 wt % BaO, greater than or equal to 0 wt % and less than or equal to 1.0 wt % BaO, greater than or equal to 0 wt % and less than or equal to 0.5 wt % BaO, greater than or equal to 0.1 wt % and less than or equal to 2.0 wt % BaO, greater than or equal to 0.1 wt % and less than or equal to 1.5 wt % BaO, greater than or equal to 0.1 wt % and less than or equal to 1.0 wt % BaO, or even greater than or equal to 0.1 wt % and less than or equal to 0.5 wt % BaO. In embodiments, the precursor glasses and glass-ceramics do not include BaO. In embodiments, the precursor glasses and glass-ceramics are substantially free of BaO. It should be understood that the above ranges include all subranges within the explicitly disclosed ranges.

In embodiments, the precursor glasses or glass-ceramics may further include ZnO. In embodiments, the precursor glasses and glass-ceramics comprise greater than or equal to 0 wt % and less than or equal to 4.0 wt % ZnO, greater than or equal to 0 wt % and less than or equal to 3.0 wt % ZnO, greater than or equal to 0 wt % and less than or equal to 2.5 wt % ZnO, greater than or equal to 0 wt % and less than or equal to 2.0 wt % ZnO, greater than or equal to 0 wt % and less than or equal to 1.5 wt % ZnO, greater than or equal to 0 wt % and less than or equal to 1.0 wt % ZnO, greater than or equal to 0 wt % and less than or equal to 0.5 wt % ZnO, greater than or equal to 0.1 wt % and less than or equal to 4.0 wt % ZnO, greater than or equal to 0.1 to less than or equal to 3 wt % ZnO, greater than or equal to 0.1 wt % and less than or equal to 2.5 wt % ZnO, greater than or equal to 0.1 wt % and less than or equal to 2.0 wt % ZnO, greater than or equal to 0.1 wt % and less than or equal to 1.5 wt % ZnO, greater than or equal to 0.1 wt % and less than or equal to 1.0 wt % ZnO, or even greater than or equal to 0.1 wt % and less than or equal to 0.5 wt % ZnO. In embodiments, the precursor glasses and glass-ceramics do not include ZnO. In embodiments, the precursor glasses and glass-ceramics are substantially free of ZnO. It should be understood that the above ranges include all subranges within the explicitly disclosed ranges.

In embodiments, the precursor glasses or glass-ceramics may further include B₂O₃. Without wishing to be bound by theory, it is believed that additions of B₂O₃ may partition into the amorphous residual glass. It is also believed that addition so B₂O₃ may lower the viscosity of the precursor glass at ceramming temperatures. In embodiments, the precursor glasses and glass-ceramics comprise greater than or equal to 0 wt % and less than or equal to 2.0 wt % B₂O₃, greater than or equal to 0 wt % and less than or equal to 1.5 wt % B₂O₃, greater than or equal to 0 wt % and less than or equal to 1.0 wt % B₂O₃, greater than or equal to 0 wt % and less than or equal to 0.5 wt % B₂O₃, greater than or equal to 0.1 wt % and less than or equal to 2.0 wt % B₂O₃, greater than or equal to 0.1 wt % and less than or equal to 1.5 wt % B₂O₃, greater than or equal to 0.1 wt % and less than or equal to 1.0 wt % B₂O₃, or even greater than or equal to 0.1 wt % and less than or equal to 0.5 wt % B₂O₃. In embodiments, the precursor glasses and glass-ceramics do not include B₂O₃. In embodiments, the precursor glasses and glass-ceramics are substantially free of B₂O₃. It should be understood that the above ranges include all subranges within the explicitly disclosed ranges.

Fe₂O₃ can lower the melting point of the precursor glasses and glass-ceramics. However, adding too much Fe₂O₃ can alter the color of the precursor glass and glass-ceramics. In embodiments, the precursor glasses and glass-ceramics do not comprise Fe₂O₃. In embodiments, the precursor glasses and glass-ceramics are substantially free of Fe₂O₃. In embodiments, the precursor glasses and glass-ceramics comprise greater than 0.0 wt % and less than or equal to 1.0 wt % Fe₂O₃, greater than or equal to 0 wt % and less than or equal to 0.5 wt % Fe₂O₃, greater than 0.0 wt % and less than or equal to 0.3 wt % Fe₂O₃, greater than or equal to 0.0 wt % and less than or equal to 0.2 wt % Fe₂O₃, or greater than 0.0 wt % and less than or equal to 0.1 wt % Fe₂O₃. It should be understood that the above ranges include all subranges within the explicitly disclosed ranges.

In embodiments, the precursor glasses or glass-ceramics may further include HfO₂. Without wishing to be bound by theory, it is believed that additions of HfO₂ may at least partially replace ZrO₂ in the compositions. In embodiments, the precursor glasses and glass-ceramics comprise greater than or equal to 0 wt % and less than or equal to 3.0 wt % HfO₂, greater than or equal to 0 wt % and less than or equal to 2.5 wt % HfO₂, greater than or equal to 0 wt % and less than or equal to 2.0 wt % HfO₂, greater than or equal to 0 wt % and less than or equal to 1.5 wt % HfO₂, greater than or equal to 0 wt % and less than or equal to 1.0 wt % HfO₂, greater than or equal to 0 wt % and less than or equal to 0.5 wt % HfO₂, greater than or equal to 0.1 to less than or equal to 3 wt % HfO₂, greater than or equal to 0.1 wt % and less than or equal to 2.5 wt % HfO₂, greater than or equal to 0.1 wt % and less than or equal to 2.0 wt % HfO₂, greater than or equal to 0.1 wt % and less than or equal to 1.5 wt % HfO₂, greater than or equal to 0.1 wt % and less than or equal to 1.0 wt % HfO₂, or even greater than or equal to 0.1 wt % and less than or equal to 0.5 wt % HfO₂. In embodiments, the precursor glasses and glass-ceramics do not include HfO₂. In embodiments, the precursor glasses and glass-ceramics are substantially free of HfO₂. It should be understood that the above ranges include all subranges within the explicitly disclosed ranges.

In embodiments, the precursor glasses or glass-ceramics may further include Y₂O₃. Without wishing to be bound by theory, it is believed that additions of Y₂O₃ may increase the refractive index of the precursor glasses and resulting glass-ceramics. In embodiments, the precursor glasses and glass-ceramics comprise greater than or equal to 0 wt % and less than or equal to 2.0 wt % Y₂O₃, greater than or equal to 0 wt % and less than or equal to 1.5 wt % Y₂O₃, greater than or equal to 0 wt % and less than or equal to 1.0 wt % Y₂O₃, greater than or equal to 0 wt % and less than or equal to 0.5 wt % Y₂O₃, greater than or equal to 0.1 wt % and less than or equal to 2.0 wt % Y₂O₃, greater than or equal to 0.1 wt % and less than or equal to 1.5 wt % Y₂O₃, greater than or equal to 0.1 wt % and less than or equal to 1.0 wt % Y₂O₃, or even greater than or equal to 0.1 wt % and less than or equal to 0.5 wt % Y₂O₃. In embodiments, the precursor glasses and glass-ceramics do not include Y₂O₃. In embodiments, the precursor glasses and glass-ceramics are substantially free of Y₂O₃. It should be understood that the above ranges include all subranges within the explicitly disclosed ranges.

In embodiments, the precursor glasses or glass-ceramics may further include La₂O₃. Without wishing to be bound by theory, it is believed that additions of La₂O₃ may increase the refractive index of the precursor glasses and resulting glass-ceramics. It is also believed that additions of La₂O₃ may change the liquidus temperature of the precusor glass. In embodiments, the precursor glasses and glass-ceramics comprise greater than or equal to 0 wt % and less than or equal to 2.0 wt % La₂O₃, greater than or equal to 0 wt % and less than or equal to 1.5 wt % La₂O₃, greater than or equal to 0 wt % and less than or equal to 1.0 wt % La₂O₃, greater than or equal to 0 wt % and less than or equal to 0.5 wt % La₂O₃, greater than or equal to 0.1 wt % and less than or equal to 2.0 wt % La₂O₃, greater than or equal to 0.1 wt % and less than or equal to 1.5 wt % La₂O₃, greater than or equal to 0.1 wt % and less than or equal to 1.0 wt % La₂O₃, or even greater than or equal to 0.1 wt % and less than or equal to 0.5 wt % La₂O₃. In embodiments, the precursor glasses and glass-ceramics do not include La₂O₃. In embodiments, the precursor glasses and glass-ceramics are substantially free of La₂O₃. It should be understood that the above ranges include all subranges within the explicitly disclosed ranges.

In embodiments, the precursor glasses or glass-ceramics may further include CeO₂. In embodiments, the precursor glasses and glass-ceramics comprise greater than or equal to 0 wt % and less than or equal to 2.0 wt % CeO₂, greater than or equal to 0 wt % and less than or equal to 1.5 wt % CeO₂, greater than or equal to 0 wt % and less than or equal to 1.0 wt % CeO₂, greater than or equal to 0 wt % and less than or equal to 0.5 wt % CeO₂, greater than or equal to 0.1 wt % and less than or equal to 2.0 wt % CeO₂, greater than or equal to 0.1 wt % and less than or equal to 1.5 wt % CeO₂, greater than or equal to 0.1 wt % and less than or equal to 1.0 wt % CeO₂, or even greater than or equal to 0.1 wt % and less than or equal to 0.5 wt % CeO₂. In embodiments, the precursor glasses and glass-ceramics do not include CeO₂. In embodiments, the precursor glasses and glass-ceramics are substantially free of CeO₂. It should be understood that the above ranges include all subranges within the explicitly disclosed ranges.

In embodiments, the precursor glasses or glass-ceramics may further include Eu₂O₃. In embodiments, the precursor glasses and glass-ceramics comprise greater than or equal to 0 wt % and less than or equal to 2.0 wt % Eu₂O₃, greater than or equal to 0 wt % and less than or equal to 1.5 wt % Eu₂O₃, greater than or equal to 0 wt % and less than or equal to 1.0 wt % Eu₂O₃, greater than or equal to 0 wt % and less than or equal to 0.5 wt % Eu₂O₃, greater than or equal to 0.1 wt % and less than or equal to 2.0 wt % Eu₂O₃, greater than or equal to 0.1 wt % and less than or equal to 1.5 wt % Eu₂O₃, greater than or equal to 0.1 wt % and less than or equal to 1.0 wt % Eu₂O₃, or even greater than or equal to 0.1 wt % and less than or equal to 0.5 wt % Eu₂O₃. In embodiments, the precursor glasses and glass-ceramics do not include Eu₂O₃. In embodiments, the precursor glasses and glass-ceramics are substantially free of Eu₂O₃. It should be understood that the above ranges include all subranges within the explicitly disclosed ranges.

In embodiments, the precursor glasses or glass-ceramics may further include Dy₂O₃. In embodiments, the precursor glasses and glass-ceramics comprise greater than or equal to 0 wt % and less than or equal to 2.0 wt % Dy₂O₃, greater than or equal to 0 wt % and less than or equal to 1.5 wt % Dy₂O₃, greater than or equal to 0 wt % and less than or equal to 1.0 wt % Dy₂O₃, greater than or equal to 0 wt % and less than or equal to 0.5 wt % Dy₂O₃, greater than or equal to 0.1 wt % and less than or equal to 2.0 wt % Dy₂O₃, greater than or equal to 0.1 wt % and less than or equal to 1.5 wt % Dy₂O₃, greater than or equal to 0.1 wt % and less than or equal to 1.0 wt % Dy₂O₃, or even greater than or equal to 0.1 wt % and less than or equal to 0.5 wt % Dy₂O₃. In embodiments, the precursor glasses and glass-ceramics do not include Dy₂O₃. In embodiments, the precursor glasses and glass-ceramics are substantially free of Dy₂O₃. It should be understood that the above ranges include all subranges within the explicitly disclosed ranges.

In embodiments, the precursor glasses or glass-ceramics may further include Tb₄O₇. In embodiments, the precursor glasses and glass-ceramics comprise greater than or equal to 0 wt % and less than or equal to 2.0 wt % Tb₄O₇, greater than or equal to 0 wt % and less than or equal to 1.5 wt % Tb₄O₇, greater than or equal to 0 wt % and less than or equal to 1.0 wt % Tb₄O₇, greater than or equal to 0 wt % and less than or equal to 0.5 wt % Tb₄O₇, greater than or equal to 0.1 wt % and less than or equal to 2.0 wt % Tb₄O₇, greater than or equal to 0.1 wt % and less than or equal to 1.5 wt % Tb₄O₇, greater than or equal to 0.1 wt % and less than or equal to 1.0 wt % Tb₄O₇, or even greater than or equal to 0.1 wt % and less than or equal to 0.5 wt % Tb₄O₇. In embodiments, the precursor glasses and glass-ceramics do not include Tb₄O₇. In embodiments, the precursor glasses and glass-ceramics are substantially free of Tb₄O₇. It should be understood that the above ranges include all subranges within the explicitly disclosed ranges.

In embodiments, the precursor glasses or glass-ceramics may further include Yb₂O₃. In embodiments, the precursor glasses and glass-ceramics comprise greater than or equal to 0 wt % and less than or equal to 2.0 wt % Yb₂O₃, greater than or equal to 0 wt % and less than or equal to 1.5 wt % Yb₂O₃, greater than or equal to 0 wt % and less than or equal to 1.0 wt % Yb₂O₃, greater than or equal to 0 wt % and less than or equal to 0.5 wt % Yb₂O₃, greater than or equal to 0.1 wt % and less than or equal to 2.0 wt % Yb₂O₃, greater than or equal to 0.1 wt % and less than or equal to 1.5 wt % Yb₂O₃, greater than or equal to 0.1 wt % and less than or equal to 1.0 wt % Yb₂O₃, or even greater than or equal to 0.1 wt % and less than or equal to 0.5 wt % Yb₂O₃. In embodiments, the precursor glasses and glass-ceramics do not include Yb₂O₃. In embodiments, the precursor glasses and glass-ceramics are substantially free of Yb₂O₃. It should be understood that the above ranges include all subranges within the explicitly disclosed ranges.

In embodiments, the precursor glasses or glass-ceramics may further include Gd₂O₃. In embodiments, the precursor glasses and glass-ceramics comprise greater than or equal to 0 wt % and less than or equal to 2.0 wt % Gd₂O₃, greater than or equal to 0 wt % and less than or equal to 1.5 wt % Gd₂O₃, greater than or equal to 0 wt % and less than or equal to 1.0 wt % Gd₂O₃, greater than or equal to 0 wt % and less than or equal to 0.5 wt % Gd₂O₃, greater than or equal to 0.1 wt % and less than or equal to 2.0 wt % Gd₂O₃, greater than or equal to 0.1 wt % and less than or equal to 1.5 wt % Gd₂O₃, greater than or equal to 0.1 wt % and less than or equal to 1.0 wt % Gd₂O₃, or even greater than or equal to 0.1 wt % and less than or equal to 0.5 wt % Gd₂O₃. In embodiments, the precursor glasses and glass-ceramics do not include Gd₂O₃. In embodiments, the precursor glasses and glass-ceramics are substantially free of Gd₂O₃. It should be understood that the above ranges include all subranges within the explicitly disclosed ranges.

In embodiments, the precursor glasses or glass-ceramics may further include Tm₂O₃. In embodiments, the precursor glasses and glass-ceramics comprise greater than or equal to 0 wt % and less than or equal to 2.0 wt % Tm₂O₃, greater than or equal to 0 wt % and less than or equal to 1.5 wt % Tm₂O₃, greater than or equal to 0 wt % and less than or equal to 1.0 wt % Tm₂O₃, greater than or equal to 0 wt % and less than or equal to 0.5 wt % Tm₂O₃, greater than or equal to 0.1 wt % and less than or equal to 2.0 wt % Tm₂O₃, greater than or equal to 0.1 wt % and less than or equal to 1.5 wt % Tm₂O₃, greater than or equal to 0.1 wt % and less than or equal to 1.0 wt % Tm₂O₃, or even greater than or equal to 0.1 wt % and less than or equal to 0.5 wt % Tm₂O₃. In embodiments, the precursor glasses and glass-ceramics do not include Tm₂O₃. In embodiments, the precursor glasses and glass-ceramics are substantially free of Tm₂O₃. It should be understood that the above ranges include all subranges within the explicitly disclosed ranges.

In embodiments, the precursor glasses or glass-ceramics may further include Lu₂O₃. In embodiments, the precursor glasses and glass-ceramics comprise greater than or equal to 0 wt % and less than or equal to 2.0 wt % Lu₂O₃, greater than or equal to 0 wt % and less than or equal to 1.5 wt % Lu₂O₃, greater than or equal to 0 wt % and less than or equal to 1.0 wt % Lu₂O₃, greater than or equal to 0 wt % and less than or equal to 0.5 wt % Lu₂O₃, greater than or equal to 0.1 wt % and less than or equal to 2.0 wt % Lu₂O₃, greater than or equal to 0.1 wt % and less than or equal to 1.5 wt % Lu₂O₃, greater than or equal to 0.1 wt % and less than or equal to 1.0 wt % Lu₂O₃, or even greater than or equal to 0.1 wt % and less than or equal to 0.5 wt % Lu₂O₃. In embodiments, the precursor glasses and glass-ceramics do not include Lu₂O₃. In embodiments, the precursor glasses and glass-ceramics are substantially free of Lu₂O₃. It should be understood that the above ranges include all subranges within the explicitly disclosed ranges.

In embodiments, the precursor glasses or glass-ceramics may further include Nd₂O₃. In embodiments, the precursor glasses and glass-ceramics comprise greater than or equal to 0 wt % and less than or equal to 0.5 wt % Nd₂O₃, greater than or equal to 0 wt % and less than or equal to 0.4 wt % Nd₂O₃, greater than or equal to 0 wt % and less than or equal to 0.3 wt % Nd₂O₃, greater than or equal to 0 wt % and less than or equal to 0.2 wt % Nd₂O₃, greater than or equal to 0 wt % and less than or equal to 0.1 wt % Nd₂O₃, greater than or equal to 0.1 wt % and less than or equal to 0.5 wt % Nd₂O₃, greater than or equal to 0.1 wt % and less than or equal to 0.4 wt % Nd₂O₃, greater than or equal to 0.1 wt % and less than or equal to 0.3 wt % Nd₂O₃, or even greater than or equal to 0.1 wt % and less than or equal to 0.2 wt % Nd₂O₃. In embodiments, the precursor glasses and glass-ceramics do not include Nd₂O₃. In embodiments, the precursor glasses and glass-ceramics are substantially free of Nd₂O₃. It should be understood that the above ranges include all subranges within the explicitly disclosed ranges.

In embodiments, the precursor glasses or glass-ceramics may further include Pr₂O₃. In embodiments, the precursor glasses and glass-ceramics comprise greater than or equal to 0 wt % and less than or equal to 0.5 wt % Pr₂O₃, greater than or equal to 0 wt % and less than or equal to 0.4 wt % Pr₂O₃, greater than or equal to 0 wt % and less than or equal to 0.3 wt % Pr₂O₃, greater than or equal to 0 wt % and less than or equal to 0.2 wt % Pr₂O₃, greater than or equal to 0 wt % and less than or equal to 0.1 wt % Pr₂O₃, greater than or equal to 0.1 wt % and less than or equal to 0.5 wt % Pr₂O₃, greater than or equal to 0.1 wt % and less than or equal to 0.4 wt % Pr₂O₃, greater than or equal to 0.1 wt % and less than or equal to 0.3 wt % Pr₂O₃, or even greater than or equal to 0.1 wt % and less than or equal to 0.2 wt % Pr₂O₃. In embodiments, the precursor glasses and glass-ceramics do not include Pr₂O₃. In embodiments, the precursor glasses and glass-ceramics are substantially free of Pr₂O₃. It should be understood that the above ranges include all subranges within the explicitly disclosed ranges.

In embodiments, the precursor glasses or glass-ceramics may further include Er₂O₃. In embodiments, the precursor glasses and glass-ceramics comprise greater than or equal to 0 wt % and less than or equal to 0.5 wt % Er₂O₃, greater than or equal to 0 wt % and less than or equal to 0.4 wt % Er₂O₃, greater than or equal to 0 wt % and less than or equal to 0.3 wt % Er₂O₃, greater than or equal to 0 wt % and less than or equal to 0.2 wt % Er₂O₃, greater than or equal to 0 wt % and less than or equal to 0.1 wt % Er₂O₃, greater than or equal to 0.1 wt % and less than or equal to 0.5 wt % Er₂O₃, greater than or equal to 0.1 wt % and less than or equal to 0.4 wt % Er₂O₃, greater than or equal to 0.1 wt % and less than or equal to 0.3 wt % Er₂O₃, or even greater than or equal to 0.1 wt % and less than or equal to 0.2 wt % Er₂O₃. In embodiments, the precursor glasses and glass-ceramics do not include Er₂O₃. In embodiments, the precursor glasses and glass-ceramics are substantially free of Er₂O₃. It should be understood that the above ranges include all subranges within the explicitly disclosed ranges.

In embodiments, the precursor glasses or glass-ceramics may further include Sm₂O₃. In embodiments, the precursor glasses and glass-ceramics comprise greater than or equal to 0 wt % and less than or equal to 0.5 wt % Sm₂O₃, greater than or equal to 0 wt % and less than or equal to 0.4 wt % Sm₂O₃, greater than or equal to 0 wt % and less than or equal to 0.3 wt % Sm₂O₃, greater than or equal to 0 wt % and less than or equal to 0.2 wt % Sm₂O₃, greater than or equal to 0 wt % and less than or equal to 0.1 wt % Sm₂O₃, greater than or equal to 0.1 wt % and less than or equal to 0.5 wt % Sm₂O₃, greater than or equal to 0.1 wt % and less than or equal to 0.4 wt % Sm₂O₃, greater than or equal to 0.1 wt % and less than or equal to 0.3 wt % Sm₂O₃, or even greater than or equal to 0.1 wt % and less than or equal to 0.2 wt % Sm₂O₃. In embodiments, the precursor glasses and glass-ceramics do not include Sm₂O₃. In embodiments, the precursor glasses and glass-ceramics are substantially free of Sm₂O₃. It should be understood that the above ranges include all subranges within the explicitly disclosed ranges.

In embodiments, the precursor glasses or glass-ceramics may further include HO₂O₃. In embodiments, the precursor glasses and glass-ceramics comprise greater than or equal to 0 wt % and less than or equal to 0.5 wt % HO₂O₃, greater than or equal to 0 wt % and less than or equal to 0.4 wt % HO₂O₃, greater than or equal to 0 wt % and less than or equal to 0.3 wt % HO₂O₃, greater than or equal to 0 wt % and less than or equal to 0.2 wt % HO₂O₃, greater than or equal to 0 wt % and less than or equal to 0.1 wt % HO₂O₃, greater than or equal to 0.1 wt % and less than or equal to 0.5 wt % HO₂O₃, greater than or equal to 0.1 wt % and less than or equal to 0.4 wt % HO₂O₃, greater than or equal to 0.1 wt % and less than or equal to 0.3 wt % HO₂O₃, or even greater than or equal to 0.1 wt % and less than or equal to 0.2 wt % HO₂O₃. In embodiments, the precursor glasses and glass-ceramics do not include HO₂O₃. In embodiments, the precursor glasses and glass-ceramics are substantially free of HO₂O₃. It should be understood that the above ranges include all subranges within the explicitly disclosed ranges.

In embodiments, the precursor glasses or glass-ceramics may further include Pm₂O₃. In embodiments, the precursor glasses and glass-ceramics comprise greater than or equal to 0 wt % and less than or equal to 0.5 wt % Pm₂O₃, greater than or equal to 0 wt % and less than or equal to 0.4 wt % Pm₂O₃, greater than or equal to 0 wt % and less than or equal to 0.3 wt % Pm₂O₃, greater than or equal to 0 wt % and less than or equal to 0.2 wt % Pm₂O₃, greater than or equal to 0 wt % and less than or equal to 0.1 wt % Pm₂O₃, greater than or equal to 0.1 wt % and less than or equal to 0.5 wt % Pm₂O₃, greater than or equal to 0.1 wt % and less than or equal to 0.4 wt % Pm₂O₃, greater than or equal to 0.1 wt % and less than or equal to 0.3 wt % Pm₂O₃, or even greater than or equal to 0.1 wt % and less than or equal to 0.2 wt % Pm₂O₃. In embodiments, the precursor glasses and glass-ceramics do not include Pm₂O₃. In embodiments, the precursor glasses and glass-ceramics are substantially free of Pm₂O₃. It should be understood that the above ranges include all subranges within the explicitly disclosed ranges.

In embodiments, the precursor glasses or glass-ceramics may further include Ta₂O₅. Without wishing to be bound by theory, it is believed that additions of Ta₂O₅ may increase the refractive index of the precursor glasses and resulting glass-ceramics. It is also believed that additions of Ta₂O₅ may increase the elastic modulus of the precursor glasses and resulting glass-ceramics. In embodiments, the precursor glasses and glass-ceramics comprise greater than or equal to 0 wt % and less than or equal to 2.0 wt % Ta₂O₅, greater than or equal to 0 wt % and less than or equal to 1.5 wt % Ta₂O₅, greater than or equal to 0 wt % and less than or equal to 1.0 wt % Ta₂O₅, greater than or equal to 0 wt % and less than or equal to 0.5 wt % Ta₂O₅, greater than or equal to 0.1 wt % and less than or equal to 2.0 wt % Ta₂O₅, greater than or equal to 0.1 wt % and less than or equal to 1.5 wt % Ta₂O₅, greater than or equal to 0.1 wt % and less than or equal to 1.0 wt % Ta₂O₅, or even greater than or equal to 0.1 wt % and less than or equal to 0.5 wt % Ta₂O₅. In embodiments, the precursor glasses and glass-ceramics do not include Ta₂O₅. In embodiments, the precursor glasses and glass-ceramics are substantially free of Ta₂O₅. It should be understood that the above ranges include all subranges within the explicitly disclosed ranges.

In embodiments, the precursor glasses or glass-ceramics may further include GeO₂. Without wishing to be bound by theory, it is believed that additions of GeO₂ may increase the refractive index of the precursor glasses and resulting glass-ceramics. In embodiments, the precursor glasses and glass-ceramics comprise greater than or equal to 0 wt % and less than or equal to 5.0 wt % GeO₂, greater than or equal to 0 wt % and less than or equal to 4.5 wt % GeO₂, greater than or equal to 0 wt % and less than or equal to 4.0 wt % GeO₂, greater than or equal to 0 wt % and less than or equal to 3.5 wt % GeO₂, greater than or equal to 0 wt % and less than or equal to 3.0 wt % GeO₂, greater than or equal to 0 wt % and less than or equal to 2.5 wt % GeO₂, greater than or equal to 0 wt % and less than or equal to 2.0 wt % GeO₂, greater than or equal to 0 wt % and less than or equal to 1.5 wt % GeO₂, greater than or equal to 0 wt % and less than or equal to 1.0 wt % GeO₂, greater than or equal to 0 wt % and less than or equal to 0.5 wt % GeO₂, greater than or equal to 0.1 wt % and less than or equal to 5.0 wt % GeO₂, greater than or equal to 0.1 wt % and less than or equal to 4.5 wt % GeO₂, greater than or equal to 0.1 wt % and less than or equal to 4.0 wt % GeO₂, greater than or equal to 0.1 wt % and less than or equal to 3.5 wt % GeO₂, greater than or equal to 0.1 wt % and less than or equal to 3.0 wt % GeO₂, greater than or equal to 0.1 wt % and less than or equal to 2.5 wt % GeO₂, greater than or equal to 0.1 wt % and less than or equal to 2.0 wt % GeO₂, greater than or equal to 0.1 wt % and less than or equal to 1.5 wt % GeO₂, greater than or equal to 0.1 wt % and less than or equal to 1.0 wt % GeO₂, or even greater than or equal to 0.1 wt % and less than or equal to 0.5 wt % GeO₂. In embodiments, the precursor glasses and glass-ceramics do not include GeO₂. In embodiments, the precursor glasses and glass-ceramics are substantially free of GeO₂. It should be understood that the above ranges include all subranges within the explicitly disclosed ranges.

In embodiments, the precursor glasses or glass-ceramics may further include TiO₂. In embodiments, the precursor glasses and glass-ceramics comprise greater than or equal to 0 wt % and less than or equal to 2.0 wt % TiO₂, greater than or equal to 0 wt % and less than or equal to 1.5 wt % TiO₂, greater than or equal to 0 wt % and less than or equal to 1.0 wt % TiO₂, greater than or equal to 0 wt % and less than or equal to 0.5 wt % TiO₂, greater than or equal to 0.1 wt % and less than or equal to 2.0 wt % TiO₂, greater than or equal to 0.1 wt % and less than or equal to 1.5 wt % TiO₂, greater than or equal to 0.1 wt % and less than or equal to 1.0 wt % TiO₂, or even greater than or equal to 0.1 wt % and less than or equal to 0.5 wt % TiO₂. In embodiments, the precursor glasses and glass-ceramics do not include TiO₂. In embodiments, the precursor glasses and glass-ceramics are substantially free of TiO₂. It should be understood that the above ranges include all subranges within the explicitly disclosed ranges.

In embodiments, the precusor glass or glass-ceramic may further include a chemical fining agent. Such fining agents include, but are not limited to, SnO₂, As₂O₃, Sb₂O₃, SO₃F, Cl and Br. In some embodiments, the concentrations of the chemical fining agents are kept at a level of 3, 2, 1, or 0.5, >0 wt %. In embodiments, the chemical fining agent is SnO₂ and the precusor glass or glass-ceramic comprises greater than or equal to 0 to less than or equal to 3 wt % SnO₂. In embodiments, the precusor glass or glass-ceramic comprises greater than or equal to 0 wt % and less than or equal to 2.5 wt % SnO₂, greater than or equal to 0 wt % and less than or equal to 2.0 wt % SnO₂, greater than or equal to 0 wt % and less than or equal to 1.5 wt % SnO₂, greater than or equal to 0 wt % and less than or equal to 1.0 wt % SnO₂, greater than or equal to 0 wt % and less than or equal to 0.5 wt % SnO₂, greater than 0.01 wt % to less than or equal to 3 wt % SnO₂, greater than 0.01 wt % and less than or equal to 2.5 wt % SnO₂, greater than 0.01 wt % and less than or equal to 2.0 wt % SnO₂, greater than 0.01 wt % and less than or equal to 1.5 wt % SnO₂, greater than 0.01 wt % and less than or equal to 1.0 wt % SnO₂, or even greater than 0.01 wt % and less than or equal to 0.5 wt % SnO₂. It should be understood that the above ranges include all subranges within the explicitly disclosed ranges. In embodiments, the chemical fining agent may also include CeO₂, Fe₂O₃, and other oxides of transition metals, such as MnO₂. These oxides may introduce unwanted color to the precusor glass or glass-ceramic via visible absorptions in their final valence state(s) in the glass, and thus, when present, their concentration is usually kept at a level of 0.5, 0.4, 0.3, 0.2, 0.1 or >0 wt %. In embodiments, the precusor glass or glass-ceramic does not include a chemical fining agent.

In some embodiments, the precusor glass or glass-ceramic can be substantially free of Sb₂O₃, As₂O₃, or combinations thereof. For example, the precusor glass or glass-ceramic can comprise 0.05 weight percent or less of Sb₂O₃ or As₂O₃ or a combination thereof, the precusor glass or glass-ceramic may comprise 0 wt % of Sb₂O₃ or As₂O₃ or a combination thereof, or the precusor glass or glass-ceramic may be, for example, free of any intentionally added Sb₂O₃, As₂O₃, or combinations thereof.

In embodiments, glass having the composition described herein may be initially formed by mixing a batch of constituent component sources (i.e., SiO₂ sources, Al₂O₃ sources, and the like), heating the batch to form molten glass, and, thereafter, forming or shaping the molten glass into a glass article using conventional forming processes, such as slot draw, float, rolling, fusion forming, or the like. At this point, the glass or glass article may be referred to as a “precursor glass” which refers to the glass or glass article prior to ceramming to convert the glass to a glass-ceramic, thereby forming a glass-ceramic article.

The processes for making glass-ceramics according to embodiments includes heat treating the precursor glass at two preselected temperatures for one or more preselected times to induce glass homogenization and crystallization (i.e., nucleation and growth) of one or more crystalline phases (e.g., having one or more compositions, amounts, morphologies, sizes or size distributions, etc.). These two temperatures may be referred to as the nucleation temperature and the growth temperature, respectively.

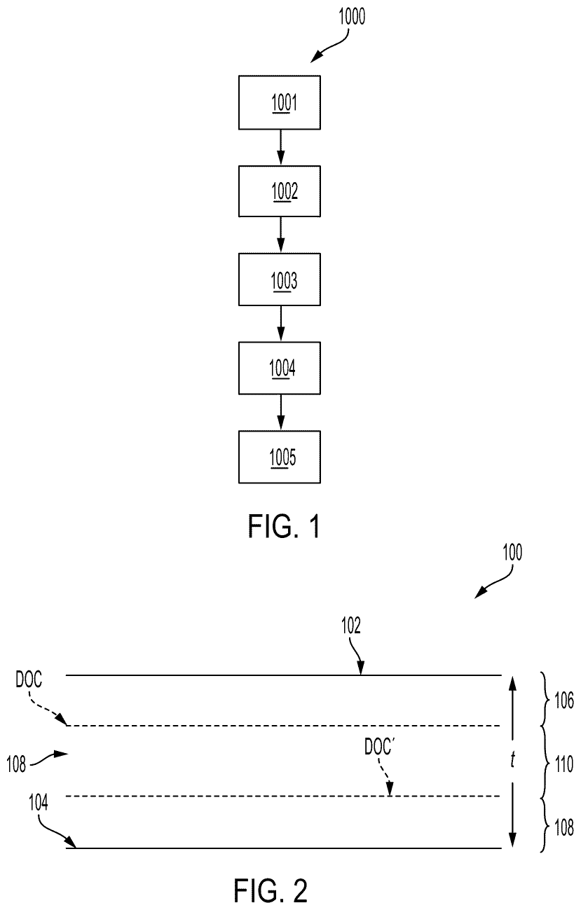

With reference now to FIG. 1, embodiments of methods 1000 for making glass-ceramics will generally be described. Initially, at step 1001, a precursor glass is heated in an oven to a nucleation temperature that is greater than or equal to 550° C. and less than or equal to 650° C. It should be understood that the nucleation temperature corresponds to the temperature of the oven in which the precursor glass is heated and that the temperature of the precursor glass may be within +/−5° C. of the nucleation temperature when the temperature of the oven is at the nucleation temperature. At step 1002, the precursor glass is held in the oven for a first duration in a temperature range that is greater than or equal to the nucleation temperature and less than or equal to 650° C. to form a nucleated precursor glass. At step 1003, the nucleated precursor glass is heated to a growth temperature that is greater than or equal to 680° C. and less than or equal to 800° C. At step 1004, the nucleated precursor glass is held for a second duration in a temperature range that is greater than or equal to the growth temperature and less than or equal to 800° C. to form the glass-ceramic. In embodiments, at step 1005, the glass-ceramic may be exposed to an ion exchange medium comprising a molten potassium salt, a molten sodium salt, or combinations thereof, with or without additions of LiNO₃ to the ion exchange bath, to form a strengthened glass-ceramic. Each of these steps will be described in more detail below.

In embodiments, the nucleation stage takes place when a precursor glass is held at the predetermined nucleation temperature for a predetermined duration. In embodiments, the nucleation temperature is greater than or equal to 550° C. and less than or equal to 650° C., greater than or equal to 560° C. and less than or equal to 650° C., greater than or equal to 570° C. and less than or equal to 650° C., greater than or equal to 580° C. and less than or equal to 650° C., greater than or equal to 590° C. and less than or equal to 650° C., greater than or equal to 600° C. and less than or equal to 650° C., greater than or equal to 610° C. and less than or equal to 650° C., greater than or equal to 620° C. and less than or equal to 650° C., greater than or equal to 630° C. and less than or equal to 650° C., greater than or equal to 640° C. and less than or equal to 650° C., greater than or equal to 550° C. and less than or equal to 640° C., greater than or equal to 560° C. and less than or equal to 640° C., greater than or equal to 570° C. and less than or equal to 640° C., greater than or equal to 580° C. and less than or equal to 640° C., greater than or equal to 590° C. and less than or equal to 640° C., greater than or equal to 600° C. and less than or equal to 640° C., greater than or equal to 610° C. and less than or equal to 640° C., greater than or equal to 620° C. and less than or equal to 640° C., greater than or equal to 630° C. and less than or equal to 640° C., greater than or equal to 550° C. and less than or equal to 630° C., greater than or equal to 560° C. and less than or equal to 630° C., greater than or equal to 570° C. and less than or equal to 630° C., greater than or equal to 580° C. and less than or equal to 630° C., greater than or equal to 590° C. and less than or equal to 630° C., greater than or equal to 600° C. and less than or equal to 630° C., greater than or equal to 610° C. and less than or equal to 630° C., greater than or equal to 620° C. and less than or equal to 630° C., greater than or equal to 550° C. and less than or equal to 620° C., greater than or equal to 560° C. and less than or equal to 620° C., greater than or equal to 570° C. and less than or equal to 620° C., greater than or equal to 580° C. and less than or equal to 620° C., greater than or equal to 590° C. and less than or equal to 620° C., greater than or equal to 600° C. and less than or equal to 620° C., greater than or equal to 610° C. and less than or equal to 620° C., greater than or equal to 550° C. and less than or equal to 610° C., greater than or equal to 560° C. and less than or equal to 610° C., greater than or equal to 570° C. and less than or equal to 610° C., greater than or equal to 580° C. and less than or equal to 610° C., greater than or equal to 590° C. and less than or equal to 610° C., greater than or equal to 600° C. and less than or equal to 610° C., greater than or equal to 550° C. and less than or equal to 600° C., greater than or equal to 560° C. and less than or equal to 600° C., greater than or equal to 570° C. and less than or equal to 600° C., greater than or equal to 580° C. and less than or equal to 600° C., greater than or equal to 590° C. and less than or equal to 600° C., greater than or equal to 550° C. and less than or equal to 590° C., greater than or equal to 560° C. and less than or equal to 590° C., greater than or equal to 570° C. and less than or equal to 590° C., greater than or equal to 580° C. and less than or equal to 590° C., greater than or equal to 550° C. and less than or equal to 580° C., greater than or equal to 560° C. and less than or equal to 580° C., greater than or equal to 570° C. and less than or equal to 580° C., greater than or equal to 550° C. and less than or equal to 570° C., greater than or equal to 560° C. and less than or equal to 570° C., or greater than or equal to 550° C. and less than or equal to 560° C. It should be understood that the above ranges include all subranges within the explicitly disclosed ranges.

In embodiments, the precursor glass is held at the nucleation temperature for a duration that is greater than or equal to 1 minute to less than or equal to 360 minutes, greater than or equal to 30 minutes to less than or equal to 360 minutes, greater than or equal to 60 minutes to less than or equal to 360 minutes, greater than or equal to 90 minutes to less than or equal to 360 minutes, greater than or equal to 120 minutes to less than or equal to 360 minutes, greater than or equal to 150 minutes to less than or equal to 360 minutes, greater than or equal to 180 minutes to less than or equal to 360 minutes, greater than or equal to 210 minutes to less than or equal to 360 minutes, greater than or equal to 240 minutes to less than or equal to 360 minutes, greater than or equal to 270 minutes to less than or equal to 360 minutes, greater than or equal to 300 minutes to less than or equal to 360 minutes, greater than or equal to 330 minutes to less than or equal to 360 minutes, greater than or equal to 1 minute to less than or equal to 330 minutes, greater than or equal to 30 minutes to less than or equal to 330 minutes, greater than or equal to 60 minutes to less than or equal to 330 minutes, greater than or equal to 90 minutes to less than or equal to 330 minutes, greater than or equal to 120 minutes to less than or equal to 330 minutes, greater than or equal to 150 minutes to less than or equal to 330 minutes, greater than or equal to 180 minutes to less than or equal to 330 minutes, greater than or equal to 210 minutes to less than or equal to 330 minutes, greater than or equal to 240 minutes to less than or equal to 330 minutes, greater than or equal to 270 minutes to less than or equal to 330 minutes, greater than or equal to 300 minutes to less than or equal to 330 minutes, greater than or equal to 1 minute to less than or equal to 300 minutes, greater than or equal to 30 minutes to less than or equal to 300 minutes, greater than or equal to 60 minutes to less than or equal to 300 minutes, greater than or equal to 90 minutes to less than or equal to 300 minutes, greater than or equal to 120 minutes to less than or equal to 300 minutes, greater than or equal to 150 minutes to less than or equal to 300 minutes, greater than or equal to 180 minutes to less than or equal to 300 minutes, greater than or equal to 210 minutes to less than or equal to 300 minutes, greater than or equal to 240 minutes to less than or equal to 300 minutes, greater than or equal to 270 minutes to less than or equal to 300 minutes, greater than or equal to 1 minute to less than or equal to 270 minutes, greater than or equal to 30 minutes to less than or equal to 270 minutes, greater than or equal to 60 minutes to less than or equal to 270 minutes, greater than or equal to 90 minutes to less than or equal to 270 minutes, greater than or equal to 120 minutes to less than or equal to 270 minutes, greater than or equal to 150 minutes to less than or equal to 270 minutes, greater than or equal to 180 minutes to less than or equal to 270 minutes, greater than or equal to 210 minutes to less than or equal to 270 minutes, greater than or equal to 240 minutes to less than or equal to 270 minutes, greater than or equal to 1 minute to less than or equal to 240 minutes, greater than or equal to 30 minutes to less than or equal to 240 minutes, greater than or equal to 60 minutes to less than or equal to 240 minutes, greater than or equal to 90 minutes to less than or equal to 240 minutes, greater than or equal to 120 minutes to less than or equal to 240 minutes, greater than or equal to 150 minutes to less than or equal to 240 minutes, greater than or equal to 180 minutes to less than or equal to 240 minutes, greater than or equal to 210 minutes to less than or equal to 240 minutes, greater than or equal to 1 minute to less than or equal to 210 minutes, greater than or equal to 30 minutes to less than or equal to 210 minutes, greater than or equal to 60 minutes to less than or equal to 210 minutes, greater than or equal to 90 minutes to less than or equal to 210 minutes, greater than or equal to 120 minutes to less than or equal to 210 minutes, greater than or equal to 150 minutes to less than or equal to 210 minutes, greater than or equal to 180 minutes to less than or equal to 210 minutes, greater than or equal to 1 minute to less than or equal to 180 minutes, greater than or equal to 30 minutes to less than or equal to 180 minutes, greater than or equal to 60 minutes to less than or equal to 180 minutes, greater than or equal to 90 minutes to less than or equal to 180 minutes, greater than or equal to 120 minutes to less than or equal to 180 minutes, greater than or equal to 150 minutes to less than or equal to 180 minutes, greater than or equal to 1 minute to less than or equal to 150 minutes, greater than or equal to 30 minutes to less than or equal to 150 minutes, greater than or equal to 60 minutes to less than or equal to 150 minutes, greater than or equal to 90 minutes to less than or equal to 150 minutes, greater than or equal to 120 minutes to less than or equal to 150 minutes, greater than or equal to 1 minute to less than or equal to 120 minutes, greater than or equal to 30 minutes to less than or equal to 120 minutes, greater than or equal to 60 minutes to less than or equal to 120 minutes, greater than or equal to 90 minutes to less than or equal to 120 minutes, greater than or equal to 1 minute to less than or equal to 90 minutes, greater than or equal to 30 minutes to less than or equal to 90 minutes, greater than or equal to 60 minutes to less than or equal to 90 minutes, greater than or equal to 1 minute to less than or equal to 60 minutes, greater than or equal to 30 minutes to less than or equal to 60 minutes, or greater than or equal to 1 minute to less than or equal to 30 minutes. It should be understood that the above ranges include all subranges within the explicitly disclosed ranges. After the nucleation stage, the precursor glass is referred to as a nucleated precursor glass.

The growth stage takes place when a nucleated precursor glass is held at the predetermined growth temperature for a predetermined duration. The growth temperature is, in embodiments, greater than the nucleation temperature. In embodiments, the growth temperature is greater than or equal to 680° C. and less than or equal to 800° C., greater than or equal to 690° C. and less than or equal to 800° C., greater than or equal to 700° C. and less than or equal to 800° C., greater than or equal to 710° C. and less than or equal to 800° C., greater than or equal to 720° C. and less than or equal to 800° C., greater than or equal to 730° C. and less than or equal to 800° C., greater than or equal to 740° C. and less than or equal to 800° C., greater than or equal to 750° C. and less than or equal to 800° C., greater than or equal to 760° C. and less than or equal to 800° C., greater than or equal to 770° C. and less than or equal to 800° C., greater than or equal to 780° C. and less than or equal to 800° C., greater than or equal to 790° C. and less than or equal to 800° C., greater than or equal to 680° C. and less than or equal to 790° C., greater than or equal to 690° C. and less than or equal to 790° C., greater than or equal to 700° C. and less than or equal to 790° C., greater than or equal to 710° C. and less than or equal to 790° C., greater than or equal to 720° C. and less than or equal to 790° C., greater than or equal to 730° C. and less than or equal to 790° C., greater than or equal to 740° C. and less than or equal to 790° C., greater than or equal to 750° C. and less than or equal to 790° C., greater than or equal to 760° C. and less than or equal to 790° C., greater than or equal to 770° C. and less than or equal to 790° C., greater than or equal to 780° C. and less than or equal to 790° C., greater than or equal to 680° C. and less than or equal to 780° C., greater than or equal to 690° C. and less than or equal to 780° C., greater than or equal to 700° C. and less than or equal to 780° C., greater than or equal to 710° C. and less than or equal to 780° C., greater than or equal to 720° C. and less than or equal to 780° C., greater than or equal to 730° C. and less than or equal to 780° C., greater than or equal to 740° C. and less than or equal to 780° C., greater than or equal to 750° C. and less than or equal to 780° C., greater than or equal to 760° C. and less than or equal to 780° C., greater than or equal to 770° C. and less than or equal to 780° C., greater than or equal to 680° C. and less than or equal to 770° C., greater than or equal to 690° C. and less than or equal to 770° C., greater than or equal to 700° C. and less than or equal to 770° C., greater than or equal to 710° C. and less than or equal to 770° C., greater than or equal to 720° C. and less than or equal to 770° C., greater than or equal to 730° C. and less than or equal to 770° C., greater than or equal to 740° C. and less than or equal to 770° C., greater than or equal to 750° C. and less than or equal to 770° C., greater than or equal to 760° C. and less than or equal to 770° C., greater than or equal to 680° C. and less than or equal to 760° C., greater than or equal to 690° C. and less than or equal to 760° C., greater than or equal to 700° C. and less than or equal to 760° C., greater than or equal to 710° C. and less than or equal to 760° C., greater than or equal to 720° C. and less than or equal to 760° C., greater than or equal to 730° C. and less than or equal to 760° C., greater than or equal to 740° C. and less than or equal to 760° C., greater than or equal to 750° C. and less than or equal to 760° C., greater than or equal to 680° C. and less than or equal to 750° C., greater than or equal to 690° C. and less than or equal to 750° C., greater than or equal to 700° C. and less than or equal to 750° C., greater than or equal to 710° C. and less than or equal to 750° C., greater than or equal to 720° C. and less than or equal to 750° C., greater than or equal to 730° C. and less than or equal to 750° C., greater than or equal to 740° C. and less than or equal to 750° C., greater than or equal to 680° C. and less than or equal to 740° C., greater than or equal to 690° C. and less than or equal to 740° C., greater than or equal to 700° C. and less than or equal to 740° C., greater than or equal to 710° C. and less than or equal to 740° C., greater than or equal to 720° C. and less than or equal to 740° C., greater than or equal to 730° C. and less than or equal to 740° C., greater than or equal to 680° C. and less than or equal to 730° C., greater than or equal to 690° C. and less than or equal to 730° C., greater than or equal to 700° C. and less than or equal to 730° C., greater than or equal to 710° C. and less than or equal to 730° C., greater than or equal to 720° C. and less than or equal to 730° C., greater than or equal to 680° C. and less than or equal to 720° C., greater than or equal to 690° C. and less than or equal to 720° C., greater than or equal to 700° C. and less than or equal to 720° C., greater than or equal to 710° C. and less than or equal to 720° C., greater than or equal to 680° C. and less than or equal to 710° C., greater than or equal to 690° C. and less than or equal to 710° C., greater than or equal to 700° C. and less than or equal to 710° C., greater than or equal to 680° C. and less than or equal to 700° C., greater than or equal to 690° C. and less than or equal to 700° C., or greater than or equal to 680° C. and less than or equal to 690° C. It should be understood that the above ranges include all subranges within the explicitly disclosed ranges.

In embodiments, the nucleated precursor glass is held at the growth temperature for a duration that is greater than or equal to 1 minute to less than or equal to 240 minutes, greater than or equal to 30 minutes to less than or equal to 240 minutes, greater than or equal to 60 minutes to less than or equal to 240 minutes, greater than or equal to 90 minutes to less than or equal to 240 minutes, greater than or equal to 120 minutes to less than or equal to 240 minutes, greater than or equal to 150 minutes to less than or equal to 240 minutes, greater than or equal to 180 minutes to less than or equal to 240 minutes, greater than or equal to 210 minutes to less than or equal to 240 minutes, greater than or equal to 1 minute to less than or equal to 210 minutes, greater than or equal to 30 minutes to less than or equal to 210 minutes, greater than or equal to 60 minutes to less than or equal to 210 minutes, greater than or equal to 90 minutes to less than or equal to 210 minutes, greater than or equal to 120 minutes to less than or equal to 210 minutes, greater than or equal to 150 minutes to less than or equal to 210 minutes, greater than or equal to 180 minutes to less than or equal to 210 minutes, greater than or equal to 1 minute to less than or equal to 180 minutes, greater than or equal to 30 minutes to less than or equal to 180 minutes, greater than or equal to 60 minutes to less than or equal to 180 minutes, greater than or equal to 90 minutes to less than or equal to 180 minutes, greater than or equal to 120 minutes to less than or equal to 180 minutes, greater than or equal to 150 minutes to less than or equal to 180 minutes, greater than or equal to 1 minute to less than or equal to 150 minutes, greater than or equal to 30 minutes to less than or equal to 150 minutes, greater than or equal to 60 minutes to less than or equal to 150 minutes, greater than or equal to 90 minutes to less than or equal to 150 minutes, greater than or equal to 120 minutes to less than or equal to 150 minutes, greater than or equal to 1 minute to less than or equal to 120 minutes, greater than or equal to 30 minutes to less than or equal to 120 minutes, greater than or equal to 60 minutes to less than or equal to 120 minutes, greater than or equal to 90 minutes to less than or equal to 120 minutes, greater than or equal to 1 minute to less than or equal to 90 minutes, greater than or equal to 30 minutes to less than or equal to 90 minutes, greater than or equal to 60 minutes to less than or equal to 90 minutes, greater than or equal to 1 minute to less than or equal to 60 minutes, greater than or equal to 30 minutes to less than or equal to 60 minutes, or greater than or equal to 1 minute to less than or equal to 30 minutes. It should be understood that the above ranges include all subranges within the explicitly disclosed ranges. The growth stage transitions the nucleated precursor glass into a glass-ceramic material (i.e., a glass-ceramic or glass-ceramic article).

A precursor glass article as disclosed and described herein held at the nucleation temperature and growth temperature for the durations disclosed and described herein will form a glass-ceramic having a phase assemblage comprising a residual amorphous glass phase, a petalite (LiAlSi₄O₁₀) crystalline phase, and a lithium disilicate (Li₂Si₂O₅) crystalline phase. As noted herein, this phase assemblage provides a glass-ceramic that has low haze (high clarity) and improved mechanical properties.

It is believed that the nucleation and growth temperatures and durations disclosed and described herein are the heat treatments that primarily result in the desired phase assemblage in the glass-ceramics. Additional heat treatments may be included before the nucleation stage, between the nucleation stage and the growth stage, and after the growth stage without causing significant deviation in the phase assemblage of the glass-ceramic material. These additional heat treatments include isothermal holds, heating at specific heating schedules including a number of differing heating rates, and combinations thereof.

Accordingly, in embodiments, there may be one of more additional temperature holds between the nucleation temperature and the growth temperature. In embodiments, after maintaining the precursor glass at the nucleation temperature, the article may be heated to one or more intermediate temperatures (wherein the intermediate temperatures are in a range between the nucleation temperature and the growth temperature) and held at the one or more intermediate temperatures for a predetermined time (for example, between 1 minute and 360 minutes and all ranges and subranges there between) and then heated to the growth temperature.

In embodiments, the nucleation stage comprises an isothermal hold at a single nucleation temperature for a duration. However, in other embodiments, the nucleation stage includes heating the precursor glass at one or more heating rates through the nucleation temperature range described herein (i.e., from greater than or equal to 550° C. to less than or equal to 650° C.). Likewise, in embodiments, the growth stage comprises an isothermal hold at a single growth temperature for a duration. However, in other embodiments, the growth stage includes heating or cooling the nucleated precursor glass at one or more heating rates within the growth temperature range described herein (i.e., from greater than or equal to 680° C. to less than or equal to 800° C.).

According to embodiments, heating rates used to heat from room temperature to the nucleation temperature, within the nucleation stage, between the nucleation stage and the growth stage, within the growth stage, and after the growth stage is greater than or equal to 0.1° C./min and less than or equal to 50° C./min, greater than or equal to 5° C./min and less than or equal to 50° C./min, greater than or equal to 10° C./min and less than or equal to 50° C./min, greater than or equal to 15° C./min and less than or equal to 50° C./min, greater than or equal to 20° C./min and less than or equal to 50° C./min, greater than or equal to 25° C./min and less than or equal to 50° C./min, greater than or equal to 30° C./min and less than or equal to 50° C./min, greater than or equal to 35° C./min and less than or equal to 50° C./min, greater than or equal to 40° C./min and less than or equal to 50° C./min, greater than or equal to 45° C./min and less than or equal to 50° C./min, greater than or equal to 0.1° C./min and less than or equal to 45° C./min, greater than or equal to 5° C./min and less than or equal to 45° C./min, greater than or equal to 10° C./min and less than or equal to 45° C./min, greater than or equal to 15° C./min and less than or equal to 45° C./min, greater than or equal to 20° C./min and less than or equal to 45° C./min, greater than or equal to 25° C./min and less than or equal to 45° C./min, greater than or equal to 30° C./min and less than or equal to 45° C./min, greater than or equal to 35° C./min and less than or equal to 45° C./min, greater than or equal to 40° C./min and less than or equal to 45° C./min, greater than or equal to 0.1° C./min and less than or equal to 40° C./min, greater than or equal to 5° C./min and less than or equal to 40° C./min, greater than or equal to 10° C./min and less than or equal to 40° C./min, greater than or equal to 15° C./min and less than or equal to 40° C./min, greater than or equal to 20° C./min and less than or equal to 40° C./min, greater than or equal to 25° C./min and less than or equal to 40° C./min, greater than or equal to 30° C./min and less than or equal to 40° C./min, greater than or equal to 35° C./min and less than or equal to 40° C./min, greater than or equal to 0.1° C./min and less than or equal to 35° C./min, greater than or equal to 5° C./min and less than or equal to 35° C./min, greater than or equal to 10° C./min and less than or equal to 35° C./min, greater than or equal to 15° C./min and less than or equal to 35° C./min, greater than or equal to 20° C./min and less than or equal to 35° C./min, greater than or equal to 25° C./min and less than or equal to 35° C./min, greater than or equal to 30° C./min and less than or equal to 35° C./min, greater than or equal to 0.1° C./min and less than or equal to 30° C./min, greater than or equal to 5° C./min and less than or equal to 30° C./min, greater than or equal to 10° C./min and less than or equal to 30° C./min, greater than or equal to 15° C./min and less than or equal to 30° C./min, greater than or equal to 20° C./min and less than or equal to 30° C./min, greater than or equal to 25° C./min and less than or equal to 30° C./min, greater than or equal to 0.1° C./min and less than or equal to 25° C./min, greater than or equal to 5° C./min and less than or equal to 25° C./min, greater than or equal to 10° C./min and less than or equal to 25° C./min, greater than or equal to 15° C./min and less than or equal to 25° C./min, greater than or equal to 20° C./min and less than or equal to 25° C./min, greater than or equal to 0.1° C./min and less than or equal to 20° C./min, greater than or equal to 5° C./min and less than or equal to 20° C./min, greater than or equal to 10° C./min and less than or equal to 20° C./min, greater than or equal to 15° C./min and less than or equal to 20° C./min, greater than or equal to 0.1° C./min and less than or equal to 15° C./min, greater than or equal to 5° C./min and less than or equal to 15° C./min, greater than or equal to 10° C./min and less than or equal to 15° C./min, greater than or equal to 0.1° C./min and less than or equal to 10° C./min, greater than or equal to 5° C./min and less than or equal to 10° C./min, or greater than or equal to 0.1° C./min and less than or equal to 5° C./min. It should be understood that the above ranges include all subranges within the explicitly disclosed ranges. Such heating rates allow the proper amount of nucleation and crystal growth without damaging the glass-ceramic article. If heating is done to quickly, the material may be damaged. However, if heating is done too slowly, proper nucleation and growth may not occur.

In embodiments, the glass-ceramic is cooled after being held at the growth temperature. In embodiments, the glass-ceramic may be cooled to room temperature in a single stage at a constant cooling rate, in two stages each with a different cooling rate, or in three or more stages each with a different cooling rate. In embodiments, the glass-ceramics are cooled at a controlled rate from the growth temperature to minimize temperature gradients across the articles as well as minimize residual stress across the articles. Temperature gradients and differences in residual stress may lead to the articles warping during cooling. Thus, controlling the cooling to control the temperature gradients and residual stresses may also minimize warpage of the glass-ceramics.

Upon performing the above heat treatments to the precursor glass, the resultant glass-ceramic has a phase assemblage where lithium disilicate and petalite are the crystalline phases with the highest weight percentages. In embodiments, a weight ratio of lithium disilicate to petalite in the glass-ceramic is greater than or equal to 0.8 and less than or equal to 2.5, greater than or equal to 0.85 and less than or equal to 2.5, greater than or equal to 0.9 and less than or equal to 2.5, greater than or equal to 0.8 and less than or equal to 2.4, greater than or equal to 0.85 and less than or equal to 2.4, greater than or equal to 0.9 and less than or equal to 2.4, greater than or equal to 0.7 and less than or equal to 2.3, greater than or equal to 0.8 and less than or equal to 2.3, greater than or equal to 0.9 and less than or equal to 2.3, greater than or equal to 0.7 and less than or equal to 2.2, greater than or equal to 0.8 and less than or equal to 2.2, greater than or equal to 0.9 and less than or equal to 2.2, greater than or equal to 0.7 and less than or equal to 2.1, greater than or equal to 0.8 and less than or equal to 2.1, greater than or equal to 0.9 and less than or equal to 2.1, greater than or equal to 0.7 and less than or equal to 2.0, greater than or equal to 0.8 and less than or equal to 2.0, greater than or equal to 0.9 and less than or equal to 2.0, greater than or equal to 0.7 and less than or equal to 1.9, greater than or equal to 0.8 and less than or equal to 1.9, greater than or equal to 0.9 and less than or equal to 1.9, greater than or equal to 0.7 and less than or equal to 1.8, greater than or equal to 0.8 and less than or equal to 1.8, greater than or equal to 0.9 and less than or equal to 1.8, greater than or equal to 0.7 and less than or equal to 1.7, greater than or equal to 0.8 and less than or equal to 1.7, greater than or equal to 0.9 and less than or equal to 1.7, greater than or equal to 0.7 and less than or equal to 1.6, greater than or equal to 0.8 and less than or equal to 1.6, greater than or equal to 0.9 and less than or equal to 1.6, greater than or equal to 0.7 and less than or equal to 1.5, greater than or equal to 0.8 and less than or equal to 1.5, greater than or equal to 0.9 and less than or equal to 1.5, greater than or equal to 0.7 and less than or equal to 1.4, greater than or equal to 0.8 and less than or equal to 1.4, greater than or equal to 0.9 and less than or equal to 1.4, greater than or equal to 0.7 and less than or equal to 1.3, greater than or equal to 0.8 and less than or equal to 1.3, greater than or equal to 0.9 and less than or equal to 1.3, greater than or equal to 0.7 and less than or equal to 1.2, greater than or equal to 0.8 and less than or equal to 1.2, or even greater than or equal to 0.9 and less than or equal to 1.2. It should be understood that the above ranges include all subranges within the explicitly disclosed ranges.

The phase assemblage of the glass-ceramics described herein (i.e., the respective percentages of the crystalline phases and the residual glass phase) limits the mismatch in indices between the crystals and the residual amorphous glass phase, which reduces light scatter and the resulting haze of the glass-ceramic while increasing the transmittance of the glass-ceramic.

The grain size of the crystals in the crystalline phases is a factor that affects the transparency of the glass-ceramics. In embodiments, the grains have a longest dimension in a range from about 5 nm to about 150 nm, about 5 nm to about 125 nm, about 5 nm to about 100 nm, about 5 nm to about 75 nm, about 5 nm to about 50 nm, about 25 nm to about 150 nm, about 25 nm to about 125 nm, about 25 nm to about 100 nm, about 25 nm to about 75 nm, about 50 nm to about 150 nm, about 50 nm to about 125 nm, about 50 nm to about 100 nm, and all ranges and subranges there between. In embodiments, the longest dimension of the grains is less than 150 nm, less than 125 nm, less than 100 nm, less than 75 nm, less than 50 nm, or less than 25 nm. The longest dimension of the grains is measured using a scanning electron microscope (SEM) and image analysis.

In embodiments, the glass-ceramics have high transparency and low haze and are suitable for use as a cover glass for electronic devices, such as mobile electronic device. In embodiments, the glass-ceramics are transparent in that it has an average transmittance of 85% or greater, 86% or greater, 87% or greater, 88% or greater, 89% or greater, 90% or greater, 91% or greater, 92% or greater, 93% or greater, 94% or greater of light over the wavelength range from 450 nm to 800 nm as measured for a glass-ceramic article having a thickness of 1 mm.

In other embodiments, glass-ceramics may be translucent over the wavelength range from 450 nm to 1000 nm. In embodiments a translucent glass-ceramic can have an average transmittance in a range from about 20% to less than about 85% of light over the wavelength range of about 450 nm to about 800 nm as measured for a glass-ceramic article having a thickness of 1 mm.

In embodiments, the glass-ceramic article has a haze of less or equal to 0.40, 0.35, 0.30, 0.25, 0.20, 0.15, 0.14, 0.13, 0.12, 0.11, 0.10, 0.09, 0.08, 0.07, 0.06, or 0.05 as measured on a glass-ceramic article having a thickness of 0.6 mm.

In embodiments, glass-ceramics and glass-ceramic articles may be strengthened to install a compressive stress layer on one or more surface thereof. Referring now to FIG. 2 by way of example, an exemplary cross-sectional side view of a strengthened glass-ceramic article 100 is depicted having a first surface 102 and an opposing second surface 104 separated by a thickness (t). In embodiments, the strengthened glass-ceramic article 100 has been ion exchanged and has a compressive stress (CS) layer 106 (or first region) extending from the first surface 102 to a depth of compression (DOC). In embodiments, as shown in FIG. 2, the glass-ceramic article 100 also has a compressive stress (CS) layer 108 extending from the second surface 104 to a depth of compression DOC′. A central tension region 110 having a central tension (CT) is positioned between DOC and DOC′.

In embodiments, the glass-ceramics and glass-ceramic articles are capable of being chemically tempered (also referred to as chemically strengthened) using one or more ion exchange techniques. In these embodiments, ion exchange can occur by subjecting one or more surfaces of such glass-ceramic or glass-ceramic article to one or more ion exchange mediums (for example molten salt baths), having a specific composition and temperature, for a specified time period to impart to the one or more surfaces with compressive stress layer(s). In embodiments, the ion exchange medium is a molten salt bath containing an ion (for example an alkali metal ion) that is larger than an ion (for example an alkali metal ion) present in the glass-ceramic or glass-ceramic article wherein the larger ion from the molten bath is exchanged with the smaller ion in the glass-ceramic article to impart a compressive stress in the glass-ceramic or glass-ceramic article, and thereby increases the strength of the glass-ceramic or glass-ceramic article.

In embodiments, a one-step ion exchange process can be used. In other embodiments, a multi-step ion exchange process (such as a two-step ion exchange process) can be used. In embodiments, for both one-step and multi-step ion exchange processes, the ion exchange mediums (for example, molten baths) can include potassium nitrate (KNO₃) and sodium nitrate (NaNO₃) as primary components. The ion exchange mediums can, in embodiments, further comprise lithium nitrate (LiNO₃), sodium nitrite (NaNO₂), and silicic acid.

In embodiments, the ion exchange medium comprises greater than or equal to 50 wt % and less than or equal to 70 wt % KNO₃, greater than or equal to 55 wt % and less than or equal to 70 wt % KNO₃, greater than or equal to 60 wt % and less than or equal to 70 wt % KNO₃, greater than or equal to 65 wt % and less than or equal to 70 wt % KNO₃, greater than or equal to 50 wt % and less than or equal to 65 wt % KNO₃, greater than or equal to 55 wt % and less than or equal to 65 wt % KNO₃, greater than or equal to 60 wt % and less than or equal to 65 wt % KNO₃, greater than or equal to 50 wt % and less than or equal to 60 wt % KNO₃, greater than or equal to 55 wt % and less than or equal to 60 wt % KNO₃, or greater than or equal to 50 wt % and less than or equal to 55 wt % KNO₃. It should be understood that the above ranges include all subranges within the explicitly disclosed ranges.

In embodiments, the ion exchange medium comprises greater than or equal to 30 wt % and less than or equal to 80 wt % NaNO₃, greater than or equal to 30 wt % and less than or equal to 75 wt % NaNO₃, greater than or equal to 30 wt % and less than or equal to 70 wt % NaNO₃, greater than or equal to 30 wt % and less than or equal to 65 wt % NaNO₃, greater than or equal to 30 wt % and less than or equal to 60 wt % NaNO₃, greater than or equal to 30 wt % and less than or equal to 55 wt % NaNO₃, greater than or equal to 30 wt % and less than or equal to 50 wt % NaNO₃, greater than or equal to 35 wt % and less than or equal to 80 wt % NaNO₃, greater than or equal to 35 wt % and less than or equal to 75 wt % NaNO₃, greater than or equal to 35 wt % and less than or equal to 70 wt % NaNO₃, greater than or equal to 35 wt % and less than or equal to 65 wt % NaNO₃, greater than or equal to 35 wt % and less than or equal to 60 wt % NaNO₃, greater than or equal to 35 wt % and less than or equal to 55 wt % NaNO₃, greater than or equal to 35 wt % and less than or equal to 50 wt % NaNO₃, greater than or equal to 40 wt % and less than or equal to 80 wt % NaNO₃, greater than or equal to 40 wt % and less than or equal to 75 wt % NaNO₃, greater than or equal to 40 wt % and less than or equal to 70 wt % NaNO₃, greater than or equal to 40 wt % and less than or equal to 65 wt % NaNO₃, greater than or equal to 40 wt % and less than or equal to 60 wt % NaNO₃, greater than or equal to 40 wt % and less than or equal to 55 wt % NaNO₃, greater than or equal to 40 wt % and less than or equal to 50 wt % NaNO₃, greater than or equal to 45 wt % and less than or equal to 80 wt % NaNO₃, greater than or equal to 45 wt % and less than or equal to 75 wt % NaNO₃, greater than or equal to 45 wt % and less than or equal to 70 wt % NaNO₃, greater than or equal to 45 wt % and less than or equal to 65 wt % NaNO₃, greater than or equal to 45 wt % and less than or equal to 60 wt % NaNO₃, greater than or equal to 45 wt % and less than or equal to 55 wt % NaNO₃, greater than or equal to 45 wt % and less than or equal to 50 wt % NaNO₃, greater than or equal to 30 wt % and less than or equal to 45 wt % NaNO₃, greater than or equal to 35 wt % and less than or equal to 45 wt % NaNO₃, greater than or equal to 40 wt % and less than or equal to 45 wt % NaNO₃, greater than or equal to 30 wt % and less than or equal to 40 wt % NaNO₃, greater than or equal to 35 wt % and less than or equal to 40 wt % NaNO₃, or greater than or equal to 30 wt % and less than or equal to 35 wt % NaNO₃. It should be understood that the above ranges include all subranges within the explicitly disclosed ranges.

In embodiments, the ion exchange medium comprises greater than or equal to 0.05 wt % and less than or equal to 0.25 wt % LiNO₃, greater than or equal to 0.08 wt % and less than or equal to 0.25 wt % LiNO₃, greater than or equal to 0.10 wt % and less than or equal to 0.25 wt % LiNO₃, greater than or equal to 0.15 wt % and less than or equal to 0.25 wt % LiNO₃, greater than or equal to 0.20 wt % and less than or equal to 0.25 wt % LiNO₃, greater than or equal to 0.05 wt % and less than or equal to 0.20 wt % LiNO₃, greater than or equal to 0.08 wt % and less than or equal to 0.20 wt % LiNO₃, greater than or equal to 0.10 wt % and less than or equal to 0.20 wt % LiNO₃, greater than or equal to 0.15 wt % and less than or equal to 0.20 wt % LiNO₃, greater than or equal to 0.05 wt % and less than or equal to 0.15 wt % LiNO₃, greater than or equal to 0.08 wt % and less than or equal to 0.15 wt % LiNO₃, greater than or equal to 0.10 wt % and less than or equal to 0.15 wt % LiNO₃, greater than or equal to 0.12 wt % and less than or equal to 0.15 wt % LiNO₃, greater than or equal to 0.05 wt % and less than or equal to 0.12 wt % LiNO₃, greater than or equal to 0.08 wt % and less than or equal to 0.12 wt % LiNO₃, greater than or equal to 0.10 wt % and less than or equal to 0.12 wt % LiNO₃, greater than or equal to 0.05 wt % and less than or equal to 0.10 wt % LiNO₃, greater than or equal to 0.08 wt % and less than or equal to 0.10 wt % LiNO₃, or greater than or equal to 0.05 wt % and less than or equal to 0.08 wt % LiNO₃. It should be understood that the above ranges include all subranges within the explicitly disclosed ranges.

In embodiments, the ion exchange medium comprises greater than or equal to 0.40 wt % and less than or equal to 0.60 wt % NaNO₂, greater than or equal to 0.45 wt % and less than or equal to 0.60 wt % NaNO₂, greater than or equal to 0.50 wt % and less than or equal to 0.60 wt % NaNO₂, greater than or equal to 0.55 wt % and less than or equal to 0.60 wt % NaNO₂, greater than or equal to 0.40 wt % and less than or equal to 0.55 wt % NaNO₂, greater than or equal to 0.45 wt % and less than or equal to 0.55 wt % NaNO₂, greater than or equal to 0.50 wt % and less than or equal to 0.55 wt % NaNO₂, greater than or equal to 0.40 wt % and less than or equal to 0.50 wt % NaNO₂, greater than or equal to 0.45 wt % and less than or equal to 0.50 wt % NaNO₂, or greater than or equal to 0.40 wt % and less than or equal to 0.45 wt %. It should be understood that the above ranges include all subranges within the explicitly disclosed ranges.

In embodiments, the ion exchange medium comprises greater than or equal to 0.40 wt % and less than or equal to 0.60 wt % silicic acid, greater than or equal to 0.45 wt % and less than or equal to 0.60 wt % silicic acid, greater than or equal to 0.50 wt % and less than or equal to 0.60 wt % silicic acid, greater than or equal to 0.55 wt % and less than or equal to 0.60 wt % silicic acid, greater than or equal to 0.40 wt % and less than or equal to 0.55 wt % silicic acid, greater than or equal to 0.45 wt % and less than or equal to 0.55 wt % silicic acid, greater than or equal to 0.50 wt % and less than or equal to 0.55 wt % silicic acid, greater than or equal to 0.40 wt % and less than or equal to 0.50 wt % silicic acid, greater than or equal to 0.45 wt % and less than or equal to 0.50 wt % silicic acid, or greater than or equal to 0.40 wt % and less than or equal to 0.45 wt %. It should be understood that the above ranges include all subranges within the explicitly disclosed ranges.

The temperature of the ion exchange medium is, in embodiments, greater than or equal to 430° C. and less than or equal to 550° C., greater than or equal to 450° C. and less than or equal to 550° C., greater than or equal to 475° C. and less than or equal to 550° C., greater than or equal to 500° C. and less than or equal to 550° C., greater than or equal to 525° C. and less than or equal to 550° C., greater than or equal to 530° C. and less than or equal to 550° C., greater than or equal to 430° C. and less than or equal to 530° C., greater than or equal to 450° C. and less than or equal to 530° C., greater than or equal to 475° C. and less than or equal to 530° C., greater than or equal to 500° C. and less than or equal to 530° C., greater than or equal to 525° C. and less than or equal to 530° C., greater than or equal to 430° C. and less than or equal to 525° C., greater than or equal to 450° C. and less than or equal to 525° C., greater than or equal to 475° C. and less than or equal to 525° C., greater than or equal to 500° C. and less than or equal to 525° C., greater than or equal to 430° C. and less than or equal to 500° C., greater than or equal to 450° C. and less than or equal to 500° C., greater than or equal to 475° C. and less than or equal to 500° C., or greater than or equal to 450° C. and less than or equal to 475° C. It should be understood that the above ranges include all subranges within the explicitly disclosed ranges.

According to embodiments, the glass-ceramic or glass-ceramic article is contacted with the ion exchange medium for a duration that is greater than or equal to 1 hour and less than or equal to 16 hours, greater than or equal to 2 hour and less than or equal to 16 hours, greater than or equal to 4 hour and less than or equal to 16 hours, greater than or equal to 6 hour and less than or equal to 16 hours, greater than or equal to 8 hour and less than or equal to 16 hours, greater than or equal to 10 hour and less than or equal to 16 hours, greater than or equal to 12 hour and less than or equal to 16 hours, greater than or equal to 14 hour and less than or equal to 16 hours, greater than or equal to 1 hour and less than or equal to 14 hours, greater than or equal to 2 hour and less than or equal to 14 hours, greater than or equal to 4 hour and less than or equal to 14 hours, greater than or equal to 6 hour and less than or equal to 14 hours, greater than or equal to 8 hour and less than or equal to 14 hours, greater than or equal to 10 hour and less than or equal to 14 hours, greater than or equal to 12 hour and less than or equal to 14 hours, greater than or equal to 1 hour and less than or equal to 12 hours, greater than or equal to 2 hour and less than or equal to 12 hours, greater than or equal to 4 hour and less than or equal to 12 hours, greater than or equal to 6 hour and less than or equal to 12 hours, greater than or equal to 8 hour and less than or equal to 12 hours, greater than or equal to 10 hour and less than or equal to 12 hours, greater than or equal to 1 hour and less than or equal to 10 hours, greater than or equal to 2 hour and less than or equal to 10 hours, greater than or equal to 4 hour and less than or equal to 10 hours, greater than or equal to 6 hour and less than or equal to 10 hours, greater than or equal to 8 hour and less than or equal to 10 hours, greater than or equal to 1 hour and less than or equal to 8 hours, greater than or equal to 2 hour and less than or equal to 8 hours, greater than or equal to 4 hour and less than or equal to 8 hours, greater than or equal to 6 hour and less than or equal to 8 hours, greater than or equal to 1 hour and less than or equal to 6 hours, greater than or equal to 2 hour and less than or equal to 6 hours, greater than or equal to 4 hour and less than or equal to 6 hours, greater than or equal to 1 hour and less than or equal to 4 hours, greater than or equal to 2 hour and less than or equal to 4 hours, or greater than or equal to 1 hour and less than or equal to 2 hours. It should be understood that the above ranges include all subranges within the explicitly disclosed ranges.

After an ion exchange process is performed, it should be understood that a composition at the surface of the glass-ceramic may be different from the composition of the as-formed glass-ceramic (i.e., the glass-ceramic before it undergoes an ion exchange process). This results from one type of alkali metal ion in the as-formed glass-ceramic, such as, for example Li⁺ or Na⁺, being replaced with larger alkali metal ions, such as, for example Na⁺ or K⁺, respectively. However, in embodiments, the composition of the glass-ceramic at or near the center of the depth of the glass-ceramic may still have the composition of the as-formed glass-ceramic. In other embodiments, the composition of the glass-ceramic at or near the center of the depth of the glass-ceramic may be different from the composition of the as-formed glass-ceramic. As utilized herein, the center of the glass-ceramic article refers to any location in the glass-ceramic article that is a distance of at least 0.5 t from every surface thereof, where t is the thickness of the glass-ceramic or glass-ceramic article.

The mechanical properties of the glass-ceramics disclosed herein are tested on strengthened glass-ceramic articles unless otherwise indicated. By forming a glass-ceramic having a composition as disclosed and described herein, using the heat treatments and chemical strengthening as disclosed and described herein, glass-ceramics with phase assemblages that provide low haze and improved mechanical properties (as described in detail below) can be achieved. Even though described in separate paragraphs below, the various mechanical properties are present in combination in glass-ceramics of embodiments. The balance of these mechanical properties provide a durable, robust glass-ceramic that is difficult to achieve without sacrificing other mechanical properties. For instance, and as an example only, achieving high compressive stress alone is possible, but achieving high compressive stress and central tension can be more difficult.

In embodiments, the depths of compression from each surface, DOC and DOC′, are individually greater than or equal to 0.09 t and less than or equal to 0.30 t, greater than or equal to 0.10 t and less than or equal to 0.30 t, greater than or equal to 0.11 t and less than or equal to 0.30 t, greater than or equal to 0.12 t and less than or equal to 0.30 t, greater than or equal to 0.13 t and less than or equal to 0.30 t, greater than or equal to 0.14 t and less than or equal to 0.30 t, greater than or equal to 0.15 t and less than or equal to 0.30 t, greater than or equal to 0.16 t and less than or equal to 0.30 t, greater than or equal to 0.17 t and less than or equal to 0.30 t, greater than or equal to 0.18 t and less than or equal to 0.30 t, greater than or equal to 0.19 t and less than or equal to 0.30 t, greater than or equal to 0.20 t and less than or equal to 0.30 t, greater than or equal to 0.21 t and less than or equal to 0.30 t, greater than or equal to 0.22 t and less than or equal to 0.30 t, greater than or equal to 0.23 t and less than or equal to 0.30 t, greater than or equal to 0.24 t and less than or equal to 0.30 t, greater than or equal to 0.09 t and less than or equal to 0.25 t, greater than or equal to 0.10 t and less than or equal to 0.25 t, greater than or equal to 0.11 t and less than or equal to 0.25 t, greater than or equal to 0.12 t and less than or equal to 0.25 t, greater than or equal to 0.13 t and less than or equal to 0.25 t, greater than or equal to 0.14 t and less than or equal to 0.25 t, greater than or equal to 0.15 t and less than or equal to 0.25 t, greater than or equal to 0.16 t and less than or equal to 0.25 t, greater than or equal to 0.17 t and less than or equal to 0.25 t, greater than or equal to 0.18 t and less than or equal to 0.25 t, greater than or equal to 0.19 t and less than or equal to 0.25 t, greater than or equal to 0.20 t and less than or equal to 0.25 t, greater than or equal to 0.21 t and less than or equal to 0.25 t, greater than or equal to 0.22 t and less than or equal to 0.25 t, greater than or equal to 0.23 t and less than or equal to 0.25 t, greater than or equal to 0.24 t and less than or equal to 0.25 t, greater than or equal to 0.09 t and less than or equal to 0.24 t, greater than or equal to 0.10 t and less than or equal to 0.24 t, greater than or equal to 0.11 t and less than or equal to 0.24 t, greater than or equal to 0.12 t and less than or equal to 0.24 t, greater than or equal to 0.13 t and less than or equal to 0.24 t, greater than or equal to 0.14 t and less than or equal to 0.24 t, greater than or equal to 0.15 t and less than or equal to 0.24 t, greater than or equal to 0.16 t and less than or equal to 0.24 t, greater than or equal to 0.17 and less than or equal to 0.24 t, greater than or equal to 0.18 t and less than or equal to 0.24 t, greater than or equal to 0.19 t and less than or equal to 0.24 t, greater than or equal to 0.20 t and less than or equal to 0.24 t, greater than or equal to 0.21 t and less than or equal to 0.24 t, greater than or equal to 0.22 t and less than or equal to 0.24 t, greater than or equal to 0.23 t and less than or equal to 0.24 t, greater than or equal to 0.09 t and less than or equal to 0.23 t, greater than or equal to 0.10 t and less than or equal to 0.23 t, greater than or equal to 0.11 t and less than or equal to 0.23 t, greater than or equal to 0.12 t and less than or equal to 0.23 t, greater than or equal to 0.13 t and less than or equal to 0.23 t, greater than or equal to 0.14 t and less than or equal to 0.23 t, greater than or equal to 0.15 t and less than or equal to 0.23 t, greater than or equal to 0.16 t and less than or equal to 0.23 t, greater than or equal to 0.17 t and less than or equal to 0.23 t, greater than or equal to 0.18 t and less than or equal to 0.23 t, greater than or equal to 0.19 t and less than or equal to 0.23 t, greater than or equal to 0.20 t and less than or equal to 0.23 t, greater than or equal to 0.21 t and less than or equal to 0.23 t, greater than or equal to 0.22 t and less than or equal to 0.23 t, greater than or equal to 0.09 t and less than or equal to 0.22 t, greater than or equal to 0.10 t and less than or equal to 0.22 t, greater than or equal to 0.11 t and less than or equal to 0.22 t, greater than or equal to 0.12 t and less than or equal to 0.22 t, greater than or equal to 0.13 t and less than or equal to 0.22 t, greater than or equal to 0.14 t and less than or equal to 0.22 t, greater than or equal to 0.15 t and less than or equal to 0.22 t, greater than or equal to 0.16 t and less than or equal to 0.22 t, greater than or equal to 0.17 t and less than or equal to 0.22 t, greater than or equal to 0.18 t and less than or equal to 0.22 t, greater than or equal to 0.19 t and less than or equal to 0.22 t, greater than or equal to 0.20 t and less than or equal to 0.22 t, greater than or equal to 0.21 t and less than or equal to 0.22 t, greater than or equal to 0.09 t and less than or equal to 0.21 t, greater than or equal to 0.10 t and less than or equal to 0.21 t, greater than or equal to 0.11 t and less than or equal to 0.21 t, greater than or equal to 0.12 t and less than or equal to 0.21 t, greater than or equal to 0.13 t and less than or equal to 0.21 t, greater than or equal to 0.14 t and less than or equal to 0.21 t, greater than or equal to 0.15 t and less than or equal to 0.21 t, greater than or equal to 0.16 t and less than or equal to 0.21 t, greater than or equal to 0.17 t and less than or equal to 0.21 t, greater than or equal to 0.18 t and less than or equal to 0.21 t, greater than or equal to 0.19 t and less than or equal to 0.21 t, greater than or equal to 0.20 t and less than or equal to 0.21 t, greater than or equal to 0.09 t and less than or equal to 0.20 t, greater than or equal to 0.10 t and less than or equal to 0.20 t, greater than or equal to 0.11 t and less than or equal to 0.20 t, greater than or equal to 0.12 t and less than or equal to 0.20 t, greater than or equal to 0.13 t and less than or equal to 0.20 t, greater than or equal to 0.14 t and less than or equal to 0.20 t, greater than or equal to 0.15 t and less than or equal to 0.20 t, greater than or equal to 0.16 t and less than or equal to 0.20 t, greater than or equal to 0.17 t and less than or equal to 0.20 t, greater than or equal to 0.18 t and less than or equal to 0.20 t, greater than or equal to 0.19 t and less than or equal to 0.20 t, greater than or equal to 0.09 t and less than or equal to 0.19 t, greater than or equal to 0.10 t and less than or equal to 0.19 t, greater than or equal to 0.11 t and less than or equal to 0.19 t, greater than or equal to 0.12 t and less than or equal to 0.19 t, greater than or equal to 0.13 t and less than or equal to 0.19 t, greater than or equal to 0.14 t and less than or equal to 0.19 t, greater than or equal to 0.15 t and less than or equal to 0.19 t, greater than or equal to 0.16 t and less than or equal to 0.19 t, greater than or equal to 0.17 t and less than or equal to 0.19 t, greater than or equal to 0.18 t and less than or equal to 0.19 t, greater than or equal to 0.09 t and less than or equal to 0.18 t, greater than or equal to 0.10 t and less than or equal to 0.18 t, greater than or equal to 0.11 t and less than or equal to 0.18 t, greater than or equal to 0.12 t and less than or equal to 0.18 t, greater than or equal to 0.13 t and less than or equal to 0.18 t, greater than or equal to 0.14 t and less than or equal to 0.18 t, greater than or equal to 0.15 t and less than or equal to 0.18 t, greater than or equal to 0.16 t and less than or equal to 0.18 t, greater than or equal to 0.17 t and less than or equal to 0.18 t, greater than or equal to 0.09 t and less than or equal to 0.17 t, greater than or equal to 0.10 t and less than or equal to 0.17 t, greater than or equal to 0.11 t and less than or equal to 0.17 t, greater than or equal to 0.12 t and less than or equal to 0.17 t, greater than or equal to 0.13 t and less than or equal to 0.17 t, greater than or equal to 0.14 t and less than or equal to 0.17 t, greater than or equal to 0.15 t and less than or equal to 0.17 t, greater than or equal to 0.16 t and less than or equal to 0.17 t, greater than or equal to 0.09 t and less than or equal to 0.16 t, greater than or equal to 0.10 t and less than or equal to 0.16 t, greater than or equal to 0.11 t and less than or equal to 0.16 t, greater than or equal to 0.12 t and less than or equal to 0.16 t, greater than or equal to 0.13 t and less than or equal to 0.16 t, greater than or equal to 0.14 t and less than or equal to 0.16 t, or greater than or equal to 0.15 t and less than or equal to 0.16 t, where “t” it the thickness as defined herein.

Still referring to FIG. 2 and as noted herein, there is also a central tension region 110 having a central tension (CT) between DOC and DOC′. Accordingly, stress transitions from compressive stress to tensile stress at DOC and DOC′, which are described hereinabove, measured from a surface toward a centerline of the strengthened glass-ceramic article.

In embodiments, the glass-ceramic articles may have a surface compressive stress (CS) of greater than or equal to 200 MPa and less than or equal to 550 MPa, such as greater than or equal to 225 MPa and less than or equal to 550 MPa, greater than or equal to 250 MPa and less than or equal to 550 MPa, greater than or equal to 275 MPa and less than or equal to 550 MPa, greater than or equal to 300 MPa and less than or equal to 550 MPa, greater than or equal to 325 MPa and less than or equal to 550 MPa, greater than or equal to 350 MPa and less than or equal to 550 MPa, greater than or equal to 375 MPa and less than or equal to 550 MPa, greater than or equal to 400 MPa and less than or equal to 550 MPa, greater than or equal to 425 MPa and less than or equal to 550 MPa, greater than or equal to 450 MPa and less than or equal to 550 MPa, greater than or equal to 475 MPa and less than or equal to 550 MPa, greater than or equal to 500 MPa and less than or equal to 550 MPa, greater than or equal to 525 MPa and less than or equal to 550 MPa, greater than or equal to 200 MPa and less than or equal to 500 MPa, such as greater than or equal to 225 MPa and less than or equal to 500 MPa, greater than or equal to 250 MPa and less than or equal to 500 MPa, greater than or equal to 275 MPa and less than or equal to 500 MPa, greater than or equal to 300 MPa and less than or equal to 500 MPa, greater than or equal to 325 MPa and less than or equal to 500 MPa, greater than or equal to 350 MPa and less than or equal to 500 MPa, greater than or equal to 375 MPa and less than or equal to 500 MPa, greater than or equal to 400 MPa and less than or equal to 500 MPa, greater than or equal to 425 MPa and less than or equal to 500 MPa, greater than or equal to 450 MPa and less than or equal to 500 MPa, greater than or equal to 475 MPa and less than or equal to 500 MPa, greater than or equal to 200 MPa and less than or equal to 475 MPa, such as greater than or equal to 225 MPa and less than or equal to 475 MPa, greater than or equal to 250 MPa and less than or equal to 475 MPa, greater than or equal to 275 MPa and less than or equal to 475 MPa, greater than or equal to 300 MPa and less than or equal to 475 MPa, greater than or equal to 325 MPa and less than or equal to 475 MPa, greater than or equal to 350 MPa and less than or equal to 475 MPa, greater than or equal to 375 MPa and less than or equal to 475 MPa, greater than or equal to 400 MPa and less than or equal to 475 MPa, greater than or equal to 425 MPa and less than or equal to 475 MPa, greater than or equal to 450 MPa and less than or equal to 475 MPa, greater than or equal to 200 MPa and less than or equal to 450 MPa, such as greater than or equal to 225 MPa and less than or equal to 450 MPa, greater than or equal to 250 MPa and less than or equal to 450 MPa, greater than or equal to 275 MPa and less than or equal to 450 MPa, greater than or equal to 300 MPa and less than or equal to 450 MPa, greater than or equal to 325 MPa and less than or equal to 450 MPa, greater than or equal to 350 MPa and less than or equal to 450 MPa, greater than or equal to 375 MPa and less than or equal to 450 MPa, greater than or equal to 400 MPa and less than or equal to 450 MPa, greater than or equal to 425 MPa and less than or equal to 450 MPa, greater than or equal to 200 MPa and less than or equal to 425 MPa, such as greater than or equal to 225 MPa and less than or equal to 425 MPa, greater than or equal to 250 MPa and less than or equal to 425 MPa, greater than or equal to 275 MPa and less than or equal to 425 MPa, greater than or equal to 300 MPa and less than or equal to 425 MPa, greater than or equal to 325 MPa and less than or equal to 425 MPa, greater than or equal to 350 MPa and less than or equal to 425 MPa, greater than or equal to 375 MPa and less than or equal to 425 MPa, greater than or equal to 400 MPa and less than or equal to 425 MPa, greater than or equal to 200 MPa and less than or equal to 400 MPa, such as greater than or equal to 225 MPa and less than or equal to 400 MPa, greater than or equal to 250 MPa and less than or equal to 400 MPa, greater than or equal to 275 MPa and less than or equal to 400 MPa, greater than or equal to 300 MPa and less than or equal to 400 MPa, greater than or equal to 325 MPa and less than or equal to 400 MPa, greater than or equal to 350 MPa and less than or equal to 400 MPa, greater than or equal to 375 MPa and less than or equal to 400 MPa, greater than or equal to 200 MPa and less than or equal to 375 MPa, greater than or equal to 225 MPa and less than or equal to 375 MPa, greater than or equal to 250 MPa and less than or equal to 375 MPa, greater than or equal to 275 MPa and less than or equal to 375 MPa, greater than or equal to 300 MPa and less than or equal to 375 MPa, greater than or equal to 325 MPa and less than or equal to 375 MPa, greater than or equal to 350 MPa and less than or equal to 375 MPa, greater than or equal to 200 MPa and less than or equal to 350 MPa, greater than or equal to 225 MPa and less than or equal to 350 MPa, greater than or equal to 250 MPa and less than or equal to 350 MPa, greater than or equal to 275 MPa and less than or equal to 350 MPa, greater than or equal to 300 MPa and less than or equal to 350 MPa, greater than or equal to 325 MPa and less than or equal to 350 MPa, greater than or equal to 200 MPa and less than or equal to 325 MPa, greater than or equal to 225 MPa and less than or equal to 325 MPa, greater than or equal to 250 MPa and less than or equal to 325 MPa, greater than or equal to 275 MPa and less than or equal to 325 MPa, greater than or equal to 300 MPa and less than or equal to 325 MPa, greater than or equal to 200 MPa and less than or equal to 300 MPa, greater than or equal to 225 MPa and less than or equal to 300 MPa, greater than or equal to 250 MPa and less than or equal to 300 MPa, greater than or equal to 275 MPa and less than or equal to 300 MPa, greater than or equal to 200 MPa and less than or equal to 275 MPa, greater than or equal to 225 MPa and less than or equal to 275 MPa, greater than or equal to 250 MPa and less than or equal to 275 MPa, greater than or equal to 200 MPa and less than or equal to 250 MPa, greater than or equal to 225 MPa and less than or equal to 250 MPa, or greater than or equal to 200 MPa and less than or equal to 225 MPa. It should be understood that the above ranges include all subranges within the explicitly disclosed ranges.

In embodiments, the maximum central tension (CT) is greater than or equal to 150 MPa, greater than or equal to 160 MPa, greater than or equal to 170 MPa, greater than or equal to 180 MPa, greater than or equal to 190 MPa, greater than or equal to 200 MPa, greater than or equal to 210 MPa, or even greater than or equal to 220 MPa. In embodiments, the maximum central tension is greater than or equal to 150 MPa and less than or equal to 230 MPa, greater than or equal to 160 MPa and less than or equal to 230 MPa, greater than or equal to 170 MPa and less than or equal to 230 MPa, greater than or equal to 180 MPa and less than or equal to 230 MPa, greater than or equal to 190 MPa and less than or equal to 230 MPa, greater than or equal to 200 MPa and less than or equal to 230 MPa, greater than or equal to 210 MPa and less than or equal to 230 MPa, greater than or equal to 220 MPa and less than or equal to 230 MPa, greater than or equal to 150 MPa and less than or equal to 220 MPa, greater than or equal to 160 MPa and less than or equal to 220 MPa, greater than or equal to 170 MPa and less than or equal to 220 MPa, greater than or equal to 180 MPa and less than or equal to 220 MPa, greater than or equal to 190 MPa and less than or equal to 220 MPa, greater than or equal to 200 MPa and less than or equal to 220 MPa, greater than or equal to 210 MPa and less than or equal to 220 MPa, greater than or equal to 150 MPa and less than or equal to 210 MPa, greater than or equal to 160 MPa and less than or equal to 210 MPa, greater than or equal to 170 MPa and less than or equal to 210 MPa, greater than or equal to 180 MPa and less than or equal to 210 MPa, greater than or equal to 190 MPa and less than or equal to 210 MPa, greater than or equal to 200 MPa and less than or equal to 210 MPa, greater than or equal to 150 MPa and less than or equal to 200 MPa, greater than or equal to 160 MPa and less than or equal to 200 MPa, greater than or equal to 170 MPa and less than or equal to 200 MPa, greater than or equal to 180 MPa and less than or equal to 200 MPa, or even greater than or equal to 190 MPa and less than or equal to 200 MPa. It should be understood that the above ranges include all subranges within the explicitly disclosed ranges.

In embodiments, the glass-ceramics have a ratio of CS to CT (CS/CT) that is greater than or equal to 0.87 and less than or equal to 3.6. It should be understood that the above ranges include all subranges within the explicitly disclosed ranges.

According to embodiments, the stress in the glass-ceramic article transitions from compressive stress to tensile stress at a depth measured from a surface of the glass-ceramic article toward the centerline of the glass-ceramic article that is greater than or equal to 0.09 t and less than or equal to 0.30 t, greater than or equal to 0.09 t and less than or equal to 0.30 t, greater than or equal to 0.10 t and less than or equal to 0.30 t, greater than or equal to 0.11 t and less than or equal to 0.30 t, greater than or equal to 0.12 t and less than or equal to 0.30 t, greater than or equal to 0.13 t and less than or equal to 0.30 t, greater than or equal to 0.14 t and less than or equal to 0.30 t, greater than or equal to 0.15 t and less than or equal to 0.30 t, greater than or equal to 0.16 t and less than or equal to 0.30 t, greater than or equal to 0.17 t and less than or equal to 0.30 t, greater than or equal to 0.18 t and less than or equal to 0.30 t, greater than or equal to 0.19 t and less than or equal to 0.30 t, greater than or equal to 0.20 t and less than or equal to 0.30 t, greater than or equal to 0.21 t and less than or equal to 0.30 t, greater than or equal to 0.22 t and less than or equal to 0.30 t, greater than or equal to 0.23 t and less than or equal to 0.30 t, greater than or equal to 0.24 t and less than or equal to 0.30 t, greater than or equal to 0.25 t and less than or equal to 0.30 t, greater than or equal to 0.09 t and less than or equal to 0.25 t, greater than or equal to 0.10 t and less than or equal to 0.25 t, greater than or equal to 0.11 t and less than or equal to 0.25 t, greater than or equal to 0.12 t and less than or equal to 0.25 t, greater than or equal to 0.13 t and less than or equal to 0.25 t, greater than or equal to 0.14 t and less than or equal to 0.25 t, greater than or equal to 0.15 t and less than or equal to 0.25 t, greater than or equal to 0.16 t and less than or equal to 0.25 t, greater than or equal to 0.17 t and less than or equal to 0.25 t, greater than or equal to 0.18 t and less than or equal to 0.25 t, greater than or equal to 0.19 t and less than or equal to 0.25 t, greater than or equal to 0.20 t and less than or equal to 0.25 t, greater than or equal to 0.21 t and less than or equal to 0.25 t, greater than or equal to 0.22 t and less than or equal to 0.25 t, greater than or equal to 0.23 t and less than or equal to 0.25 t, greater than or equal to 0.24 t and less than or equal to 0.25 t, greater than or equal to 0.09 t and less than or equal to 0.24 t, greater than or equal to 0.10 t and less than or equal to 0.24 t, greater than or equal to 0.11 t and less than or equal to 0.24 t, greater than or equal to 0.12 t and less than or equal to 0.24 t, greater than or equal to 0.13 t and less than or equal to 0.24 t, greater than or equal to 0.14 t and less than or equal to 0.24 t, greater than or equal to 0.15 t and less than or equal to 0.24 t, greater than or equal to 0.16 t and less than or equal to 0.24 t, greater than or equal to 0.17 t and less than or equal to 0.24 t, greater than or equal to 0.18 t and less than or equal to 0.24 t, greater than or equal to 0.19 t and less than or equal to 0.24 t, greater than or equal to 0.20 t and less than or equal to 0.24 t, greater than or equal to 0.21 t and less than or equal to 0.24 t, greater than or equal to 0.22 t and less than or equal to 0.24 t, greater than or equal to 0.23 t and less than or equal to 0.24 t, greater than or equal to 0.09 t and less than or equal to 0.23 t, greater than or equal to 0.10 t and less than or equal to 0.23 t, greater than or equal to 0.11 t and less than or equal to 0.23 t, greater than or equal to 0.12 t and less than or equal to 0.23 t, greater than or equal to 0.13 t and less than or equal to 0.23 t, greater than or equal to 0.14 t and less than or equal to 0.23 t, greater than or equal to 0.15 t and less than or equal to 0.23 t, greater than or equal to 0.16 t and less than or equal to 0.23 t, greater than or equal to 0.17 t and less than or equal to 0.23 t, greater than or equal to 0.18 t and less than or equal to 0.23 t, greater than or equal to 0.19 t and less than or equal to 0.23 t, greater than or equal to 0.20 t and less than or equal to 0.23 t, greater than or equal to 0.21 t and less than or equal to 0.23 t, greater than or equal to 0.22 t and less than or equal to 0.23 t, greater than or equal to 0.09 t and less than or equal to 0.22 t, greater than or equal to 0.10 t and less than or equal to 0.22 t, greater than or equal to 0.11 t and less than or equal to 0.22 t, greater than or equal to 0.12 t and less than or equal to 0.22 t, greater than or equal to 0.13 t and less than or equal to 0.22 t, greater than or equal to 0.14 t and less than or equal to 0.22 t, greater than or equal to 0.15 t and less than or equal to 0.22 t, greater than or equal to 0.16 t and less than or equal to 0.22 t, greater than or equal to 0.17 t and less than or equal to 0.22 t, greater than or equal to 0.18 t and less than or equal to 0.22 t, greater than or equal to 0.19 t and less than or equal to 0.22 t, greater than or equal to 0.20 t and less than or equal to 0.22 t, greater than or equal to 0.21 t and less than or equal to 0.22 t, greater than or equal to 0.09 t and less than or equal to 0.21 t, greater than or equal to 0.10 t and less than or equal to 0.21 t, greater than or equal to 0.11 t and less than or equal to 0.21 t, greater than or equal to 0.12 t and less than or equal to 0.21 t, greater than or equal to 0.13 t and less than or equal to 0.21 t, greater than or equal to 0.14 t and less than or equal to 0.21 t, greater than or equal to 0.15 t and less than or equal to 0.21 t, greater than or equal to 0.16 t and less than or equal to 0.21 t, greater than or equal to 0.17 t and less than or equal to 0.21 t, greater than or equal to 0.18 t and less than or equal to 0.21 t, greater than or equal to 0.19 t and less than or equal to 0.21 t, greater than or equal to 0.20 t and less than or equal to 0.21 t, greater than or equal to 0.09 t and less than or equal to 0.20 t, greater than or equal to 0.10 t and less than or equal to 0.20 t, greater than or equal to 0.11 t and less than or equal to 0.20 t, greater than or equal to 0.12 t and less than or equal to 0.20 t, greater than or equal to 0.13 t and less than or equal to 0.20 t, greater than or equal to 0.14 t and less than or equal to 0.20 t, greater than or equal to 0.15 t and less than or equal to 0.20 t, greater than or equal to 0.16 t and less than or equal to 0.20 t, greater than or equal to 0.17 t and less than or equal to 0.20 t, greater than or equal to 0.18 t and less than or equal to 0.20 t, greater than or equal to 0.19 t and less than or equal to 0.20 t, greater than or equal to 0.09 t and less than or equal to 0.19 t, greater than or equal to 0.10 t and less than or equal to 0.19 t, greater than or equal to 0.11 t and less than or equal to 0.19 t, greater than or equal to 0.12 t and less than or equal to 0.19 t, greater than or equal to 0.13 t and less than or equal to 0.19 t, greater than or equal to 0.14 t and less than or equal to 0.19 t, greater than or equal to 0.15 t and less than or equal to 0.19 t, greater than or equal to 0.16 t and less than or equal to 0.19 t, greater than or equal to 0.17 t and less than or equal to 0.19 t, or greater than or equal to 0.18 t and less than or equal to 0.19 t. It should be understood that the above ranges include all subranges within the explicitly disclosed ranges.

According to embodiments, the glass-ceramic article has a maximum central tension (mCT) and the absolute value of the surface compressive stress measured at a surface of the glass-ceramic article is greater than or equal to 0.87 mCT and less than or equal to 3.6 mCT, greater than or equal to 0.9 mCT and less than or equal to 3.6 mCT, greater than or equal to 1.0 mCT and less than or equal to 3.6 mCT, greater than or equal to 1.1 mCT and less than or equal to 3.6 mCT, greater than or equal to 1.2 mCT and less than or equal to 3.6 mCT, greater than or equal to 1.3 mCT and less than or equal to 3.6 mCT, greater than or equal to 1.4 mCT and less than or equal to 3.6 mCT, greater than or equal to 1.5 mCT and less than or equal to 3.6 mCT, greater than or equal to 1.6 mCT and less than or equal to 3.6 mCT, greater than or equal to 1.7 mCT and less than or equal to 3.6 mCT, greater than or equal to 1.8 mCT and less than or equal to 3.6 mCT, greater than or equal to 1.9 mCT and less than or equal to 3.6 mCT, greater than or equal to 2.0 mCT and less than or equal to 3.6 mCT, greater than or equal to 2.1 mCT and less than or equal to 3.6 mCT, greater than or equal to 2.2 mCT and less than or equal to 3.6 mCT, greater than or equal to 2.3 mCT and less than or equal to 3.6 mCT, greater than or equal to 2.4 mCT and less than or equal to 3.6 mCT, greater than or equal to 2.5 mCT and less than or equal to 3.6 mCT, greater than or equal to 2.6 mCT and less than or equal to 3.6 mCT, greater than or equal to 2.7 mCT and less than or equal to 3.6 mCT, greater than or equal to 2.8 mCT and less than or equal to 3.6 mCT, greater than or equal to 2.9 mCT and less than or equal to 3.6 mCT, or greater than or equal to 3.0 mCT and less than or equal to 3.6 mCT. It should be understood that the above ranges include all subranges within the explicitly disclosed ranges.

In embodiments, the stored strain energy of the glass-ceramic article is greater than or equal to 22 J/m² and less than or equal to 62 J/m², such as greater than or equal to 25 J/m² and less than or equal to 62 J/m², greater than or equal to 30 J/m² and less than or equal to 62 J/m², greater than or equal to 35 J/m² and less than or equal to 62 J/m², greater than or equal to 40 J/m² and less than or equal to 62 J/m², greater than or equal to 45 J/m² and less than or equal to 62 J/m², greater than or equal to 50 J/m² and less than or equal to 62 J/m², greater than or equal to 55 J/m² and less than or equal to 62 J/m², greater than or equal to 22 J/m² and less than or equal to 60 J/m², greater than or equal to 25 J/m² and less than or equal to 60 J/m², greater than or equal to 30 J/m² and less than or equal to 60 J/m², greater than or equal to 35 J/m² and less than or equal to 60 J/m², greater than or equal to 40 J/m² and less than or equal to 60 J/m², greater than or equal to 45 J/m² and less than or equal to 60 J/m², greater than or equal to 50 J/m² and less than or equal to 60 J/m², greater than or equal to 55 J/m² and less than or equal to 60 J/m², greater than or equal to 22 J/m² and less than or equal to 55 J/m², such as greater than or equal to 25 J/m² and less than or equal to 55 J/m², greater than or equal to 30 J/m² and less than or equal to 55 J/m², greater than or equal to 35 J/m² and less than or equal to 55 J/m², greater than or equal to 40 J/m² and less than or equal to 55 J/m², greater than or equal to 45 J/m² and less than or equal to 55 J/m², greater than or equal to 50 J/m² and less than or equal to 55 J/m², greater than or equal to 22 J/m² and less than or equal to 50 J/m², such as greater than or equal to 25 J/m² and less than or equal to 50 J/m², greater than or equal to 30 J/m² and less than or equal to 50 J/m², greater than or equal to 35 J/m² and less than or equal to 50 J/m², greater than or equal to 40 J/m² and less than or equal to 50 J/m², greater than or equal to 45 J/m² and less than or equal to 50 J/m², greater than or equal to 22 J/m² and less than or equal to 45 J/m², such as greater than or equal to 25 J/m² and less than or equal to 45 J/m², greater than or equal to 30 J/m² and less than or equal to 45 J/m², greater than or equal to 35 J/m² and less than or equal to 45 J/m², greater than or equal to 40 J/m² and less than or equal to 45 J/m², greater than or equal to 22 J/m² and less than or equal to 40 J/m², such as greater than or equal to 25 J/m² and less than or equal to 40 J/m², greater than or equal to 30 J/m² and less than or equal to 40 J/m², greater than or equal to 35 J/m² and less than or equal to 40 J/m², greater than or equal to 22 J/m² and less than or equal to 35 J/m², such as greater than or equal to 25 J/m² and less than or equal to 35 J/m², greater than or equal to 30 J/m² and less than or equal to 35 J/m², greater than or equal to 22 J/m² and less than or equal to 30 J/m², such as greater than or equal to 25 J/m² and less than or equal to 30 J/m², or greater than or equal to 22 J/m² and less than or equal to 25 J/m². It should be understood that the above ranges include all subranges within the explicitly disclosed ranges. The glass-ceramic achieves the aforementioned stored strain energy with no bifurcation in crack pattern.

Glass-ceramics according to embodiments have a Knoop Hardness (at 200 g load) measured on an unstrengthened glass-ceramic that is greater than or equal to 550 Kgf/mm² and less than or equal to 610 Kgf/mm², such as greater than or equal to 560 Kgf/mm² and less than or equal to 610 Kg/mm², greater than or equal to 570 Kgf/mm² and less than or equal to 610 Kgf/mm², greater than or equal to 580 Kgf/mm² and less than or equal to 610 Kg/mm², greater than or equal to 590 Kgf/mm² and less than or equal to 610 Kgf/mm², or even greater than or equal to 600 Kgf/mm² and less than or equal to 610 Kg/mm². It should be understood that the above ranges include all subranges within the explicitly disclosed ranges.

Glass-ceramics according to embodiments have a Knoop Hardness (at 200 g load) measured on a strengthened glass-ceramic that is greater than 610 Kgf/mm² and less than or equal to 640 Kgf/mm², such as greater than or equal to 615 Kgf/mm² and less than or equal to 640 Kgf/mm², greater than or equal to 620 Kgf/mm² and less than or equal to 640 Kgf/mm², greater than or equal to 625 Kgf/mm² and less than or equal to 640 Kgf/mm², greater than or equal to 630 Kgf/mm² and less than or equal to 640 Kgf/mm², or even greater than or equal to 635 Kgf/mm² and less than or equal to 640 Kgf/mm². In embodiments, the Knoop Hardness (at 200g load) measured on a strengthened glass-ceramic may be greater than 610 Kgf/mm² and less than or equal to 635 Kg/mm², such as greater than 610 Kgf/mm² and less than or equal to 630 Kgf/mm², greater than 610 Kg/mm² and less than or equal to 625 Kg/mm², greater than 610 Kg/mm² and less than or equal to 620 Kg/mm², oven greater than 610 Kg/mm² and less than or equal to 615 Kgf/mm². It should be understood that the above ranges include all subranges within the explicitly disclosed ranges.

In embodiments, the glass-ceramic article has a thickness t that is greater than or equal to 0.1 mm and less than or equal to 2.0 mm, greater than or equal to 0.3 mm and less than or equal to 2.0 mm, greater than or equal to 0.5 mm and less than or equal to 2.0 mm, greater than or equal to 0.8 mm and less than or equal to 2.0 mm, greater than or equal to 1.0 mm and less than or equal to 2.0 mm, greater than or equal to 1.3 mm and less than or equal to 2.0 mm, greater than or equal to 1.5 mm and less than or equal to 2.0 mm, greater than or equal to 1.8 mm and less than or equal to 2.0 mm, greater than or equal to 0.1 mm and less than or equal to 1.8 mm, greater than or equal to 0.3 mm and less than or equal to 1.8 mm, greater than or equal to 0.5 mm and less than or equal to 1.8 mm, greater than or equal to 0.8 mm and less than or equal to 1.8 mm, greater than or equal to 1.0 mm and less than or equal to 1.8 mm, greater than or equal to 1.3 mm and less than or equal to 1.8 mm, greater than or equal to 1.5 mm and less than or equal to 1.8 mm, greater than or equal to 0.1 mm and less than or equal to 1.5 mm, greater than or equal to 0.3 mm and less than or equal to 1.5 mm, greater than or equal to 0.5 mm and less than or equal to 1.5 mm, greater than or equal to 0.8 mm and less than or equal to 1.5 mm, greater than or equal to 1.0 mm and less than or equal to 1.5 mm, greater than or equal to 1.3 mm and less than or equal to 1.5 mm, greater than or equal to 0.1 mm and less than or equal to 1.3 mm, greater than or equal to 0.3 mm and less than or equal to 1.3 mm, greater than or equal to 0.5 mm and less than or equal to 1.3 mm, greater than or equal to 0.8 mm and less than or equal to 1.3 mm, greater than or equal to 1.0 mm and less than or equal to 1.3 mm, greater than or equal to 0.1 mm and less than or equal to 1.0 mm, greater than or equal to 0.3 mm and less than or equal to 1.0 mm, greater than or equal to 0.5 mm and less than or equal to 1.0 mm, greater than or equal to 0.8 mm and less than or equal to 1.0 mm, greater than or equal to 0.1 mm and less than or equal to 0.8 mm, greater than or equal to 0.3 mm and less than or equal to 0.8 mm, greater than or equal to 0.5 mm and less than or equal to 0.8 mm, greater than or equal to 0.1 mm and less than or equal to 0.5 mm, greater than or equal to 0.3 mm and less than or equal to 0.5 mm, or greater than or equal to 0.1 mm and less than or equal to 0.3 mm. It should be understood that the above ranges include all subranges within the explicitly disclosed ranges.

In embodiments, the fracture toughness of the non-chemically strengthened glass-ceramic article is greater than or equal to 1.0 MPa√m and less than or equal to 2.0 MPa√m, greater than or equal to 1.1 MPa√m and less than or equal to 2.0 MPa√m, greater than or equal to 1.2 MPa√m and less than or equal to 2.0 MPa√m, greater than or equal to 1.4 MPa√m and less than or equal to 2.0 MPa√m, greater than or equal to 1.0 MPa√m and less than or equal to 1.8 MPa√m, greater than or equal to 1.1 MPa√m and less than or equal to 1.8 MPa√m, greater than or equal to 1.2 MPa√m and less than or equal to 1.8 MPa√m, greater than or equal to 1.3 MPa√m and less than or equal to 1.8 MPa√m, greater than or equal to 1.4 MPa√m and less than or equal to 1.8 MPa√m, greater than or equal to 1.0 MPa√m and less than or equal to 1.6 MPa√m, greater than or equal to 1.1 MPa√m and less than or equal to 1.6 MPa√m, greater than or equal to 1.2 MPa√m and less than or equal to 1.6 MPa√m, greater than or equal to 1.3 MPa√m and less than or equal to 1.6 MPa√m, greater than or equal to 1.4 MPa√m and less than or equal to 1.6 MPa√m, greater than or equal to 1.5 MPa√m and less than or equal to 1.6 MPa√m, greater than or equal to 1.0 MPa√m and less than or equal to 1.5 MPa√m, greater than or equal to 1.1 MPa√m and less than or equal to 1.5 MPa√m, greater than or equal to 1.2 MPa√m and less than or equal to 1.5 MPa√m, greater than or equal to 1.3 MPa√m and less than or equal to 1.5 MPa√m, greater than or equal to 1.4 MPa√m and less than or equal to 1.5 MPa√m, greater than or equal to 1.0 MPa√m and less than or equal to 1.4 MPa√m, greater than or equal to 1.1 MPa√m and less than or equal to 1.4 MPa√m, greater than or equal to 1.2 MPa√m and less than or equal to 1.4 MPa√m, greater than or equal to 1.0 MPa√m and less than or equal to 1.3 MPa√m, greater than or equal to 1.1 MPa√m and less than or equal to 1.3 MPa√m, greater than or equal to 1.2 MPa√m and less than or equal to 1.3 MPa√m, or even greater than or equal to 1.0 MPa√m and less than or equal to 1.2 MPa√m. It should be understood that the above ranges include all subranges within the explicitly disclosed ranges.

In embodiments, the Young's modulus (also referred to as elastic modulus) of the non-chemically strengthened glass-ceramic article is greater than or equal to 90 GPa and less than or equal to 130 GPa, such as greater than or equal to 95 GPa and less than or equal to 130 GPa, greater than or equal to 100 GPa and less than or equal to 130 GPa, greater than or equal to 105 GPa and less than or equal to 130 GPa, greater than or equal to 90 GPa and less than or equal to 120 GPa, greater than or equal to 95 GPa and less than or equal to 120 GPa, greater than or equal to 100 GPa and less than or equal to 120 GPa, greater than or equal to 105 GPa and less than or equal to 120 GPa, greater than or equal to 90 GPa and less than or equal to 110 GPa, greater than or equal to 95 GPa and less than or equal to 110 GPa, greater than or equal to 100 GPa and less than or equal to 110 GPa, greater than or equal to 105 GPa and less than or equal to 110 GPa, or greater than or equal to 90 GPa and less than or equal to 105 GPa. It should be understood that the above ranges include all subranges within the explicitly disclosed ranges.

In embodiments, the non-chemically strengthened glass-ceramic articles have a Poisson's ratio that is greater than or equal to 0.15 and less than or equal to 0.25, greater than or equal to 0.17 and less than or equal to 0.25, greater than or equal to 0.20 and less than or equal to 0.25, greater than or equal to 0.22 and less than or equal to 0.25, greater than or equal to 0.15 and less than or equal to 0.22, greater than or equal to 0.17 and less than or equal to 0.22, greater than or equal to 0.20 and less than or equal to 0.22, greater than or equal to 0.15 and less than or equal to 0.20, greater than or equal to 0.17 and less than or equal to 0.20. It should be understood that the above ranges include all subranges within the explicitly disclosed ranges.

In embodiments, the non-chemically strengthened glass-ceramic articles have a shear modulus that is greater than or equal to 40 GPa and less than or equal to 50 GPa, greater than or equal to 41 GPa and less than or equal to 50 GPa, greater than or equal to 42 GPa and less than or equal to 50 GPa, greater than or equal to 40 GPa and less than or equal to 48 GPa, greater than or equal to 41 GPa and less than or equal to 48 GPa, greater than or equal to 42 GPa and less than or equal to 48 GPa, greater than or equal to 43 GPa and less than or equal to 45 GPa, or greater than or equal to 40 GPa and less than or equal to 43 GPa. It should be understood that the above ranges include all subranges within the explicitly disclosed ranges.

The fracture strength was measured by applied fracture stress to failure with a 4 point bending test after introducing flaws using 80 grit Al₂O₃ sand paper. Testing was performed using an apparatus comprising a simple pendulum-based four point bend test having a surface ranging from flat to curved, where the glass-ceramic article test specimen is mounted to a bob of a pendulum, which is then used to cause the test specimen to contact a roughened impact surface. The apparatus is described in detail in International Application Publication No. WO2017/100646, which is hereby incorporated by reference in its entirety. To perform the test, the sample is loaded on the holder and then pulled backwards from the pendulum equilibrium position and released to make a dynamic impact on the impact surface.

The fracture strength of the glass-ceramic according to embodiments measured on glass-ceramic articles strengthened by ion exchange and having a thickness of 0.5 mm using 80 grit Al₂O₃ sandpaper damage introduction is greater than or equal to 250 MPa and less than or equal to 450 MPa, greater than or equal to 275 MPa and less than or equal to 450 MPa, greater than or equal to 300 MPa and less than or equal to 450 MPa, greater than or equal to 325 MPa and less than or equal to 450 MPa, greater than or equal to 350 MPa and less than or equal to 450 MPa, greater than or equal to 375 MPa and less than or equal to 450 MPa, greater than or equal to 400 MPa and less than or equal to 450 MPa, greater than or equal to 425 MPa and less than or equal to 450 MPa, greater than or equal to 250 MPa and less than or equal to 450 MPa, greater than or equal to 275 MPa and less than or equal to 450 MPa, greater than or equal to 300 MPa and less than or equal to 425 MPa, greater than or equal to 325 MPa and less than or equal to 425 MPa, greater than or equal to 350 MPa and less than or equal to 425 MPa, greater than or equal to 375 MPa and less than or equal to 425 MPa, or even greater than or equal to 400 MPa and less than or equal to 425 MPa. It should be understood that the above ranges include all subranges within the explicitly disclosed ranges.

The fracture strength of the glass-ceramic according to embodiments measured on a glass-ceramic article strengthened by ion exchange and having a thickness of 0.6 mm using 80 grit Al₂O₃ sandpaper is greater than or equal to 250 MPa and less than or equal to 450 MPa, greater than or equal to 275 MPa and less than or equal to 450 MPa, greater than or equal to 300 MPa and less than or equal to 450 MPa, greater than or equal to 325 MPa and less than or equal to 450 MPa, greater than or equal to 350 MPa and less than or equal to 450 MPa, greater than or equal to 375 MPa and less than or equal to 450 MPa, greater than or equal to 400 MPa and less than or equal to 450 MPa, greater than or equal to 425 MPa and less than or equal to 450 MPa, greater than or equal to 250 MPa and less than or equal to 425 MPa, greater than or equal to 275 MPa and less than or equal to 425 MPa, greater than or equal to 300 MPa and less than or equal to 425 MPa, greater than or equal to 325 MPa and less than or equal to 425 MPa, greater than or equal to 350 MPa and less than or equal to 425 MPa, greater than or equal to 375 MPa and less than or equal to 425 MPa, or even greater than or equal to 400 MPa and less than or equal to 425 MPa. It should be understood that the above ranges include all subranges within the explicitly disclosed ranges.

The Drop Test Method is used to determine the maximum height (i.e., the drop height) from which the precusor glass or glass-ceramic can be dropped without catastrophic failure. The Drop Test Method involves performing face-drop testing on a puck with a precusor glass or glass-ceramic article attached thereto. The precusor glass or glass-ceramic article to be tested has a thickness similar or equal to the thickness that will be used in a given hand-held consumer electronic device. A puck refers to a structure meant to mimic the size, shape, and weight distribution of a given device, such as a cell phone. Hereinafter, the term “puck,” refers to a structure that has a weight of 126.0 grams, a length of 133.1 mm, a width of 68.2 mm, and a height of 9.4 mm.

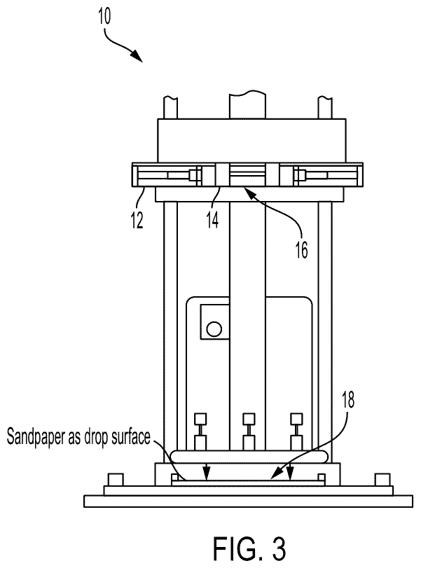

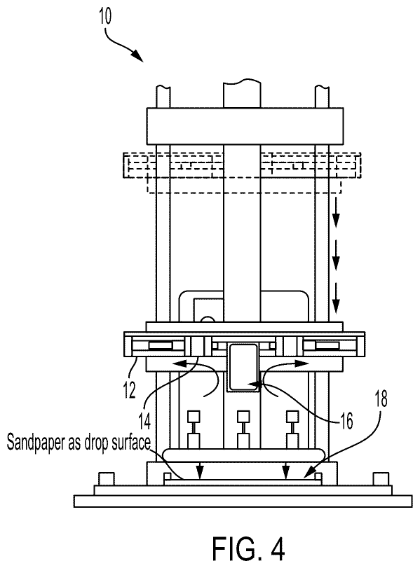

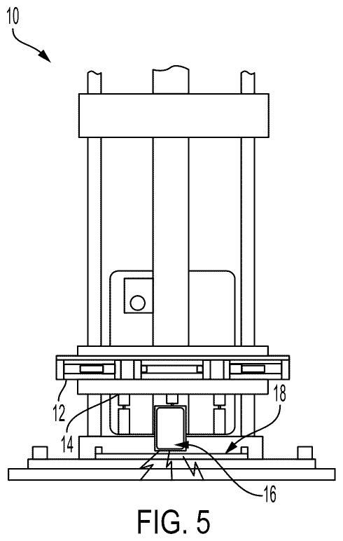

An exemplary device-drop machine that may be used to conduct the Drop Test Method is shown as reference number 10 in FIG. 3. The device-drop machine 10 includes a chuck 12 having chuck jaws 14. The puck 16 is staged in the chuck jaws 14 with the precusor glass article or glass-ceramic article attached thereto and facing downward. The chuck 12 is ready to fall from, for example, an electro-magnetic chuck lifter. Referring now to FIG. 4, the chuck 12 is released and during its fall, the chuck jaws 14 are triggered to open by, for example, a proximity sensor. As the chuck jaws 14 open, the puck 16 is released. Referring now to FIG. 5, the falling puck 16 strikes a drop surface 18. The drop surface 18 may be sandpaper, such as 80 grit sandpaper (however, other grit sandpaper may be used). If the precusor glass or glass-ceramic article attached to the puck survives the fall (i.e., does not crack), the chuck 12 is set at an increased height and the test is repeated. The failure height is then the lowest height from which the puck including the precusor glass or glass-ceramic article is dropped and the precusor glass or glass-ceramic article fails.

In embodiments the drop height of a 0.6 mm thick glass-ceramic article onto 80 grit sandpaper is greater than or equal to 170 cm and less than or equal to 250 cm, greater than or equal to 180 cm and less than or equal to 250 cm, greater than or equal to 190 cm and less than or equal to 250 cm, greater than or equal to 200 cm and less than or equal to 250 cm, greater than or equal to 210 cm and less than or equal to 250 cm, greater than or equal to 220 cm and less than or equal to 250 cm, greater than or equal to 170 cm and less than or equal to 240 cm, greater than or equal to 180 cm and less than or equal to 240 cm, greater than or equal to 190 cm and less than or equal to 240 cm, greater than or equal to 200 cm and less than or equal to 240 cm, greater than or equal to 210 cm and less than or equal to 240 cm, greater than or equal to 220 cm and less than or equal to 240 cm, greater than or equal to 170 cm and less than or equal to 230 cm, greater than or equal to 180 cm and less than or equal to 230 cm, greater than or equal to 190 cm and less than or equal to 230 cm, greater than or equal to 200 cm and less than or equal to 230 cm, greater than or equal to 210 cm and less than or equal to 230 cm, greater than or equal to 220 cm and less than or equal to 230 cm, greater than or equal to 170 cm and less than or equal to 220 cm, greater than or equal to 180 cm and less than or equal to 220 cm, greater than or equal to 190 cm and less than or equal to 220 cm, greater than or equal to 200 cm and less than or equal to 220 cm, or even greater than or equal to 210 cm and less than or equal to 220 cm. It should be understood that the above ranges include all subranges within the explicitly disclosed ranges.

In embodiments the drop height of a 0.5 mm thick glass-ceramic article on 80 grit sandpaper is greater than or equal to 150 cm and less than or equal to 240 cm, greater than or equal to 160 cm and less than or equal to 240 cm, greater than or equal to 170 cm and less than or equal to 240 cm, greater than or equal to 180 cm and less than or equal to 240 cm, greater than or equal to 190 cm and less than or equal to 240 cm, greater than or equal to 200 cm and less than or equal to 240 cm, greater than or equal to 180 cm and less than or equal to 230 cm, greater than or equal to 150 cm and less than or equal to 230 cm, greater than or equal to 160 cm and less than or equal to 230 cm, greater than or equal to 170 cm and less than or equal to 230 cm, greater than or equal to 180 cm and less than or equal to 230 cm, greater than or equal to 190 cm and less than or equal to 230 cm, greater than or equal to 200 cm and less than or equal to 230 cm, greater than or equal to 150 cm and less than or equal to 220 cm, greater than or equal to 160 cm and less than or equal to 220 cm, greater than or equal to 170 cm and less than or equal to 220 cm, greater than or equal to 180 cm and less than or equal to 220 cm, greater than or equal to 190 cm and less than or equal to 220 cm, greater than or equal to 200 cm and less than or equal to 220 cm, greater than or equal to 150 cm and less than or equal to 210 cm, greater than or equal to 160 cm and less than or equal to 210 cm, greater than or equal to 170 cm and less than or equal to 210 cm, greater than or equal to 180 cm and less than or equal to 210 cm, greater than or equal to 190 cm and less than or equal to 210 cm, greater than or equal to 200 cm and less than or equal to 210 cm, greater than or equal to 150 cm and less than or equal to 200 cm, greater than or equal to 160 cm and less than or equal to 200 cm, greater than or equal to 170 cm and less than or equal to 200 cm, greater than or equal to 180 cm and less than or equal to 200 cm, or even greater than or equal to 190 cm and less than or equal to 200 cm. It should be understood that the above ranges include all subranges within the explicitly disclosed ranges.

According to embodiments, glass-ceramics have a refractive index (measured at wavelengths of 598 nm) that is greater than or equal to 1.500 and less than or equal to 1.600, greater than or equal to 1.520 and less than or equal to 1.600, greater than or equal to 1.540 and less than or equal to 1.600, greater than or equal to 1.550 and less than or equal to 1.600, greater than or equal to 1.500 and less than or equal to 1.580, greater than or equal to 1.520 and less than or equal to 1.580, greater than or equal to 1.540 and less than or equal to 1.580, greater than or equal to 1.550 and less than or equal to 1.580, greater than or equal to 1.500 and less than or equal to 1.560, greater than or equal to 1.520 and less than or equal to 1.560, greater than or equal to 1.540 and less than or equal to 1.560, greater than or equal to 1.550 and less than or equal to 1.560. It should be understood that the above ranges include all subranges within the explicitly disclosed ranges.

The stress optical coefficient (measured at a wavelength of 546 nm) of glass-ceramics according to embodiments is greater than or equal to 25.5 nm/cm/MPa and less than or equal to 28.5 nm/cm/MPa, greater than or equal to 25.8 nm/cm/MPa and less than or equal to 28.5 nm/cm/MPa, greater than or equal to 26.0 nm/cm/MPa and less than or equal to 28.5 nm/cm/MPa, greater than or equal to 26.2 nm/cm/MPa and less than or equal to 28.5 nm/cm/MPa, greater than or equal to 26.4 nm/cm/MPa and less than or equal to 28.5 nm/cm/MPa, greater than or equal to 25.5 nm/cm/MPa and less than or equal to 28.0 nm/cm/MPa, greater than or equal to 25.8 nm/cm/MPa and less than or equal to 28.0 nm/cm/MPa, greater than or equal to 26.0 nm/cm/MPa and less than or equal to 28.0 nm/cm/MPa, greater than or equal to 26.2 nm/cm/MPa and less than or equal to 28.0 nm/cm/MPa, greater than or equal to 26.4 nm/cm/MPa and less than or equal to 28.0 nm/cm/MPa, greater than or equal to 25.5 nm/cm/MPa and less than or equal to 27.6 nm/cm/MPa, greater than or equal to 25.8 nm/cm/MPa and less than or equal to 27.6 nm/cm/MPa, greater than or equal to 26.0 nm/cm/MPa and less than or equal to 27.6 nm/cm/MPa, greater than or equal to 26.2 nm/cm/MPa and less than or equal to 27.6 nm/cm/MPa, greater than or equal to 26.4 nm/cm/MPa and less than or equal to 27.6 nm/cm/MPa, greater than or equal to 25.5 nm/cm/MPa and less than or equal to 27.0 nm/cm/MPa, greater than or equal to 25.8 nm/cm/MPa and less than or equal to 27.0 nm/cm/MPa, greater than or equal to 26.0 nm/cm/MPa and less than or equal to 27.0 nm/cm/MPa, greater than or equal to 26.2 nm/cm/MPa and less than or equal to 27.0 nm/cm/MPa, greater than or equal to 26.4 nm/cm/MPa and less than or equal to 27.0 nm/cm/MPa, greater than or equal to 25.5 nm/cm/MPa and less than or equal to 26.5 nm/cm/MPa, greater than or equal to 25.8 nm/cm/MPa and less than or equal to 26.5 nm/cm/MPa, greater than or equal to 26.0 nm/cm/MPa and less than or equal to 26.5 nm/cm/MPa, greater than or equal to 26.2 nm/cm/MPa and less than or equal to 26.5 nm/cm/MPa, greater than or equal to 25.5 nm/cm/MPa and less than or equal to 26.4 nm/cm/MPa, greater than or equal to 25.8 nm/cm/MPa and less than or equal to 26.4 nm/cm/MPa, greater than or equal to 26.0 nm/cm/MPa and less than or equal to 26.4 nm/cm/MPa, greater than or equal to 25.5 nm/cm/MPa and less than or equal to 26.2 nm/cm/MPa, or greater than or equal to 25.8 nm/cm/MPa and less than or equal to 26.2 nm/cm/MPa. It should be understood that the above ranges include all subranges within the explicitly disclosed ranges.

Embodiments of the precursor glasses described herein have an annealing point that is greater than or equal to 490° C. and less than or equal to 530° C., greater than or equal to 500° C. and less than or equal to 520° C., or even greater than or equal to 510° C. and less than or equal to 520° C. It should be understood that the above ranges include all subranges within the explicitly disclosed ranges.

Precursor glasses according to embodiments have a strain point that is greater than or equal to 450° C. and less than or equal to 500° C., greater than or equal to 460° C. and less than or equal to 490° C., or even greater than or equal to 470° C. and less than or equal to 480° C. It should be understood that the above ranges include all subranges within the explicitly disclosed ranges.

Embodiments of the glass-ceramics described herein have an annealing point that is greater than or equal to 730° C. and less than or equal to 770° C., greater than or equal to 735° C. and less than or equal to 770° C., greater than or equal to 740° C. and less than or equal to 770° C., greater than or equal to 745° C. and less than or equal to 770° C., greater than or equal to 745° C. and less than or equal to 765° C., greater than or equal to 745° C. and less than or equal to 760° C., or even greater than or equal to 745° C. and less than or equal to 755° C. It should be understood that the above ranges include all subranges within the explicitly disclosed ranges.

Glass-ceramics according to embodiments have a strain point that is greater than or equal to 700° C. and less than or equal to 750° C., greater than or equal to 710° C. and less than or equal to 740° C., greater than or equal to 715° C. and less than or equal to 730° C., or even greater than or equal to 720° C. and less than or equal to 730° C. It should be understood that the above ranges include all subranges within the explicitly disclosed ranges.

In embodiments described herein, the glass-ceramics have a CTE of less than 8×10⁻⁶° C.⁻¹. In embodiments, the glass-ceramics have a coefficient of thermal expansion greater than or equal to 6×10⁻⁶° C.⁻¹ and less than or equal to 8×10⁻⁶° C.⁻¹, greater than or equal to 6.5×10⁻⁶° C.⁻¹ and less than or equal to 7.5×10⁻⁶° C.⁻¹, or even greater than or equal to 7×10⁻⁶° C.⁻¹ and less than or equal to 7.5×10⁻⁶° C.⁻¹. These relatively low CTE values improve the survivability of the glass-ceramic to thermal cycling or thermal stress conditions relative to glass-ceramics with higher CTEs.

As noted herein, it is believed that additions of CaO and ZrO₂ increase the density of the precursor glasses and glass-ceramics and, therefore, slows the diffusion of ions into the glass-ceramics during chemical strengthening. This slowing of diffusion slows the ion exchange process, but results in glass-ceramics with more compressive stress and central tension than less dense glasses. In embodiments, the precursor glasses and glass ceramics have a density of greater than 2.51 g/cm³, greater than or equal to 2.52 g/cm³, greater than or equal to 2.53 g/cm³, greater than or equal to 2.54 g/cm³, or even greater than or equal to 2.55 g/cm³.

In some embodiments, the precursor glasses described here may be compatible with float-type forming processes with an adjustment of the liquidus viscosity. In some embodiments, the precusor glass can have a liquidus viscosity of from greater than or equal to 0.5 kilopoise (kP) to less than or equal to 3.5 kP, greater than or equal to 0.5 kilopoise (kP) to less than or equal to 3 kP, greater than or equal to 0.5 kP to less than or equal to 2.5 kP, greater than or equal to 0.5 kP to less than or equal to 2.0 kP, greater than or equal to 0.5 kP to less than or equal to 1.5 kP, or even greater than or equal to 0.5 kP to less than or equal to 1.0 kP. In some embodiments, the precusor glass can have a liquidus viscosity of about 500, 1000, 1200, 1500, 2000, 2500, 3000 or 3500 P.

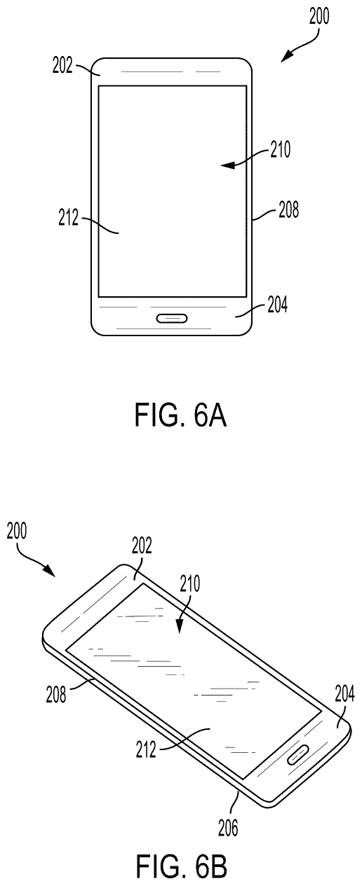

The precursor glass and glass-ceramic articles disclosed herein may be incorporated into another article such as an article with a display (or display articles) (e.g., consumer electronics, including mobile phones, tablets, computers, navigation systems, wearable devices (e.g., watches) and the like), architectural articles, transportation articles (e.g., automotive, trains, aircraft, sea craft, etc. for example for use as an interior display cover, a window, or windshield), appliance articles, or any article that requires some transparency, scratch-resistance, abrasion resistance or a combination thereof. An exemplary article incorporating any of the strengthened glass-ceramic articles disclosed herein is shown in FIGS. 6A and 6B.

Specifically, FIGS. 6A and 6B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover substrate 212 at or over the front surface of the housing such that it is over the display 210. In some embodiments, at least one of the cover substrate 212 or a portion of the housing 202 (such as the back 206) may include any of the strengthened glass-ceramics disclosed herein.

Additionally, the precursor glasses disclosed herein can be cerammed into other shapes (i.e., other than a plate or sheet) with minimal deformation, readily machined to precision shapes, cut, drilled, chamfered, tapped, polished to high luster with conventional ceramic machining tooling and even exhibit various degrees of translucency depending on composition and heat treatment. These properties make the glass-ceramics useful for a broad number of applications in addition to those identified herein, including, without limitation, countertops and other surfaces, appliance doors and exteriors, floor tiles, wall panels, ceiling tiles, white boards, materials storage containers (hollowware) such as beverage bottles, food sales and storage vessels, machine parts requiring light weight, good wear resistance and precise dimensions. The glass-ceramics can be formed in three-dimensional articles using various methods due to its lower viscosity.

Accordingly, various embodiments described herein may be employed to produce glass-ceramic articles having excellent optical quality and reduced warp while not adversely impacting, or even improving, stress in the glass-ceramic articles as compared to glass articles cerammed according to conventional techniques. Such glass-ceramic articles may be particularly well suited for use in portable electronic devices due to their strength performance and high transmission values.

### EXAMPLES

The embodiments described herein will be further clarified by the following examples.

The compositions listed in Tables 1A-1C were melted and formed into precursor glass plates with thicknesses in the range from 0.5 mm to 4.5 mm. The liquidus viscosity and liquidus temperature of the precursor glass plates were measured. The precursor glass plates were then cerammed according to the ceramming cycles indicated in Tables 1A-1C for each composition to create glass-ceramic articles, specifically glass-ceramic plates. Various properties of the glass-ceramic plates were then measured, including the fracture toughness, Young's modulus, shear modulus, Poisson's ratio, refractive index (using a PerkinElmer 950 spectrometer), haze, and the phase assemblage (by Rietveld x-ray diffraction). The properties of the glass-ceramics are reported in Tables 1A-1C.

TABLE 1A

| Oxide (wt %) | Ex. 1 | Ex. 2 | Ex. 3 | Ex. 4 |
|---|---|---|---|---|
| SiO₂ | 71.69 | 72.81 | 70.78 | 69.29 |
| Al₂O₃ | 5.40 | 3.64 | 5.37 | 5.34 |
| Li₂O | 12.08 | 12.14 | 12.02 | 11.95 |
| Na₂O | 0 | 0 | 0 | 0.11 |
| K₂O | 0.08 | 0.08 | 0.08 | 1.62 |
| CaO | 0.723 | 0.73 | 0.72 | 0.72 |
| P₂O5 | 2.50 | 2.51 | 2.49 | 2.47 |
| ZrO₂ | 7.517226 | 8.09 | 8.54 | 8.50 |
| HfO₂ | 0 | 0 | 0 | 0 |
| SnO₂ | 0 | 0 | 0 | 0 |
| Fe₂O₃ | | | | |
| Li₂O:Al₂O₃ | 2.24 | 3.33 | 2.24 | 2.24 |
| Li₂O:ZrO₂ | 1.61 | 1.50 | 1.41 | 1.41 |
| Liquidus Temp. (° C.) | 1090 | 1065 | 1135 | 1105 |
| Liquidus phase | Zircon | Tridymite | Zircon | Zircon |
| Liquidus viscosity | 1.8 | 3 | 1 | 1.2 |
| (kpoise) | | | | |
| Ceramming cycle | 580-4/750-1 | 590-4/720-1 | 590-4/720-1 | 590-4/730-1 |
| (temp (° C.)-(time (h)) | | | | |
| Appearance | Clear, transparent | Slightly hazy, | Clear, | Clear, |
| (qualitative) | | transparent | transparent | transparent |
| Phases assemblage | Res. glass: 13; | Res. glass: 30; | Res. glass: 22; | Res. glass: 26; |
| (wt %) | Petalite: 35; | Petalite: 21; | Petalite: 34; | Petalite: 27; |
| | Lithium disilicate: 47; | Lithium | Lithium | Lithium |
| | lithiophosphate: 2.4; | disilicate: 49 | disilicate: 41; | disilicate: 47 |
| | cristobalite: 3 | | cristobalite: 3.1 | |
| Haze at 0.6 mm | 0.16 | 0.31 | 0.22 | 0.21 |
| Fracture Toughness | 1.22 | 1.2 | 1.17 | 1.17 |
| (MPa√m) | | | | |
| Shear modulus (GPa) | 43.9 | 43.0 | 43.4 | 43.2 |
| Young's modulus | 105.6 | 103.7 | 104.6 | 104.1 |
| (GPa) | | | | |
| Poisson ratio | 0.2 | 0.21 | 0.2 | 0.21 |
| Stress optical | 2.582 | 2.607 | 2.635 | 2.634 |
| coefficient | | | | |
| (nm/mm/MPa) | | | | |
| Refractive index | 1.555 | 1.556 | 1.558 | 1.556 |

TABLE 1B

| Oxide (Wt %) | Ex. 5 |
|---|---|
| SiO₂ | 70.66 |
| Al₂O₃ | 5.34 |
| Li₂O | 11.89 |
| Na₂O | 0.04 |
| K₂O | 0.11 |
| CaO | 0.72 |
| P₂O5 | 2.48 |
| ZrO₂ | 8.50 |
| HfO₂ | 0.15 |
| SnO₂ | 0.10 |
| Fe₂O₃ | |
| Li₂O:Al₂O₃ | 2.22 |
| Li₂O:ZrO₂ | 1.40 |
| Liquidus Temp. (° C.) | 1190 |
| Liquidus phase | Zircon |
| Liquidus viscosity | 0.56 |
| (kpoise) | |
| Ceramming cycle | 585-4/735-1 h |
| (temp (° C.)-(time (h)) | |
| Appearance | Clear, transparent |
| (qualitative) | |
| Phases assemblage | Res. glass: 20; |
| (wt %) | Petalite: 41; |
| | Lithium |
| | disilicate: 38; |
| | cristobalite: 1 |
| Haze at 0.6 mm | 0.12 |
| Fracture Toughness | 1.17 |
| (MPa√m) | |
| Shear modulus (GPa) | 44 |
| Young's modulus | 105 |
| (GPa) | |
| Poisson ratio | 0.2 |
| Stress optical | 2.752 |
| coefficient | |
| (nm/mm/MPa) | |
| Refractive index | 1.558 |

TABLE 1C

| Oxide (Wt %) | Comp. Ex. A | Comp. Ex. B |
|---|---|---|
| SiO₂ | 73.99 | 71.88 |
| Al₂O₃ | 7.66 | 7.13 |
| Li₂O | 11.20 | 11.55 |
| Na₂O | 0.17 | 0.06 |
| K₂O | 0.20 | 0.11 |
| CaO | 0 | 0.69 |
| P₂O5 | 2.07 | 2.49 |
| ZrO₂ | 4.24 | 5.94 |
| HfO₂ | 0.07 | 0.11 |
| SnO₂ | 0.39 | 0.03 |
| Fe₂O₃ | | |
| Li₂O:Al₂O₃ | 1.46 | 1.62 |
| Li₂O:ZrO₂ | 2.64 | 1.94 |
| Liquidus Temp. (° C.) | 1065 | 1065 |
| Liquidus phase | Lithium | Zircon |
| | silicate/lithiophos | |
| | phate | |
| Liquidus viscosity | 3.75 | 3.24 |
| (kpoise) | | |
| Ceramming cycle (temp | 570-4/740-1 | 580-4/740-1 |
| (° C.)-(time (h)) | | |
| Appearance (qualitative) | Clear, transparent | Clear, |
| | | transparent |
| Phases assemblage (wt %) | Residual glass: | Residual glass: |
| | 12; Petalite: 44; | 13; Petalite: |
| | Lithium | 42; Lithium |
| | disilicate: 44 | disilicate: 45 |
| Haze at 0.6 mm | 0.13 | 0.13 |
| Fracture Toughness | 1.15 | 1.16 |
| (MPa√m) | | |
| Shear modulus (GPa) | 43 | 43 |
| Young's modulus (GPa) | 102.7 | 104 |
| Poisson ratio | 0.19 | 0.19 |
| Stress optical coefficient | 2.597 | 2.622 |
| (nm/mm/MPa) | | |
| Refractive index | 1.542 | 1.549 |

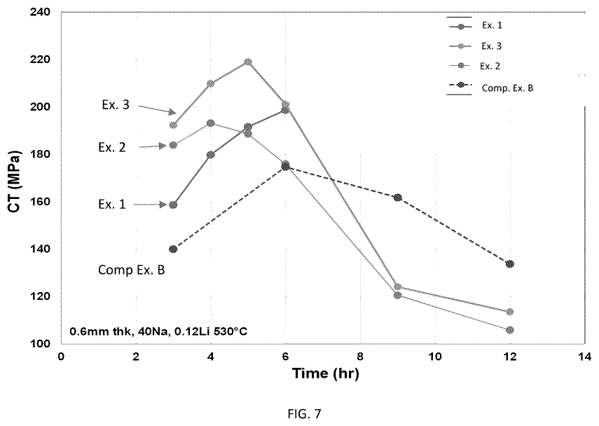

Thereafter, glass-ceramic plates having the composition of Example 1, Example 2, Example 3, and Comparative Example B were chemically strengthened by ion exchange in a molten salt bath comprising 40 wt % sodium nitrate (NaNO₃), 60 wt % potassium nitrate (KNO₃) and 0.12 wt % lithium nitrate (LiNO₃) at 530° C. for a range of different times (i.e., the IOX time was in the range from 3 hours to 12 hours). The maximum central tension installed in each glass-ceramic plate as a result of the ion exchange was measured. The results are reported in Table 2 below, including the ion exchange time, measured maximum central tension, and thickness of the glass-ceramic plate. The central tension (CT) as a function of time (hours) is depicted in FIG. 7 for the Examples listed in Table 2.

TABLE 2

| Composition | IOX Time (hr) | CT (MPa) | thickness (mm) |
|---|---|---|---|
| Comp. Ex. B | 3 | 140.01 | 0.59 |
| | 6 | 174.64 | 0.6 |
| | 9 | 161.71 | 0.6 |
| | 12 | 133.72 | 0.6 |
| Ex. 1 | 3 | 158.60 | 0.58 |
| | 4 | 179.76 | 0.59 |
| | 5 | 191.53 | 0.59 |
| | 6 | 198.57 | 0.59 |
| Ex. 2 | 3 | 183.89 | 0.57 |
| | 4 | 193.07 | 0.57 |
| | 5 | 188.65 | 0.57 |
| | 6 | 175.84 | 0.59 |
| | 9 | 120.44 | 0.57 |
| | 12 | 105.80 | 0.58 |
| Ex. 3 | 3 | 192.27 | 0.6 |
| | 4 | 209.64 | 0.6 |
| | 5 | 218.92 | 0.6 |
| | 6 | 201.05 | 0.59 |
| | 9 | 124.09 | 0.6 |
| | 12 | 113.45 | 0.59 |

As indicated in Table 2 and FIG. 7, the glass-ceramic plates having ratios of Li₂O:Al₂O₃ within the range of greater than 2 and less than or equal to 4 and ratios of Li₂O:ZrO₂ greater than or equal to 1.2 and less than or equal to 1.7 (such as the glass-ceramic plates formed from the composition of Examples 1-3) were able to achieve higher CT values in shorter ion exchange times than glass-ceramic plates having ratios of Li₂O:Al₂O₃ and Li₂O:ZrO₂ falling outside these ranges, demonstrating the synergistic effect of the combination of Li₂O, Al₂O₃, ZrO₂, and CaO, in the prescribed amounts and ratios, on enhancing the ion exchange properties of the glass-ceramics.

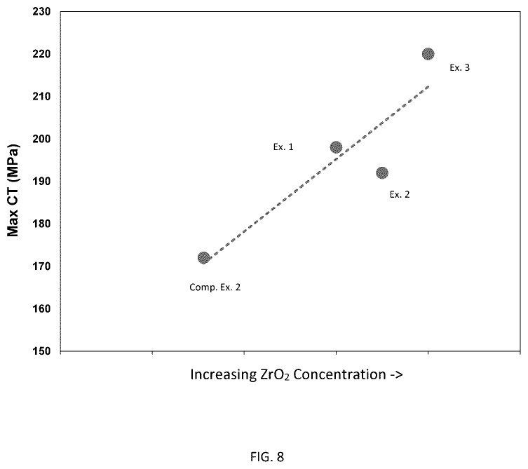

In addition, FIG. 8 shows the maximum CT plotted as a function of increasing ZrO₂ concentration. As indicated in FIG. 8, the maximum CT increases along with the concentration of ZrO₂ in the glass-ceramic.

Glass-ceramic plates formed from the composition of Example 5 and Comparative Example B were chemically strengthened according to the ion exchange conditions listed in Table 3 (i.e., “IOX Conditions” W, X, Y, and Z). As an example, “60Na/40K+0.12Li (530 C-3 h 10 min)” corresponds to ion exchange in a salt bath including 60 wt % sodium nitrate (NaNO₃), 40 wt % potassium nitrate (KNO₃) and 0.12 wt % lithium nitrate (LiNO₃) at a temperature of 530° C. for 3 hours and 10 minutes. Thereafter, the surface compressive stress (CS), maximum central tension (CT), and depth of compression (DOC) were measured for each glass-ceramic plate. The results are provided in Table 3.

TABLE 3

| | | | Ion Exchange Cycle | | | |
|---|---|---|---|---|---|---|
| | Thickness | IOX | (Bath Composition | CS | CT | DOC |
| Composition | (mm) | Condition | (Temp. - Time)) | (MPa) | (MPa) | (um) |
| Comp. Ex. B | 0.5 | W | 80Na/20K + 0.14Li | 300 | 157 | 113 |
| | | | (530 C.-4 h) | | | |
| Comp. Ex. B | 0.6 | X | 80Na/20K + 0.14Li | 316 | 155 | 135 |
| | | | (530 C.-5 h) | | | |
| Ex. 5 | 0.5 | Y | 60Na/40k + 0.12Li | 300 | 195 | 114 |
| | | | (530 C.-3 h 10 min) | | | |
| Ex. 5 | 0.6 | Z | 40Na/60K + 0.12Li | 315 | 170 | 135 |
| | | | (530 C.-3 h 40 min) | | | |

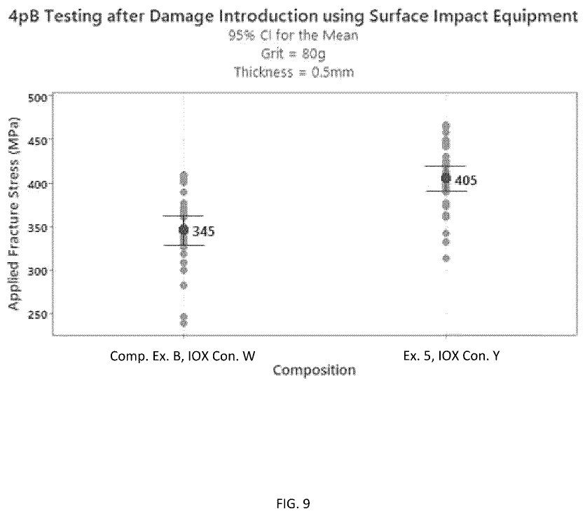

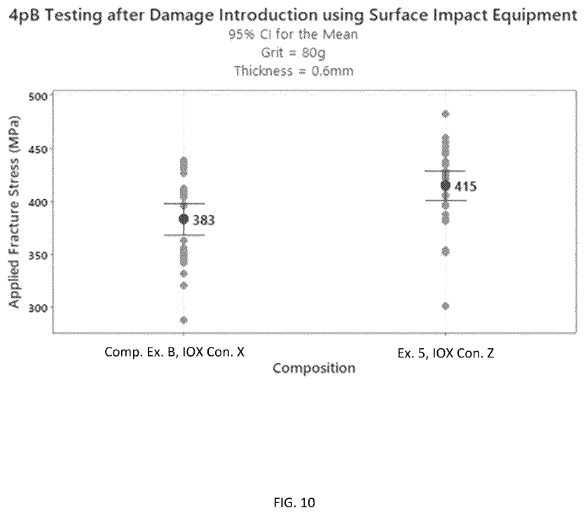

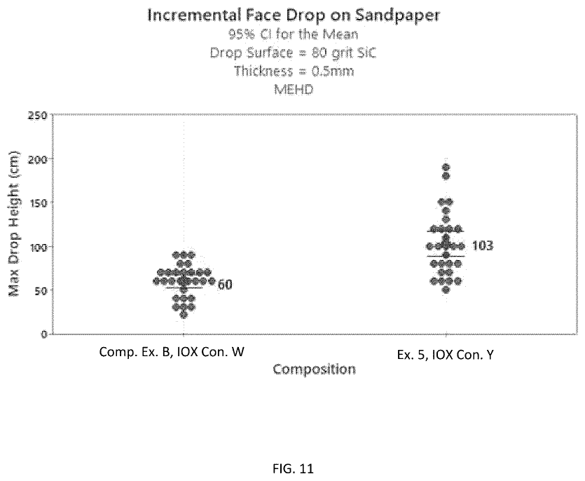

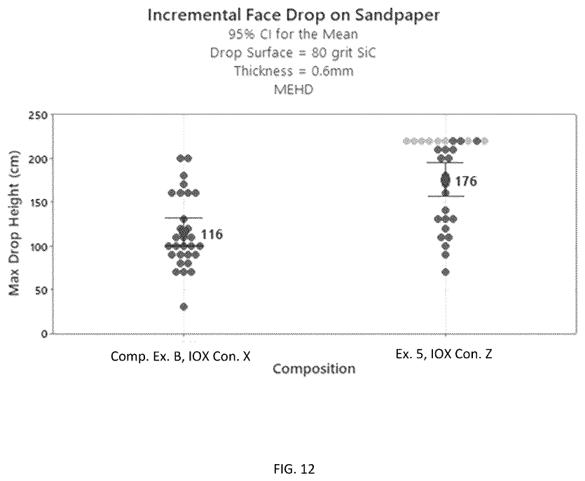

The glass-ceramic plates from Table 3 were subsequently subjected to a four point bend test (as described herein) to determine the fracture strength and a drop test (as described herein) to determine the maximum drop height before failure (i.e., the drop height). The four point bend tests were conducted by introducing flaws with 80 grit Al₂O₃ sandpaper, as described herein. The results are graphically depicted in FIG. 9 (for glass-ceramic plates having a thickness of 0.5 mm) and FIG. 10 (for glass-ceramic plates having a thickness of 0.6 mm). The drop tests were performed on 80 grit SiC sandpaper. The results are graphically depicted in FIG. 11 (for glass-ceramic plates having a thickness of 0.5 mm) and FIG. 12 (for glass-ceramic plates having a thickness of 0.6 mm).

As shown in FIG. 9, glass-ceramic plates formed from the composition of Example 5 having a thickness of 0.5 mm and strengthened according to ion exchange condition Y generally exhibited a higher fracture strength than the glass-ceramic plates formed from the composition of Comparative Example B having a thickness of 0.5 mm and strengthened according to ion exchange condition W. While not wishing to be bound by theory, it is believed that the increase in fracture strength is due to the higher central tension (CT) installed in the glass-ceramic plate formed form the composition of Example 5 ion exchanged according to condition Y. As noted herein, it is believed that the relatively higher central tension allows for higher compressive stresses at deeper depths from the surface of the glass-ceramic plate, thereby improving the mechanical performance of the glass-ceramic compared to glass-ceramic plates with relatively lower central tensions.

As shown in FIG. 10, glass-ceramic plates formed from the composition of Example 5 having a thickness of 0.6 mm and strengthened according to ion exchange condition Z generally exhibited a higher fracture strength than the glass-ceramic plates formed from the composition of Comparative Example B having a thickness of 0.6 mm and strengthened according to ion exchange condition X. As noted herein, it is believed that the increase in fracture strength is due to the higher central tension (CT) installed in the glass-ceramic plate formed form the composition of Example 5 ion exchanged according to condition Z because the relatively higher central tension allows for higher compressive stresses at deeper depths from the surface of the glass-ceramic plate, thereby improving the mechanical performance of the glass-ceramic compared to glass-ceramic plates with relatively lower central tensions.

As shown in FIG. 11, glass-ceramic plates formed from the composition of Example 5 having a thickness of 0.5 mm and strengthened according to ion exchange condition Y generally exhibited a higher maximum drop height than the glass-ceramic plates formed from the composition of Comparative Example B having a thickness of 0.5 mm and strengthened according to ion exchange condition W. While not wishing to be bound by theory, it is believed that the increase in maximum drop height is due to the higher central tension (CT) installed in the glass-ceramic plate formed form the composition of Example 5 ion exchanged according to condition Y. As noted herein, it is believed that the relatively higher central tension allows for higher compressive stresses at deeper depths from the surface of the glass-ceramic plate, thereby improving the mechanical performance of the glass-ceramic compared to glass-ceramic plates with relatively lower central tensions.

As shown in FIG. 12, glass-ceramic plates formed from the composition of Example 5 having a thickness of 0.6 mm and strengthened according to ion exchange condition Z generally exhibited a higher maximum drop height than the glass-ceramic plates formed from the composition of Comparative Example B having a thickness of 0.6 mm and strengthened according to ion exchange conditions X. While not wishing to be bound by theory, it is believed that the increase in maximum drop height is due to the higher central tension (CT) installed in the glass-ceramic plate formed form the composition of Example 5 ion exchanged according to condition Z. As noted herein, it is believed that the relatively higher central tension allows for higher compressive stresses at deeper depths from the surface of the glass-ceramic plate, thereby improving the mechanical performance of the glass-ceramic compared to glass-ceramic plates with relatively lower central tensions.

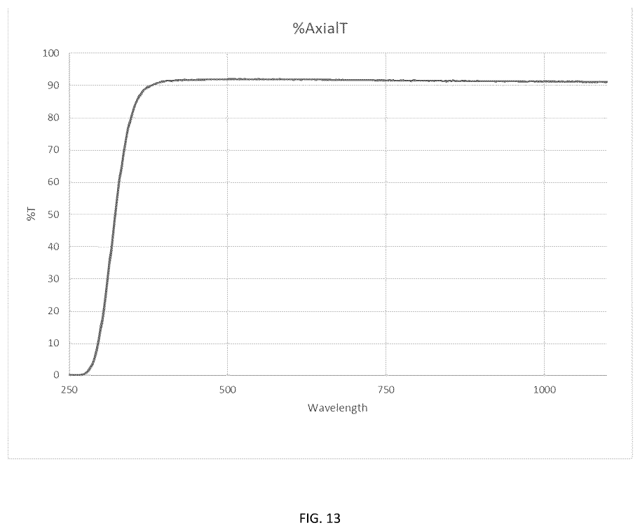

Referring now to FIG. 13, FIG. 13 graphically depicts the transmittance as a function of wavelength of a glass-ceramic plate having a thickness of 0.5 mm. The glass-ceramic plate was formed from the composition of Example 5. As shown in FIG. 13, the glass-ceramic plate had a transmittance of greater than 90% for wavelengths of light within the range from greater than or equal to 400 nm to less than or equal to 800 nm at an article thickness of 0.5 mm.

Glass-ceramic plates were formed from the composition of Example 5. Some of the plates of each composition were strengthened by ion exchange. Thereafter, the Knoop hardness of both the strengthened plates and non-strengthened plates was determined according to the method described herein. The average hardness values are reported in Table 4 below.

TABLE 4

| Composition | Average Knoop Hardness (Kgf/mm²) |
|---|---|
| Example 5 (strengthened) | 615 |
| Example 5 (non-strengthened) | 606 |

The annealing point, strain point, and CTE of glass-ceramic plates formed from the composition of Example 5 were determined as described herein. The values are reported in Table 5 below.

TABLE 5

| Property | Value |
|---|---|
| Annealing Point (° C.) | 752.1 |
| Strain Point (° C.) | 725 |
| CTE (0-300° C.) (×10⁻⁶/° C.) | 7.17 |

The thermal diffusivity, thermal conductivity, and heat capacity of glass-ceramic plates formed from the composition of Example 5 were determined as described herein. The values are reported in Tables 6-8 below.

TABLE 6

| Thermal Diffusivity | |
|---|---|
| (cm²/s) | Value |
| @ 100° C. | 0.0079 |
| @200° C. | 0.0073 |
| @300° C. | 0.0070 |
| @400° C. | 0.0069 |
| @500° C. | 0.0066 |

TABLE 7

| Thermal Conductivity | |
|---|---|
| (W/mK) | Value |
| @ 100° C. | 1.93 |
| @200° C. | 2.11 |
| @300° C. | 2.38 |
| @400° C. | 2.32 |
| @500° C. | 2.21 |

TABLE 8

| Heat Capacity (J/g*K) | Value |
|---|---|
| @ 100° C. | 1.02 |
| @200° C. | 1.14 |
| @300° C. | 1.22 |
| @400° C. | 1.29 |
| @500° C. | 1.36 |

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A glass-ceramic comprising:
greater than or equal to 55 wt % to less than or equal to 75 wt % SiO2;
greater than or equal to 2 wt % to less than or equal to 10 wt % Al2O3;
greater than or equal to 8 wt % to less than or equal to 15 wt % Li2O;
greater than or equal to 2 wt % to less than or equal to 4 wt % P2O5;
greater than or equal to 0.05 wt % and less than or equal to 4.0 wt % CaO;
greater than or equal to 5 wt % to less than or equal to 15 wt % ZrO2; and
a phase assemblage comprising at least one crystalline phase and a residual amorphous glass phase, wherein:
a ratio of Li2O (wt %) to Al2O3 (wt %) is greater than 2 and less than or equal to 4; and
a ratio of Li2O (wt %) to ZrO2 (wt %) is greater than or equal to 1.2 and less than or equal to 1.7.

2. The glass-ceramic of claim 1, wherein the ratio of Li2O (wt %) to Al2O3 (wt %) is greater than 2 and less than or equal to 3.5.

3. The glass-ceramic of claim 1, wherein the ratio of Li2O (wt %) to ZrO2 (wt %) is greater than or equal to 1.35 and less than or equal to 1.7.

4. The glass-ceramic of claim 1, wherein a ratio of Al2O3 (wt %) to ZrO2 (wt %) is greater than 0 and less than or equal to 1.

5. The glass-ceramic of claim 1, wherein a ratio of Al2O3 (wt %) to ZrO2 (wt %) is greater than 0.35 and less than or equal to 0.65.

6. The glass-ceramic of claim 1, further comprising greater than 0 wt % and less than or equal to 2 wt % Na2O.

7. The glass-ceramic of claim 1, further comprising greater than 0.1 wt % and less than or equal to 1 wt % K2O.

8. The glass-ceramic of claim 1, further comprising greater than or equal to 0.1 wt % to less than or equal to 1.0 wt % HfO2.

9. The glass-ceramic of claim 1, comprising greater than or equal to 10 wt % to less than or equal to 14 wt % Li2O.

10. The glass-ceramic of claim 1, comprising greater than or equal to 6 wt % to less than or equal to 10 wt % ZrO2.

11. The glass-ceramic of claim 1, comprising greater than or equal to 3 wt % to less than or equal to 8 wt % Al2O3.

12. The glass-ceramic of claim 1, comprising greater than or equal to 0.10 wt % to less than or equal to 1.00 wt % CaO.

13. The glass-ceramic of claim 1, wherein the phase assemblage comprises:
a lithium disilicate crystalline phase;
a petalite crystalline phase; and
the residual amorphous glass phase.

14. The glass-ceramic of claim 13, comprising greater than or equal to 15 wt % to less than or equal to 35 wt % of the residual amorphous glass phase.

15. The glass-ceramic of claim 13, comprising greater than or equal to 20 wt % to less than or equal to 45 wt % of the petalite crystalline phase.

16. The glass-ceramic of claim 13, comprising greater than or equal to 35 wt % to less than or equal to 50 wt % of the lithium disilicate crystalline phase.

17. The glass-ceramic of claim 1, further comprising:
a compressive stress layer extending from a surface of the glass-ceramic to a depth of compression; and
a central tension, wherein the central tension is greater than 170 MPa.

18. The glass-ceramic of claim 17, wherein the compressive stress layer comprises a surface compressive stress greater than or equal to 200 MPa and less than or equal to 550 MPa.

19. The glass-ceramic of claim 17, wherein the glass-ceramic is ion-exchange strengthened.

20. The glass-ceramic of claim 17, wherein the glass-ceramic has a thickness t and the depth of compression is greater than or equal to 0.09*t to less than or equal to 0.30*t.

21. The glass-ceramic of claim 1, wherein the glass-ceramic has a transmittance of greater than 90% for wavelengths of light within a range from greater than or equal to 400 nm to less than or equal to 800 nm at an article thickness of 0.5 mm.

22. The glass-ceramic of claim 1, wherein the glass-ceramic has a fracture toughness greater than or equal to 1.0 MPa·m½ and less than or equal to 2.0 MPa·m½ prior to strengthening by ion exchange.

23. The glass-ceramic of claim 1, wherein the glass-ceramic has an elastic modulus greater than or equal to 90 GPa and less than or equal to 130 GPa.

24. An electronic device comprising a cover substrate, the cover substrate comprising the glass-ceramic of claim 1.

25. A glass-ceramic comprising:
a lithium disilicate crystalline phase;
a petalite crystalline phase; and
a residual amorphous glass phase, wherein:
a ratio of Li2O (wt %) to Al2O3 (wt %) in the glass-ceramic is greater than 2 and less than or equal to 4; and
a ratio of Li2O (wt %) to ZrO2 (wt %) in the glass-ceramic is greater than or equal to 1.2 and less than or equal to 1.7.

26. A precursor glass comprising:
greater than or equal to 55 wt % to less than or equal to 75 wt % SiO2;
greater than or equal to 2 wt % to less than or equal to 10 wt % Al2O3;
greater than or equal to 8 wt % to less than or equal to 15 wt % Li2O;
greater than or equal to 2 wt % to less than or equal to 4 wt % P2O5;
greater than or equal to 0.05 wt % and less than or equal to 4.0 wt % CaO; and
greater than or equal to 5 wt % to less than or equal to 15 wt % ZrO2;
a ratio of Li2O (wt %) to Al2O3 (wt %) is greater than 2 and less than or equal to 4; and
a ratio of Li2O (wt %) to ZrO2 (wt %) is greater than or equal to 1.2 and less than or equal to 1.7.
